(19) United States
(12) Patent Application Publication
(10) Pub. No.: US 2009/0079910 A1
(43) Pub. Date: Mar. 26, 2009

(54) OPTICAL COMPENSATION FILM, POLARIZING PLATE AND LIQUID CRYSTAL DISPLAY

(75) Inventors: Yoji Ito, Kanagawa (JP); Ryo Nakamura, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/815,768

(22) PCT Filed: Mar. 22, 2006
(86) PCT No.: PCT/JP2006/306387

§ 371 Date: Aug. 8, 2007

(30) Foreign Application Priority Data
Mar. 22, 2005 (JP) 2005-081401
Mar. 22, 2005 (JP) 2005-082211

(51) Int. Cl. G02F 1/1333; G02F 1/13363

(52) U.S. Cl. 349/75; 349/193

(57) ABSTRACT

An optical compensation film is provided and has a cellulose acylate film coated with an optically anisotropic layer containing a liquid crystalline compound, cellulose having a glucose unit, a hydroxyl group of the glucose unit being substituted with an acyl group having at least two carbon atoms. The cellulose acylate film satisfies relationships specified in the specification.

### TECHNICAL FIELD

The present invention relates to an optical compensation film, and a polarizing plate and a liquid crystal display each using the optical compensation film.

### BACKGROUND ART

Liquid crystal displays are widely used for a number of applications, including personal computers, mobile equipment monitors and televisions, since they have various advantages, e.g., in their low voltage and low consumption power at the time of operation and their high possibility for reduction in size and profile. Although a variety of modes depending on how liquid crystalline molecules are aligned in a liquid crystal cell have been proposed for such liquid crystal displays, the dominating mode has hitherto been a TN mode in which liquid crystalline molecules are in an aligned state that their orientations twist by about 90° toward an upper side substrate from a lower side substrate.

In general a liquid crystal display is made up of a liquid crystal cell, an optical compensation film and a polarizer. The optical compensation film is used for dissolution of coloring of images and expansion of a viewing angle, and a birefringent stretched film or a transparent film coated with a liquid crystal is employed as the optical compensation film. For instance, Japanese Patent No. 2587398 discloses the art of expanding a viewing angle by applying to a TN-mode liquid crystal cell the optical compensation film formed by coating a discotic liquid crystal on a triacetyl cellulose film, forcing the liquid crystal into an aligned state and fixing the aligned state. However, liquid crystal displays for television use, which are supposed to be equipped with big screens and to be viewed from various angles, have stringent demands on viewing angle dependence, so even the foregoing art cannot satisfy such demands. Under these circumstances, liquid crystal displays of different modes from the TN mode, such as an IPS (In-Plane Switching) mode, an OCB (Optically Compensatory Bend) mode and a VA (Vertically Aligned) mode, have been studied. The IPS mode in particular has captured the spotlight in liquid crystal displays for TV uses because of its small change in gradation characteristic by visual angles.

Cellulose acylate films contain a feature that they are high in optical isotropy (low in retardation value), compared with other polymer films. Accordingly, it is a general rule that cellulose acetate film is used for applications requiring optical anisotropy, such as for polarizing plates.

By contrast, optical anisotropy (high retardation value) is required of optical compensation films (retardation films) used in liquid crystal displays. When cellulose acylate films are applied to IPS-mode liquid crystal displays in particular, it is required for them to have Re values ranging from 20 nm to 150 nm and Re/Rth ratios ranging from 1.5 to 7.

Hitherto, it has been a general rule in the technical field of optical materials to use synthetic polymers in the case of requiring for polymer films to have optical anisotropy (high retardation values), but to use cellulose acetate film in the case of requiring for polymer films to have optical isotropy (low retardation values).

EP-A-911656 discloses the cellulose acetate film having a high retardation value which, though against the rule hitherto regarded as general, is also usable for applications requiring optical anisotropy. In order to achieve a high retardation value in the case of using cellulose acetate, addition of a compound having at least two aromatic rings, notably a 1,3,5-triazine ring, and stretch processing are performed in that patent.

Although in general cellulose acetate is a material hard to stretch and known for difficulty in increasing its birefringence factor, simultaneous alignment of the additive molecules by stretch processing in the patent document cited makes it possible to increase the birefringence factor and thereby to achieve a high retardation value.

Such a film can also serve as protective film of a polarizing plate, so it has an advantage in its suitability for offering thin liquid-crystal displays at low prices.

JP-A-2002-71957 discloses the optical film containing a cellulose ester having 2-4 C acyl groups as substituents and satisfying both the relations 2.0≦A+B≦3.0 and A<2.4 when the degree of acetyl-group substitution is taken as A and the degree of propionyl- or butyryl-group substitution is taken as B, and further satisfying the relation 0.0005≦Nx−Ny≦0.0050 when the refractive index measured by light of 590 nm in the direction of a slow axis is taken as Nx and the refractive index measured by light of 590 nm in the direction of a fast axis.

In the IPS mode, placement of an optical compensation material having birefringence characteristics between a liquid crystal layer and a polarizing plate has been studied as one of methods for improving viewing angles in states of color-tone and black-state displays For instance, it is disclosed that an improvement of coloring in a white displayed state or middle-tone displayed states when viewed from oblique directions can be attained by placing a birefringent medium having optical axes which intersect at right angles and respectively have functions of compensating an increase and a decrease in retardation of a liquid crystal layer in an inclined state between a substrate and a polarizing plate (See JP-A-9-80424). In addition, there are proposed the method of using an optical compensation film which has negative intrinsic birefringence and includes a styrene polymer or a discotic liquid crystalline compound (See JP-A-10-54982, JP-A-11-202323 and JP-A-9-292522), the method of using as an optical compensation film a combination of a film having positive birefringence and an optical axis in the plane of the film and a film having positive birefringence and an optical axis in the direction of the normal to the film (See JP-A-11-133408), the method of using a biaxial optical compensation film having a half-wavelength retardation (See JP-A-11-305217) and the method of using a film having negative retardation as the protective film of a polarizing plate and providing on this film surface an optical compensation layer having positive retardation (See JP-A-10-307291).

In JP-A-9-211444 and JP-A-11-316378, the optical compensation films having layers made up of liquid crystalline compounds are applied in polarizing plates used for OCB mode liquid crystal displays, and thereby wide viewing angles are achieved.

The methods disclosed in Documents cited above are effective in allowing thin liquid-crystal displays to be produced at low prices. In recent years, however, there has been a growth in the use of liquid crystal displays under a wide variety of circumstances, and it has become a problem that the cellulose ester films utilizing the foregoing arts changed their optical compensation performance under those circumstances. More specifically, the problem is in that those cellulose ester films are affected by changes of circumstances, notably an influence of humidity, especially when each of them is stuck on a liquid crystal cell, and thereby their Re retardation and Rth retardation values are changed to result in changes of their optical compensation performance. Therefore, it has been requested to solve such a problem.

### DISCLOSURE OF THE INVENTION

An object of an illustrative, non-limiting embodiment of the invention is to provide an optical compensation film using a cellulose acylate film developing excellent in-plane retardation and thickness-direction retardation characteristics and being reduced in retardation changes depending on ambient humidity, and another object of an illustrative, non-limiting embodiment of the invention is to provide a polarizing plate using such an optical compensation film.

A further object of an illustrative, non-limiting embodiment of the invention is to provide a liquid crystal display reduced in changes of viewing angle characteristics.

These objects are attained by the following embodiments of the invention.

(1-1) An optical compensation film having a cellulose acylate film coated with an optically anisotropic layer containing a rod-shaped liquid crystalline compound, wherein the cellulose acylate film comprises a cellulose having a glucose unit, a hydroxyl group of the glucose unit being substituted with an acyl group having at least two carbon atoms, and the cellulose acylate film satisfies relationships (I) and (II):

2.0≦DS2+DS3+DS6≦3.0 (I)

DS6(DS2+DS3+DS6)≧0.315 (II)

wherein DS2 stands for a substitution degree of the hydroxyl group at 2-position of the glucose unit with the acyl group, DS3 stands for a substitution degree of the hydroxyl group at 3-position of the glucose unit with the acyl group, and DS6 stands for a substitution degree of the hydroxyl group at 6-position of the glucose unit with the acyl group.

(1-2) An optical compensation film as described in (1-1), wherein the cellulose acylate film has an Re(550) value of 20 nm to 150 nm and an Rth(550)/Re(550) ratio of 1.5 to 7 and the optically anisotropic layer containing the rod-shaped liquid crystalline compound has an Re(550) value of 0 nm to 10 nm and an Rth(550) value of −80 nm to −400 nm.

[In the above (1-2), Re(λ) is an in-plane retardation expressed in the units nm at a wavelength of λ nm and Rth(λ) is a thickness-direction retardation expressed in the units nm at a wavelength of λ nm.]

(1-3) An optical compensation film as described in (1-1) or (1-2), wherein a difference between retardation values Re(550) of the cellulose acylate film under conditions of 25° C.-10% RH and 25°-80% RH, ΔRe (Re10% RH-Re80% RH), is 12 nm or below and a difference between retardation values Rth(550) of the cellulose acylate film under conditions of 25° C.-10% RH and 25°-80% RH, ΔRth (Rth10% RH-Rth80% RH), is 32 nm or below.

[In the above (1-3), Re(λ) is an in-plane retardation expressed in the units nm at a wavelength of λ nm and Rth(λ) is a thickness-direction retardation expressed in the units nm at a wavelength of λ nm.]

(1-4) A polarizing plate having an optical compensation film as described in any of (1-1) to (1-3) and a polarizer.

(1-5) A liquid crystal display having a liquid crystal cell and an optical compensation film as described in any of (1-1) to (1-3) or a polarizing plate as described in (1-4).

(1-6) A liquid crystal display as described in (1-5), wherein an IPS mode is employed.

In the invention, the following modes are also preferred.

(1-7) An optical compensation film as described in any of (1-1) to (1-3), wherein the acyl group in the cellulose acylate film is an acetyl group.

(1-8) An optical compensation film as described in any of (1-1) to (1-3), wherein the cellulose acylate film contains at least one retardation developer including a rod-shaped or discotic compound.

(1-9) An optical compensation film as described in any of (1-1) to (1-3), wherein the cellulose acylate film contains at least one additive selected from a plasticizer, an ultraviolet absorbent or a parting accelerator.

(1-10) An optical compensation film as described in any of (1-1) to (1-3), wherein the cellulose acylate film has a thickness of 40 μm to 180 μm.

(1-11) An optical compensation film as described in any of (1-1) to (1-3), wherein a content of the additive in the cellulose acylate film is from 10 to 30% of the mass of the cellulose acylate film.

(1-12) An optical compensation film as described in any of (1-1) to (1-3), wherein the cellulose acylate film has an equilibrium moisture content of 3.4% or below at a temperature of 25° C. and a humidity of 80% RH.

(1-13) An optical compensation film as described in any of (1-1) to (1-3), wherein a moisture permeability of the cellulose acylate film under conditions of 60° C., 95% RH and 24 hr is from 400 g/m² 24 hr to 2,300 g/m² 24 hr (calculated in terms of film thickness of 80 μm).

(1-14) An optical compensation film as described in any of (1-1) to (1-3), wherein the cellulose acylate film has a mass change of 0 to 5% when allowed to stand for 48 hours under conditions of 80° C. and 90% RH.

(1-15) An optical compensation film as described in any of (1-1) to (1-3), wherein a dimensional change caused in the cellulose acylate film when allowed to stand for 24 hours under conditions of 60° C. and 95% RH and a dimensional change caused in the cellulose acylate film when allowed to stand for 24 hours under conditions of 90° C. and 5% RH are both in a range of 0% to 5%.

(1-16) An optical compensation film as described in any of (1-1) to (1-3), wherein the cellulose acylate film has a glass transition temperature Tg of 80° C. to 180° C.

(1-17) An optical compensation film as described in any of (1-1) to (1-3), wherein the cellulose acylate film has an elasticity modulus of 1,500 MPa to 5,000 MPa.

(1-18) An optical compensation film as described in any of (1-1) to (1-3), wherein the cellulose acylate film has a photoelasticity coefficient of 50×10⁻¹³ cm²/dyne or below.

(1-19) An optical compensation film as described in any of (1-1) to (1-3), wherein the cellulose acylate film has a haze of 0.01% to 2%.

(1-20) An optical compensation film as described in any of (1-1) to (1-3), wherein the cellulose acylate film contains fine particles of silicon dioxide ranging from 0.2 μm to 1.5 μm in average diameter of secondary particles.

(1-21) A polarizing plate as described in (1-4), further having at least one factor selected from a singl plate transmittance TT, a parallel transmittance PT, a cross transmittance CT or a polarization degree P satisfying the following expression (a), (b), (c) or (d), respectively, when measured under conditions of 25° C. and 60% RH:

(a) 40.0≦TT≦45.0

(b) 30.0≦PT≦40.0

(c) CT≦2.0

(d) 95.0≦P

(1-22) A polarizing plate as described in (1-4), further satisfying at least one of the following expressions (e), (f) and (g) concerning cross transmittances of the plate when a cross transmittance measured at a wavelength λ nm is denoted as CT(λ):

(e) CT(380)≦2.0

(f) CT(410)≦0.1

(g) CT(700)≦0.5

(1-23) A polarizing plate as described in (1-4), further having at least either an amount of change in a cross transmittance ΔCT or an amount of change in a polarization degree ΔP satisfying the following expression (j) or (k), respectively, when the plate is allowed to stand for 500 hours under conditions of 60° C. and 95% RH:

(j)−6.0≦ΔCT≦6.0

(k)−10.0≦ΔP≦0.0

(wherein the amount of change is defined as a value obtained by subtracting a measurement value before testing from a measurement value after testing).

(1-24) A polarizing plate as described in (1-4), further provided with at least one layer chosen from a hard coating layer, an antiglare layer or an antireflective layer on the surface of a protective film to be positioned opposite to a liquid crystal cell.

(1-25) A polarizing plate as described in (1-4), which is packaged in a moisture-proof bag having an inside humidity adjusted to a range of 43% RH to 65% RH at 25° C.

(1-26) A polarizing plate as described in (1-4), which is packaged in a moisture-proof bag having an inside humidity adjusted so as to differ by 15% RH or below from the ambient humidity at which the polarizing plate is stacked on a liquid crystal panel.

The above objects are also attained by the following embodiments of the invention.

(2-1) An optical compensation film having a cellulose acylate film coated with an optically anisotropic layer containing a liquid crystalline compound, wherein the cellulose acylate film comprises a cellulose having a glucose unit, a hydroxyl group of the glucose unit being substituted with an acyl group having at least two carbon atoms, and the cellulose acylate film satisfies relationships (I) and (II):

2.0≦DS2+DS3+DS6≦3.0 (I)

DS6(DS2+DS3+DS6)≦0.315 (II)

wherein DS2 stands for a substitution degree of the hydroxyl group at 2-position of the glucose unit with the acyl group, DS3 stands for a substitution degree of the hydroxyl group at 3-position of the glucose unit with the acyl group, and DS6 stands for a substitution degree of the hydroxyl group at 6-position of the glucose unit with the acyl group.

(2-2) An optical compensation film as described in (2-1), wherein the cellulose acylate film contains at least one retardation developer comprising a rod-shaped or discotic compound.

(2-3) An optical compensation film as described in (2-1) or (2-2), wherein a difference between retardation values Re(550) of the cellulose acylate film under conditions of 25° C.-10% RH and 25°-80% RH, ΔRe (Re10% RH-Re80% RH), is 12 nm or below and a difference between retardation values Rth(550) of the cellulose acylate film under conditions of 25° C.-10% RH and 25°-80% RH, ΔRth (Rth10% RH-Rth80% RH), is 32 nm or below.

[In the above (2-3), Re(λ) is an in-plane retardation expressed in the units nm at a wavelength of λ nm and Rth(λ) is a thickness-direction retardation expressed in the units nm at a wavelength of λ nm.]

(2-4) A polarizing plate as described in any of (2-1) to (2-3), wherein the liquid crystalline compound is a discotic liquid crystalline compound.

(2-5) A polarizing plate having an optical compensation film as described in any of (2-1) to (2-4) and a polarizer.

(2-6) A liquid crystal display having a liquid crystal cell and an optical compensation film as described in any of (2-1) to (2-4) or a polarizing plate as described in (2-5).

(2-7) A liquid crystal display as described in (2-6), wherein an OCB mode is employed.

In the invention, the following modes are also preferred.

(2-8) An optical compensation film as described in any of (2-1) to (2-4), wherein the acyl group in the cellulose acylate film is an acetyl group.

(2-9) An optical compensation film as described in any of (2-1) to (2-4), wherein the cellulose acylate film contains at least one additive selected from a plasticizer, an ultraviolet absorbent or a parting accelerator.

(2-10) An optical compensation film as described in any of (2-1) to (2-4), wherein the cellulose acylate film has a thickness of 40 μm to 180 μm.

(2-11) An optical compensation film as described in any of (2-1) to (2-4), wherein a content of the additive in the cellulose acylate film is from 10 to 30% of the mass of the cellulose acylate film.

(2-12) An optical compensation film as described in any of (2-1) to (2-4), wherein the cellulose acylate film has an equilibrium moisture content of 3.4% or below at a temperature of 25° C. and a humidity of 80% RH.

(2-13) An optical compensation film as described in any of (2-1) to (2-4), wherein a moisture permeability of the cellulose acylate film under conditions of 60° C., 95% RH and 24 hr is from 400 g/m²·24 hr to 2,300 g/m²·24 hr (calculated in terms of film thickness of 80 μm).

(2-14) An optical compensation film as described in any of (2-1) to (2-4), wherein the cellulose acylate film has a mass change of 0 to 5% when allowed to stand for 48 hours under conditions of 80° C. and 90% RH.

(2-15) An optical compensation film as described in any of (2-1) to (2-4), wherein a dimensional change caused in the cellulose acylate film when allowed to stand for 24 hours under conditions of 60° C. and 95% RH and a dimensional change caused in the cellulose acylate film when allowed to stand for 24 hours under conditions of 90° C. and 5% RH are both in a range of 0% to 5%.

(2-16) An optical compensation film as described in any of (2-1) to (2-4), wherein the cellulose acylate film has a glass transition temperature Tg of 80° C. to 180° C.

(2-17) An optical compensation film as described in any of (2-1) to (2-4), wherein the cellulose acylate film has an elasticity modulus of 1,500 MPa to 5,000 MPa.

(2-18) An optical compensation film as described in any of (2-1) to (2-4), wherein the cellulose acylate film has a photoelasticity coefficient of 50×10⁻¹³ cm²/dyne or below.

(2-19) An optical compensation film as described in any of (2-1) to (2-4), wherein the cellulose acylate film has a haze of 0.01% to 2%.

(2-20) An optical compensation film as described in any of (2-1) to (2-4), wherein the cellulose acylate film contains fine particles of silicon dioxide ranging from 0.2 μm to 1.5 μm in average diameter of secondary particles.

(2-21) An optical compensation film as described in any of (2-1) to (2-16), wherein the crystalline compound is a discotic liquid crystalline compound.

(2-22) A polarizing plate as described in (2-5), further having at least one factor selected from a singl plate transmittance TT, a parallel transmittance PT, a cross transmittance CT or a polarization degree P satisfying the following expression (a), (b), (c) or (d), respectively, when measured under conditions of 25° C. and 60% RH: (a) 40.0≦TT≦45.0

(b) 30.0≦PT≦40.0

(c) CT≦2.0

(d) 95.0≦P

(2-23) A polarizing plate as described in (2-5), further satisfying at least one of the following expressions (e), (f) and (g) concerning cross transmittances of the plate when a cross transmittance measured at a wavelength λ nm is denoted as CT(λ):

(e) CT(380)≦2.0

(f) CT(410)≦0.1

(g) CT(700)≦0.5

(2-24) A polarizing plate as described in (2-5), further having at least either an amount of change in a cross transmittance ΔCT or an amount of change in a polarization degree ΔP satisfying the following expression (j) or (k), respectively, when the plate is allowed to stand for 500 hours under conditions of 60° C. and 95% RH:

(j)−6.0≦ΔCT≦6.0

(k)−10.0≦ΔP≦0.0

(wherein the amount of change is defined as a value obtained by subtracting a measurement value before testing from a measurement value after testing).

(2-25) A polarizing plate as described in (2-5), further provided with at least one layer chosen from a hard coating layer, an antiglare layer or an antireflective layer oil the surface of a protective film to be positioned opposite to a liquid crystal cell.

(2-26) A polarizing plate as described in (2-5), which is packaged in a moisture-proof bag having an inside humidity adjusted to a range of 43% RH to 65% RH at 25° C.

(2-27) A polarizing plate as described in (2-5), which is packaged in a moisture-proof bag having an inside humidity adjusted so as to differ by 15% RH or below from the ambient humidity at which the polarizing plate is stacked on a liquid crystal panel.

In accordance with the invention, it is possible to provide an optical compensation film which uses a cellulose acylate film developing excellent in-plane and thickness-direction retardation characteristics and is reduced in retardation changes according to ambient humidity, and further to provide a polarizing plate using such an optical compensation film.

Further, the invention can provide a liquid crystal display reduced in change of viewing angle characteristics.

### BRIEF DESCRIPTION OF THE DRAWINGS

FIG. 1 is a schematic diagram showing an example of one pixel region in a liquid crystal display according to the invention.

FIG. 2 is a schematic diagram showing an example of a liquid crystal display according to the invention.

FIG. 3 is a schematic diagram showing another example of a liquid crystal display according to the invention.

### DETAILED DESCRIPTION OF THE INVENTION

Exemplary embodiments of the invention is described below in detail.

### (Cellulose Acylate)

Cellulose acylates preferably used in the invention will be described in detail. Each of glucose units which constitute cellulose through β-1,4 bonds has free hydroxyl groups at the 2-, 3-, and 6-positions thereof. The cellulose acylate is a polymer obtained by esterifying a part or the whole of these hydroxyl groups with acyl groups. The acyl substitution degrees DS2, DS3 and DS6 mean the rates of esterification for the hydroxyl groups at the 2-, 3- and 6-positions, respectively (in the case of 100 esterification, the substitution degree is 1).

The total degree of acyl substitution, or DS2+DS3+DS6, is preferably from 2.00 to 3.00, far preferably from 2.22 to 2.90, particularly preferably from 2.40 to 2.82. In addition, DS6/(DS2+DS3+DS6) is preferably 0.315 or above, far preferably 0.322 or above, particularly preferably from 0.324 to 0.340. Herein, DS2 stands for the substitution degree on the 2-position hydroxyl groups of glucose units (hereinafter referred to as “2-position acyl substitution degree”, too), DS3 stands for the substitution degree on the 3-position hydroxyl groups of glucose units (hereinafter referred to as “3-position acyl substitution degree”, too), and DS6 stands for the substitution degree on the 6-position hydroxyl groups of glucose units (hereinafter referred to as “6-position acyl substitution degree”, too).

Acyl groups used in the cellulose acylate according to the invention may be acyl groups of one kind alone, or made up of two or more kinds of acyl groups. When two or more kinds of acyl groups are used, one kind of them are preferably acetyl groups. When the total degree of substitution of acetyl groups for 2-position, 3-position and 6-position hydroxyl groups is denoted as DSA and the total degree of substitution of acyl groups other than acetyl groups for 2-position, 3-position and 6-position hydroxyl groups is denoted as DSB, the value of DSA+DSB is preferably from 2.2 to 2.86, particularly preferably from 2.40 to 2.80. In addition, the value of DSB is 1.50 or above, particularly preferably 1.7 or above. Further, at least 28% of the DSB value is the substitution degree on 6-position hydroxyl groups, Furthermore, the proportion of the substitution degree on 6-position hydroxyl groups in the DSB value is preferably 30% or above, far preferably 31% or above, particularly preferably 32% or above. Alternatively, it is possible to use a cellulose acylate film having at the 6-positions a DSA+DSB value of 0.75 or above, preferably 0.80 or above, particularly preferably 0.85 or above. These cellulose acylate films make it possible to prepare good solutions having favorable solubility, especially when chlorine-free organic solvents are used. In addition, solutions low in viscosity and high in filtration efficiency can be prepared by use of those films.

The acyl groups in cellulose acylate according to the invention, which have at least two carbon atoms per group, may be aliphatic groups or aromatic groups, and have no particular restrictions. The cellulose acylate may be an alkylcarbonyl or alkenylcarbonyl ester of cellulose, or an arylcarbonyl ester or aryl- and alkylcarbonyl ester of cellulose, which each may further have substituents. Suitable examples of such acyl groups include acetyl, propionyl, butanoyl, pentanoyl, hexanoyl, octanoyl decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl. Of these groups, acetyl, propionyl, butanoyl, dodecanoyl, octadecanoyl, t-butanoyl, oleoyl, benzoyl, naphthylcarbonyl and cinnamoyl are preferred over the others, and acetyl, propionyl and butanoyl in particular are favorable.

### (Method of Synthesizing Cellulose Acylate)

A basic principle of a synthetic method of the cellulose acylate is described in Migita et al., Wood Chemistry, pages 180 to 190 (Kyoritsu Shuppan Co., Ltd., 1968). A typical synthesis method is liquid phase esterification using a carboxylic acid anhydride, acetic acid and a sulfuric acid catalyst. Specifically, a cellulose starting material such as cotton linter or wood pulp is pretreated with an adequate amount of acetic acid, and then put into a previously cooled carboxylation mixture to perform esterification, thereby synthesizing a complete cellulose acylate (the sum of the substitution degrees at 2-, 3- and 6-positions is approximately 3). The above-mentioned carboxylation mixture generally contains acetic acid as a solvent, a carboxylic acid anhydride as an esterifying agent and sulfuric acid as a catalyst. The carboxylic acid anhydride is generally used in a stoichiometric excess of the total of cellulose to be reacted therewith and water existing in the system. After the termination of the acylation reaction, an aqueous solution of a neutralizing agent (for example, a carbonate, acetate or oxide of calcium, magnesium, iron, aluminum or zinc) is added for hydrolysis of excess carboxylic acid anhydride remaining in the system and neutralization of a part of the esterifying catalyst. Then, the resulting complete cellulose acylate is kept at 50 to 90° C. in the presence of a small amount of an acetylation reaction catalyst (generally, remaining sulfuric acid) to conduct saponification and aging, thereby changing the complete cellulose acylate to a cellulose acylate having a desired acyl substitution degree and polymerization degree. At the time when the desired cellulose acylate has been obtained, the catalyst remaining in the system is completely neutralized with the neutralizing agent as described above, or the cellulose acylate solution is put into water or diluted sulfuric acid (or water or diluted sulfuric acid is poured into the cellulose acylate solution) without neutralization to separate the cellulose acylate, followed by washing and stabilization treatment to obtain the cellulose acylate.

In the cellulose acylate film of the invention, it is preferred that the polymer components constituting the film substantially comprise the cellulose acylate defined above. The term “substantially” means 55% by mass or more (preferably 70% by mass or more, and more preferably 80% by mass or more) of the polymer components. As a starting material for film production, there are preferably used cellulose acylate particles. It is preferred that 90% by mass or more of the particles used have a particle size of 0.5 to 5 mm. Further, it is preferred that 50% by mass or more of the particles used have a particle size of 1 to 4 mm. The cellulose acylate particles preferably have a shape as similar to a sphere as possible.

The viscosity average polymerization degree of the cellulose acylate used in the invention is from 200 to 700, preferably from 250 to 550, more preferably from 250 to 400, and particularly preferably from 250 to 350. The average polymerization degree can be measured by a limiting viscosity method of Uda et al., (Kazuo Uda and Hideo Saito, Seni-Gakkai Shi (The Journal of the Society of Fiber Science and Technology, Japan) 18 (1), 105-120, 1962). It is further described in detail in JP-A-9-95538.

When low molecular weight components are removed from the cellulose acylate, the average molecular weight (polymerization degree) thereof becomes high. However, the viscosity thereof becomes lower than that of the ordinary cellulose acylate, so that the removal of the low molecular weight components is useful. The cellulose acylate containing the low molecular weight components in small amounts can be obtained by removing the low molecular weight components from a cellulose acylate synthesized by an ordinary method. The removal of the low molecular weight components can be carried out by washing the cellulose acylate with an appropriate organic solvent. When the cellulose acylate containing the low molecular weight components in small amounts is produced, the amount of the sulfuric acid catalyst in the acylation reaction is preferably adjusted to 0.5 to 25 parts by mass based on 100 parts by mass of cellulose. The cellulose acylate which is also preferred in terms of molecular weight distribution (uniform in molecular weight distribution) can be synthesized by adjusting the amount of the sulfuric acid catalyst within the above-mentioned range. When used in the production of the cellulose acylate film of the invention, the cellulose acylate has preferably a water content of 2% by mass or less, more preferably a water content of 1% by mass or less, and particularly preferably a water content of 0.7% by mass or less. In general, the cellulose acylate contains water, and the water content thereof is known to be from 2.5 to 5% by mass. In order to adjust the cellulose acylate to this water content in the invention, drying is required, and a method therefor is not particularly limited, as long as the desired water content is attained.

Starting material cotton and synthesis methods of these cellulose acylates used in the invention are described in JIII Journal of Technical Disclosure No. 2001-1745, pages 7 to 12 (published on May 15, 2001, Japan Institute of Invention and Innovation) in detail.

### (Additives)

Various additives (for example, a plasticizer, an ultraviolet absorber, a deterioration inhibitor, retardation (optical anisotropic) developer, fine particles, a releasing agent and an infrared absorber) can be added to the cellulose acylate solution in the invention in each preparation step depending on its use, and may be either solids or oily products. That is to say, there is no particular limitation on their melting point and boiling point. For example, an ultraviolet absorber having a melting point of 20° C. or lower and that having a melting point of higher than 20° C. may be mixed with each other, or plasticizers may be similarly mixed, which is described, for example, in JP-A-2001-151901. Examples of the releasing agents include ethyl esters of citric acid. Further, infrared absorbing dyes are described, for example, in JP-A-2001-194522. The addition may be performed at any time of the dope-producing process, and a step for adding the additives may be added as a final step of the dope-producing process. Furthermore, there is no particular limitation on the amount of each material added, as long as its function is exhibited. When the cellulose acylate film is formed in multiple layers, the kinds of additives and amounts thereof added in the respective layers may be different. This is described, for example, in JP-A-2001-151902, and is a technique which has hitherto been known. It is preferred to adjust the glass transition temperature (Tg) of the cellulose acylate film to 70 to 145° C. and the elastic modulus measured with a tensile tester to 1,500 to 3,000 MPa by selecting the kinds of these additives and amounts thereof added. Further, there are preferably used materials described in JIII Journal of Technical Disclosure No. 2001-1745, from page 16 on (published on May 15, 2001, Japan Institute of Invention and Innovation) in detail.

### (Plasticizer)

It is preferable that the present film contains a plasticizer. Compounds usable as the plasticizer in the present film have no particular restrictions, but they are preferably more hydrophobic than cellulose acylate, with examples including phosphoric acid esters, such as triphenyl phosphate, tricresyl phosphate, cresyldiphenyl phosphate, octyldiphenyl phosphate, diphenylbiphenyl phosphate, trioctyl phosphate and tributyl phosphate, phthalic acid esters, such as diethyl phthalate, dimethoxyethyl phthalate, dimethyl phthalate, dioctyl phthalate, dibutyl phthalate and di-2-ethylhexyl phthalate, and glycolic acid esters, such as triacetin, tributyrin, butylphthalylbutyl glycolate, ethylphthalylethyl glycolate, methylphthalylethyl glycolate and butylphthalylbutyl glycolate. These plasticizers may be used alone or as combinations of two or more thereof, if needed.

### (Retardation Developer)

For making the retardation values develop in the invention, it is appropriate that a compound having at least two aromatic rings be used as retardation developer. The amount of a retardation developer used is preferably from 0.05 to 20 parts by mass, far preferably from 0.1 to 10 parts by mass, further preferably from 0.2 to 5 parts by mass, particularly preferably from 0.5 to 2 parts by mass, per 100 parts by mass of polymer. Two or more of retardation developers may be used in combination.

It is preferable that the retardation developer used has its maximum absorption in a wavelength region of 250 nm to 400 nm and substantially no absorption in the visible region.

The term “aromatic rings” as used in the present specification is intended to include not only aromatic hydrocarbon rings but also aromatic heterocyclic rings.

It is especially preferable that the aromatic hydrocarbon rings are 6-membered rings (namely benzene rings).

The aromatic heterocyclic rings are generally unsaturated heterocyclic rings, and they are preferably 5-, 6- or 7-membered rings, far preferably 5- or 6-membered rings. The aromatic heterocyclic rings each generally have the most double bonds. The hetero-atoms containable therein are preferably nitrogen, oxygen and sulfur atoms, notably nitrogen atom. Examples of an aromatic heterocyclic ring include a furan ring, a thiophene ring, a pyrrole ring, an oxazole ring, an isooxazole ring, a thiazole ring, an isothiazole ring, an imidazole ring, a pyrazole ring, a furazane ring, a trizole ring, a pyran ring, a pyridine ring, a pyridazine ring, a pyrimidine ring, a pyrazine ring and 1,3,5-triazine ring.

Suitable aromatic rings are a benzene ring, a furan ring, a thiophene ring, a pyrrole ring, an oxazole ring, a thiazole ring, an imidazole ring, a triazole ring, a pyridine ring, a pyrimidine ring, a pyrazine ring and a 1,3,5-triazine ring. Of these rings, a 1,3,5-triazine ring is especially preferred. More specifically, the compounds disclosed in JP-A-2001-166144 can be used to advantage.

The number of aromatic rings the retardation developer has is preferably from 2 to 20, far preferably from 2 to 12, further preferably from 2 to 8, particularly preferably from 2 to 6.

The bonding relation between two aromatic rings can fall into (a) a case where the rings form a fused ring, (b) a case where the rings are directly bound by a single bond, or (c) a case where the rings are bonded via a linkage group (wherein it is impossible to form a spiro-bonding because the two rings are aromatic ones). The bonding relation herein may be any of (a) to (c).

Examples of a fused ring (formed from two or more aromatic rings) in the case (a) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, acridine ring, a phenanthridine ring, a xanthene ring, a phenazine ring, a phenothiazine ring, a phenoxthine ring, a phenoxazine ring and a thianthrene ring. Of these rings, a naphthalene ring, an azulene ring, an indole ring, a benzoxazole ring, a benzothiazole ring, a benzoimidazole ring, a benzotriazole ring and a quinoline ring are preferred over the others.

The single bond in the case (b) is preferably a carbon-carbon bond between two aromatic rings. The two aromatic rings may be bound by two or more single bonds to form an aliphatic ring or a non-aromatic heterocyclic ring between them.

It is preferable that the linkage group in the case (c) is also attached to carbon atoms of two aromatic rings. The linkage group is preferably an alkylene group, an alkenylene group, an alkynylene group, —CO—, —O—, —NH—, —S— or a combination of two or more thereof. Examples of a linkage group formed by combining any two or more of the above-recited ones are shown below. Additionally, each of the linkage groups recited below may be reversed left to right.

c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkenylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic rings and the linkage groups may have substituents.

Examples of such substituents include halogen atoms (F, Cl, Br, I), a hydroxyl group, a carboxyl group, a cyano group, an amino group, a nitro group, a sulfo group, a carbamoyl group, a sulfamoyl group, a ureido group, an allyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amido group, an aliphatic sulfonamido group, an aliphatic substituted amino group, an aliphatic substituted carbamoyl group, an aliphatic substituted sulfamoyl group, an aliphatic substituted ureido group and non-aromatic heterocyclic group.

The number of carbon atoms in the alkyl group is preferably from 1 to 8. Linear alkyl groups are preferable to cycloalkyl groups, and straight-chain alkyl groups are especially preferred. These alkyl groups may further have substituents (such as hydroxyl, carboxyl, alkoxy and alkyl-substituted amino groups). Examples of such alkyl groups (including substituted alkyl groups) include methyl, ethyl, n-butyl, n-hexyl, 2-hydroxyethyl, 4-carboxybutyl, 2-methoxyethyl and 2-diethylaminoethyl.

The number of carbon atoms in the alkenyl group is preferably from 2 to 8. Linear alkenyl groups are preferable to cyclic alkenyl groups, and straight-chain alkenyl groups are especially preferred. These alkenyl groups may further have substituents. Examples of such alkenyl groups include vinyl, allyl and 1-hexenyl.

The number of carbon atoms in the alkynyl group is preferably from 2 to 8. Linear alkynyl groups are preferable to cyclic alkynyl groups, and straight-chain alkynyl groups are especially preferred. These alkynyl groups may further have substituents. Examples of such alkynyl groups include ethynyl, 1-butynyl and 1-hexynyl.

The number of carbon atoms in the aliphatic acyl group is preferably from 1 to 10. Examples of such an aliphatic acyl group include acetyl, propanoyl and butanoyl.

The number of carbon atoms in the aliphatic acyloxy group is preferably from 1 to 10. Examples of such an aliphatic acyloxy group include acetoxy.

The number of carbon atoms in the alkoxy group is preferably from 1 to 8. Such an alkoxy group may further have a substituent (such as an alkoxy group). Examples of the alkoxy group (including a substituted alkoxy group) include methoxy, ethoxy, butoxy and methoxyethoxy.

The number of carbon atoms in the alkoxycarbonyl group is preferably from 2 to 10. Examples of such an alkoxycarbonyl group include methoxycarbonyl and ethoxycarbonyl.

The number of carbon atoms in the alkoxycarbonylamino group is preferably from 2 to 10. Examples of such an alkoxycarbonylamino group include methoxycarbonylamino and ethoxycarbonylamino.

The number of carbon atoms in the alkylthio group is preferably from 1 to 12. Examples of such an alkylthio group include methylthio, ethylthio and octylthio.

The number of carbon atoms in the alkylsulfonyl group is preferably from 1 to 8. Examples of such an alkylsulfonyl group include methanesulfonyl and ethanesulfonyl.

The number of carbon atoms in the aliphatic amido group is preferably from 1 to 10. Examples of such an amido group include acetamido.

The number of carbon atoms in the aliphatic sulfonamido group is preferably from 1 to 8. Examples of such an aliphatic sulfonamido group include methanesulfonamido, butanesulfonamido and n-octanesulfonamido.

The number of carbon atoms in the aliphatic substituted amino group is preferably from 1 to 10. Examples of such an aliphatic substituted amino group include dimethylamino, diethylamino and 2-carboxyethylamino.

The number of carbon atoms in the aliphatic substituted carbamoyl group is preferably from 2 to 10. Examples of such an aliphatic substituted carbamoyl group include methylcarbamoyl and diethylcarbamoyl.

The number of carbon atoms in the aliphatic substituted sulfamoyl group is preferably from 1 to 8. Examples of such an aliphatic substituted sulfamoyl group include methylsulfamoyl and diethylsulfamoyl.

The number of carbon atoms in the aliphatic substituted ureido group is preferably from 2 to 10 Examples of such an aliphatic substituted ureido group include methylureido.

Examples of the non-aromatic heterocyclic group include piperidino and morpholino.

The molecular weight of retardation developer is preferably from 300 to 800.

In the invention, it is preferable that a rod-shaped or discotic compound is used as retardation developer, and a rod-shaped compound having a linear molecular structure besides a compound having a 1,3,5-triazine ring is used to particular advantage. The term “linear molecular structure” means that the thermodynamically most stable molecular structure of a rod-shaped compound is linear. The thermodynamically most stable structure can be determined by crystal structure analysis or molecular orbital calculation. For instance, the molecular orbital calculations can be made using a software program for molecular orbital calculations (e.g., WinMOPAC2000, produced by Fujitsu) and thereby the molecular structure capable of minimizing the heat for forming the intended compound can be determined. The expression “the molecular structure is linear” means that the main chain in the thermodynamically most stable molecular structure forms an angle of 140 degrees or above.

As a rod-shaped compound having at least two aromatic rings, those represented by the following formula (1) are suitable:

Ar¹-L¹-Ar² Formula (1)

In the above formula (1), Ar¹ and Ar² each represent an aromatic group independently.

The term “aromatic group” as used herein is intended to include aryl groups (aromatic hydrocarbon groups), substituted aryl groups, aromatic heterocyclic groups and aromatic substituted heterocyclic groups.

Aryl groups and substituted aryl groups are preferable to aromatic heterocyclic groups and aromatic substituted heterocyclic groups. The heterocyclic rings of aromatic heterocyclic groups are generally unsaturated rings, and they are preferably 5-, 6- or 7-membered rings, far preferably 5- or 6-membered rings. The aromatic heterocyclic rings each generally have the most double bonds. The hetero-atom containable therein is preferably a nitrogen, oxygen or sulfur atom, far preferably a nitrogen or sulfur atom.

Examples of the aromatic ring in an aromatic group include a benzene ring, a furan ring, a thiophene ring, a pyrrole ring, an oxazole ring, a thiazole ring, an imidazole ring, a trizole ring, a pyridine ring, a pyrimidine ring and a pyrazine ring. Of these rings, a benzene ring is preferred over the others.

Examples of substituents present in the substituted aryl group and the aromatic substituted heterocyclic group include halogen atoms (F, Cl, Br, I), a hydroxyl group, a carboxyl group, a cyano group, an amino group, alkylamino groups (e.g., methylamino, ethylamino, butylamino, dimethylamino), a nitro group, a sulfo group, a carbamoyl group, an alkylcarbamoyl groups (e.g., N-methylcarbamoyl, N-ethylcarbamoyl, N,N-dimethylcarbamoyl), a sulfamoyl group, alkylsulfamoyl groups (e.g., N-methylsulfamoyl, N-ethylsulfamoyl, N,N-dimethylsulfamoyl), an ureido group, alkylureido groups (e.g., N-methylureido, N,N-dimethylureido, N,N,N′-trimethylureido), alkyl groups (e.g., methyl, ethyl, propyl, butyl, pentyl, heptyl, octyl, isopropyl, s-butyl, t-amyl, cyclohexyl, cyclopentyl), alkenyl groups (e.g., vinyl, allyl, hexenyl), alkynyl groups (e.g., ethynyl, butynyl), acyl groups (e.g., formyl, acetyl, butyryl, hexannoyl, lauryl), acyloxy groups (e.g., acetoxy, butryloxy, hexanoyloxy, lauryloxy), alkoxy groups (e.g., methoxy, ethoxy, propoxy, butoxy, pentyloxy, heptyloxy, octyloxy), aryloxy groups (e.g., phenoxy), alkoxycarbonyl groups (e.g., methoxycarbonyl, ethoxycarbonyl, propoxycarbonyl, butoxycarbonyl, pentyloxycarbonyl, heptyloxycarbonyl), aryloxycarbonyl groups (e.g., phenoxycarbonyl), alkoxycarbonylamino groups (e.g., butoxycarbonylamino, hexyloxycarbonylamino), alkylthio groups (e.g., methylthio, ethylthio, propylthio, butylthio, pentylthio, heptylthio, octylthio), arylthio groups (e.g., phenylthio), alkylsulfonyl groups (e.g., methylsulfonyl, ethylsulfonyl, propylsulfonyl, butylsulfonyl, pentylsulfonyl, heptylsulfonyl, octylsulfonyl), amido groups (e.g., acetamido, butylamido, hexylamido, laurylamido), and non-aromatic heterocyclic groups (e.g., morpholino, pyrazinyl).

Of these substituents, halogen atoms, a cyano group, a carboxyl group, a hydroxyl group, an amino group, alkylamino groups, acyl groups, acyloxy groups, amido groups, alkoxycarbonyl groups, alkoxy groups, alkylthio groups and alkyl groups are preferred over the others.

The alkyl moieties of alkylamino, alkoxycarbonyl, alkoxy and alkylthio groups and the alkyl groups may further have substituents. Examples of substituents the alkyl moieties and alkyl groups may have include halogen atoms, a hydroxyl group, a carboxyl group, a cyano group, an amino group, alkylamino groups, a nitro group, a sulfo group, a carbamoyl group, alkylcarbamoyl groups, a sulfamoyl group, alkylsulfamoyl groups, a ureido group, alkylureido groups, alkenyl groups, alkynyl groups, acyl groups, acyloxy groups, alkoxy groups, aryloxy groups, alkoxycarbonyl groups, aryloxycarbonyl groups, alkoxycarbonylamino groups, alkylthio groups, arylthio groups, alkylsulfonyl groups, amido groups and non-aromatic heterocyclic groups. Of these substituents, halogen atoms, a hydroxyl group, an amino group, alkylamino groups, acyl groups, acyloxy groups, acylamino groups, alkoxycarbonyl groups and alkoxy groups are preferred over the others.

In formula (1), L¹ is a divalent linkage group selected from alkylene groups, alkenylene groups, alkynylene groups, —O—, —CO— or combinations of two or more thereof. The alkylene groups may have cyclic structures. As cycloalkylene groups, cyclohexylene groups, especially 1,4-cyclohexylene, are suitable. As to open-chain alkylene groups, straight-chain alkylene groups are preferable to branched-chain alkylene groups.

The number of carbon atoms in such an alkylene group is preferably from 1 to 20, far preferably from 1 to 15, further preferably from 1 to 10, furthermore preferably from 1 to 8, especially preferably from 1 to 6.

The alkenylene and alkynylene groups having open-chain structures are preferable to those having cyclic structures, and further the alkenylene and alkynylene groups having straight-chain structures are preferable to those having branched-chain structures. It is appropriate that the number of carbon atoms in such an alkenylene group and that in such an alkynylene group be each from 2 to 10, preferably from 2 to 8, far preferably from 2 to 6, further preferably from 2 to 4, especially preferably 2 (vinylene and ethynylene).

The number of carbon atoms in such an aryl group is preferably from 6 to 20, far preferably from 6 to 16, further preferably from 6 to 12.

The angle that Ar¹ forms with Ar² in a state that they face each other across L¹ is preferably at least 140 degrees.

As the rod-shaped compound, compounds represented by the following formula (2) are more suitable.

Ar¹-L²-X-L³-Ar² Formula (2)

In the above formula (2), Ar¹ and Ar² are aromatic groups independently. The definition and examples of the aromatic groups as Ar¹ and Ar² are the same as those in formula (1).

In formula (2), L2 and L3 each represent a divalent linkage group selected from an alkylene group, —O—, —CO— or a combination of two or more thereof.

As to the alkylene group, an alkylene group having an open-chain structure is preferable to an alkylene group having a cyclic structure, and further a straight-chain alkylene group is preferable to a branched-chain alkylene group.

The number of carbon atoms in such an alkylene group is preferably from 1 to 10, far preferably from 1 to 8, further preferably from 1 to 6, and especially preferably from 1 to 4. However, the best number is 1 or 2 (corresponding to methylene or ethylene).

As L² and L³ each, —O—CO— or —CO—O— is most suitable.

In formula (2), X is 1,4-cyclohexylene, vinylene or ethynylene.

Examples of a compound represented by formula (1) are illustrated below.

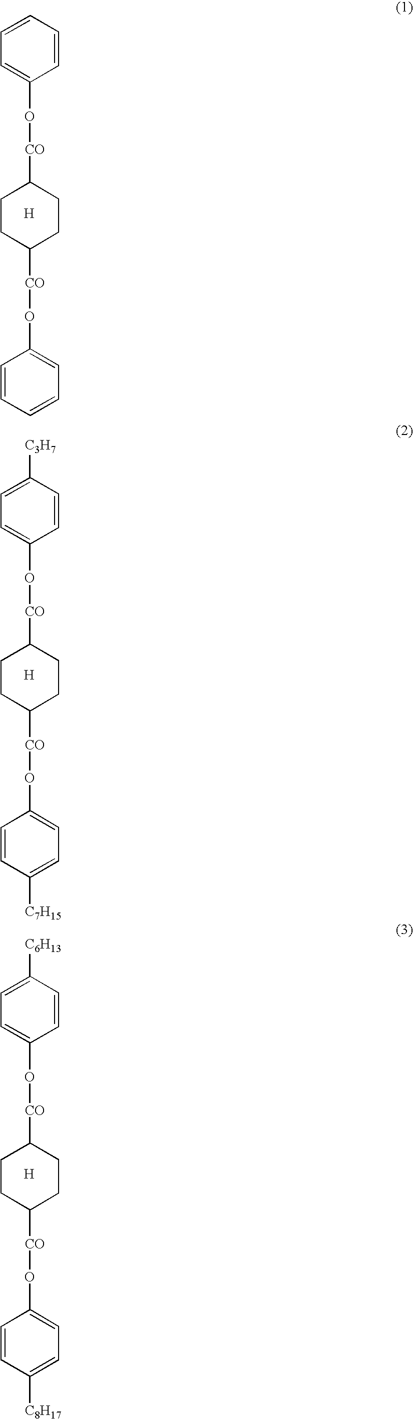

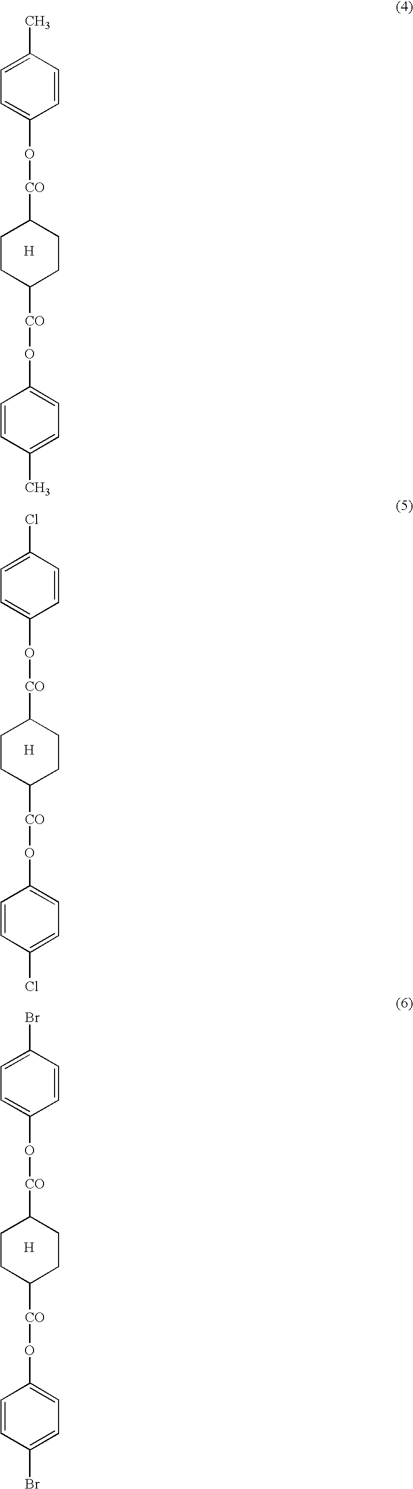

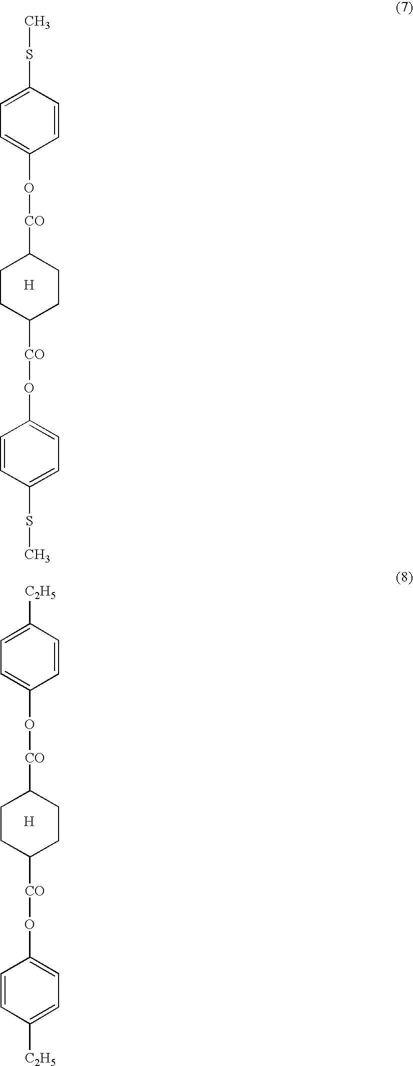

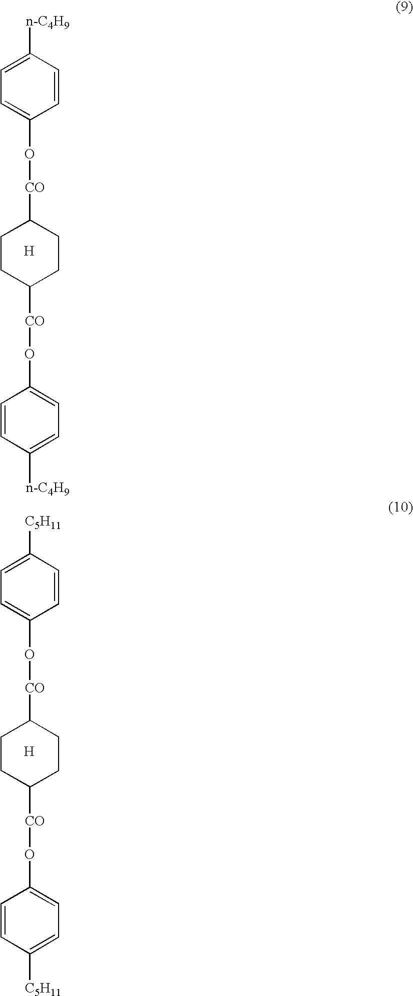

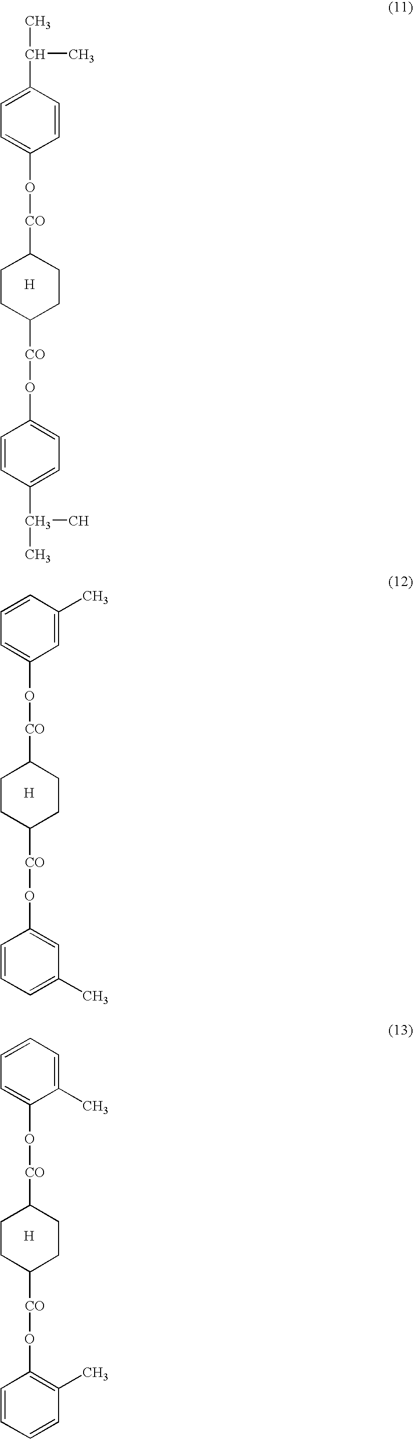

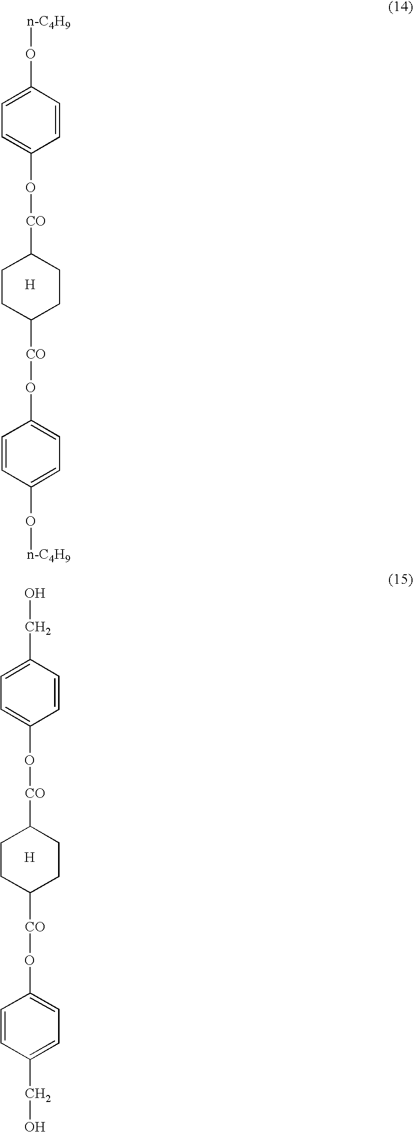

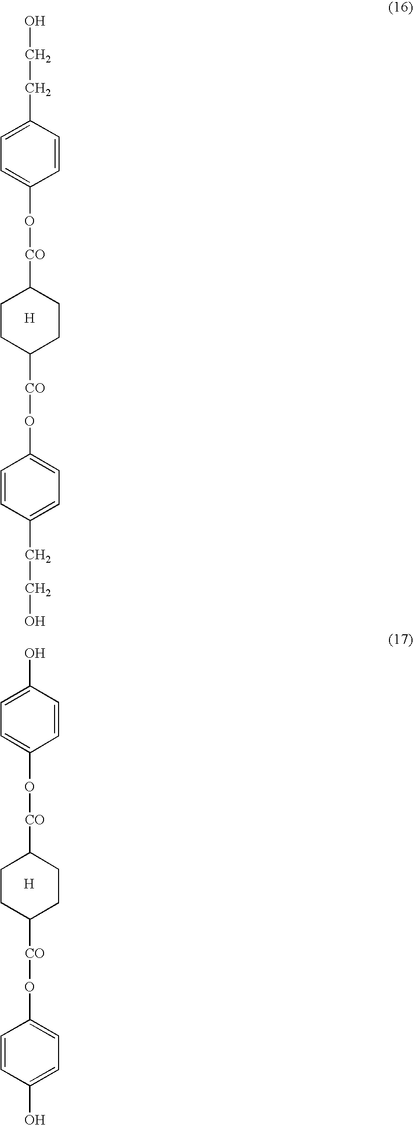

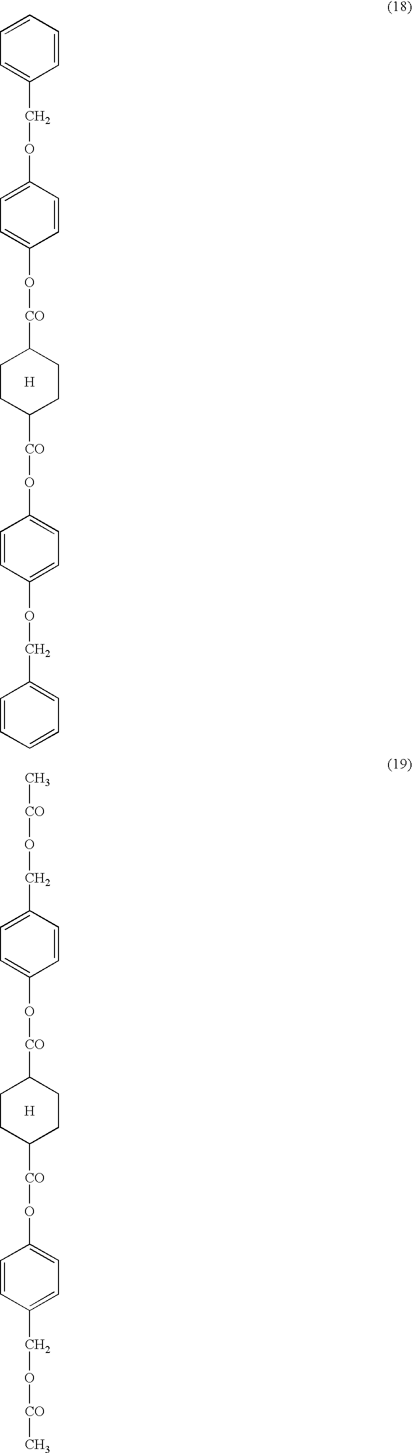

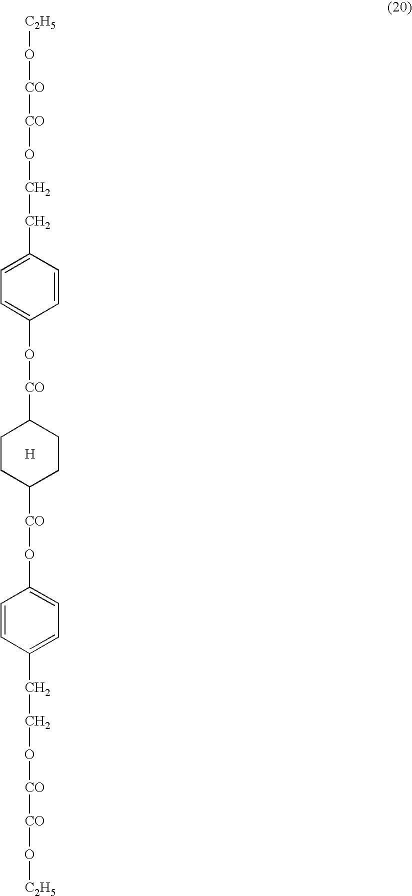

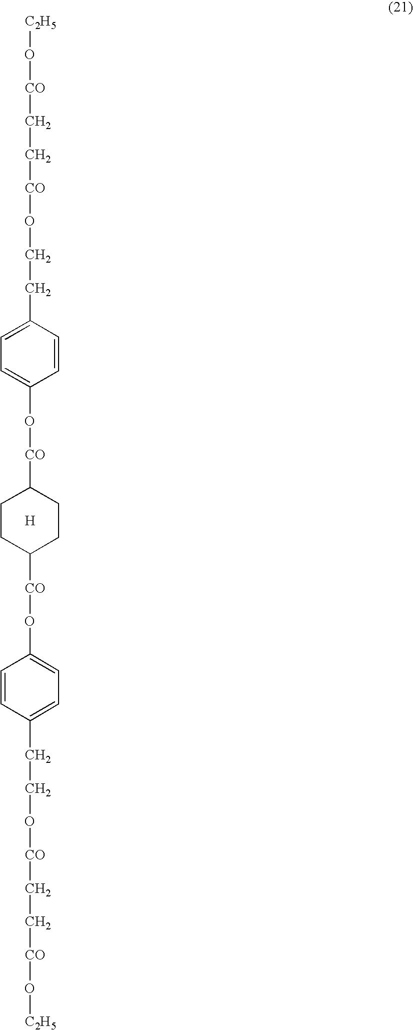

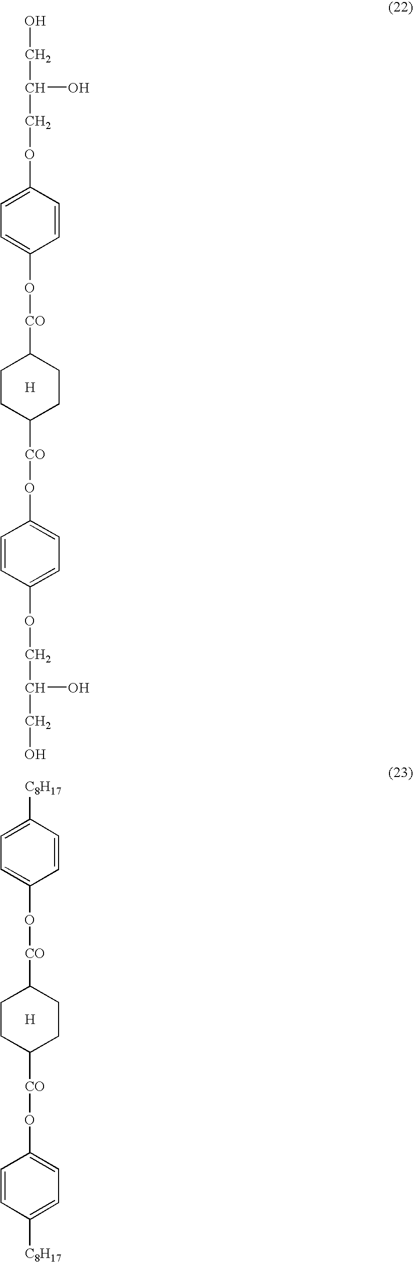

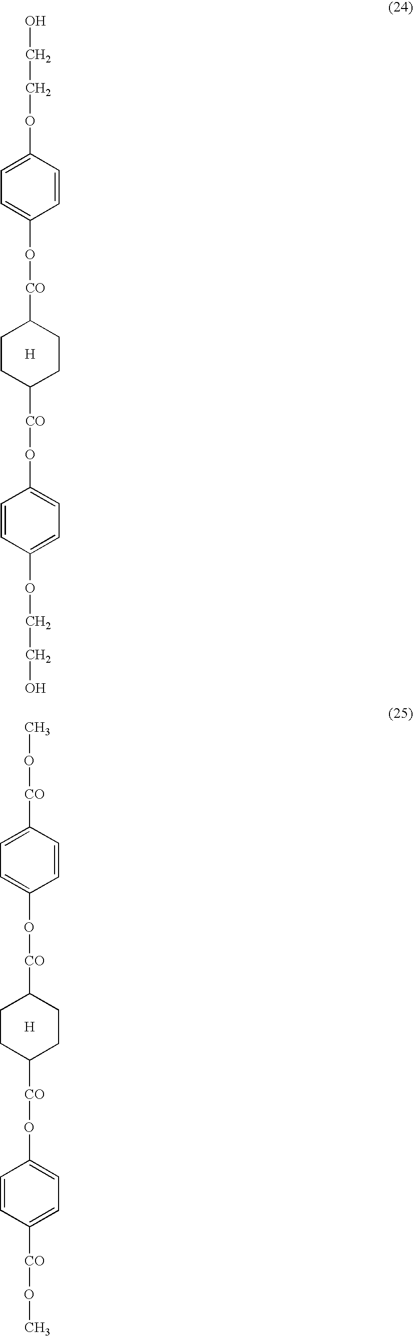

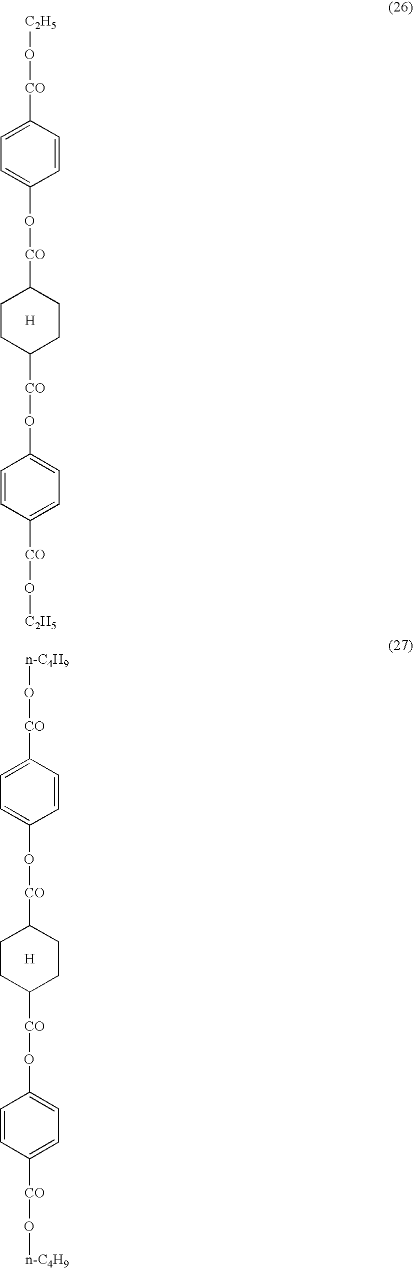

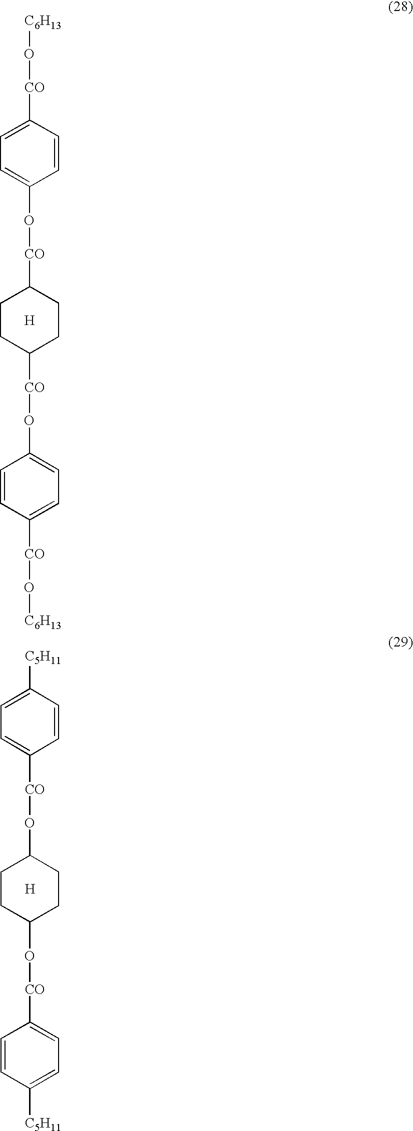

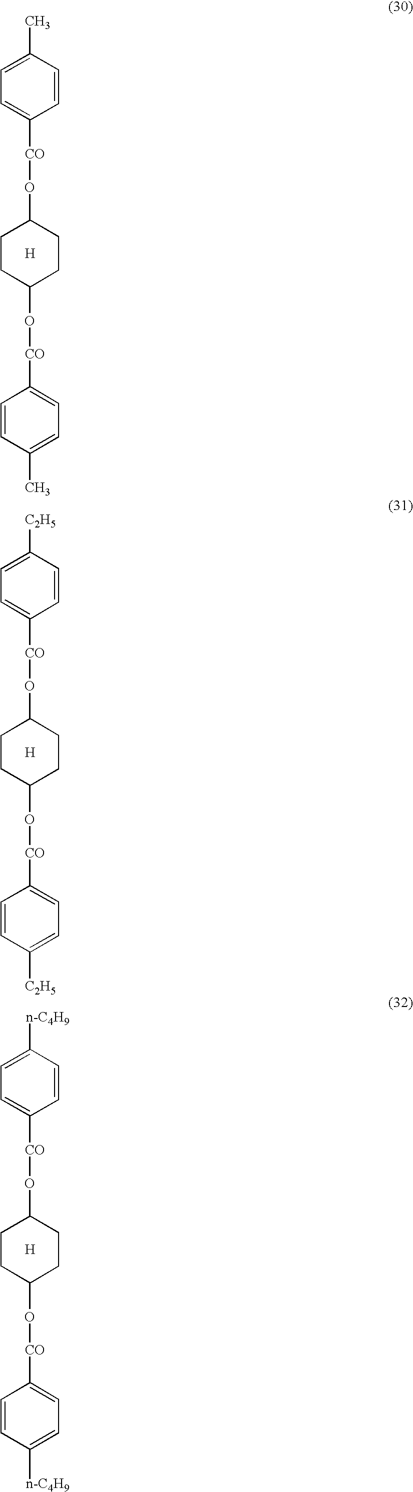

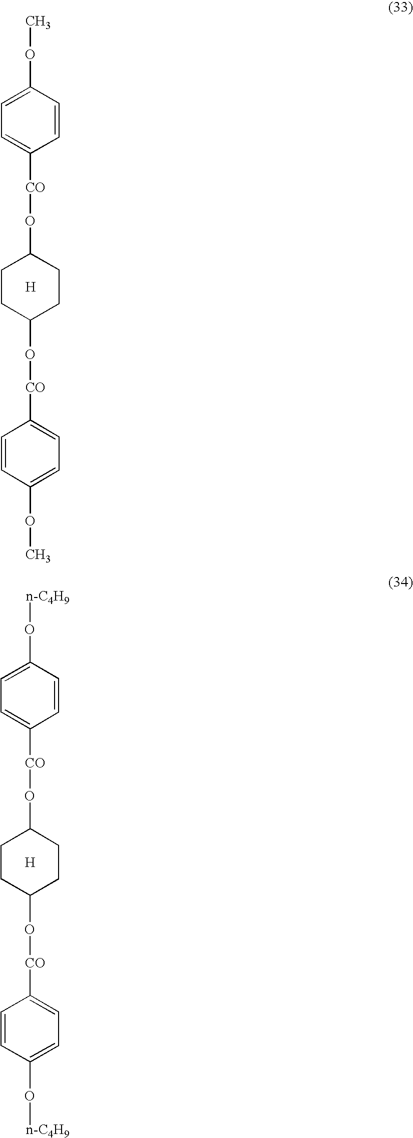

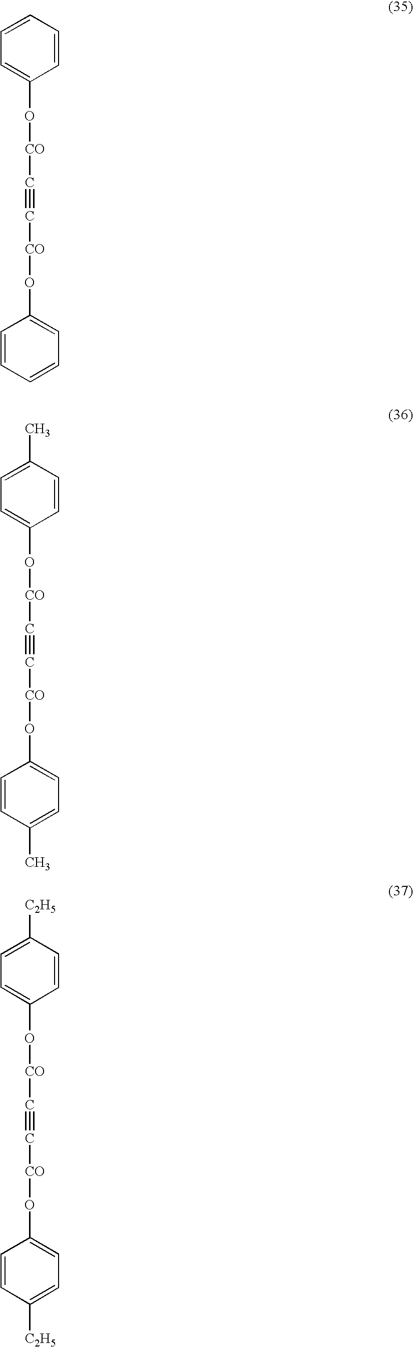

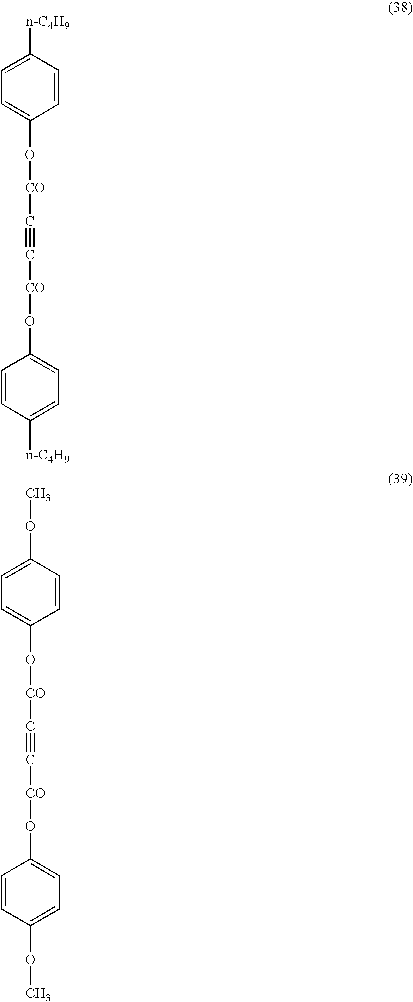

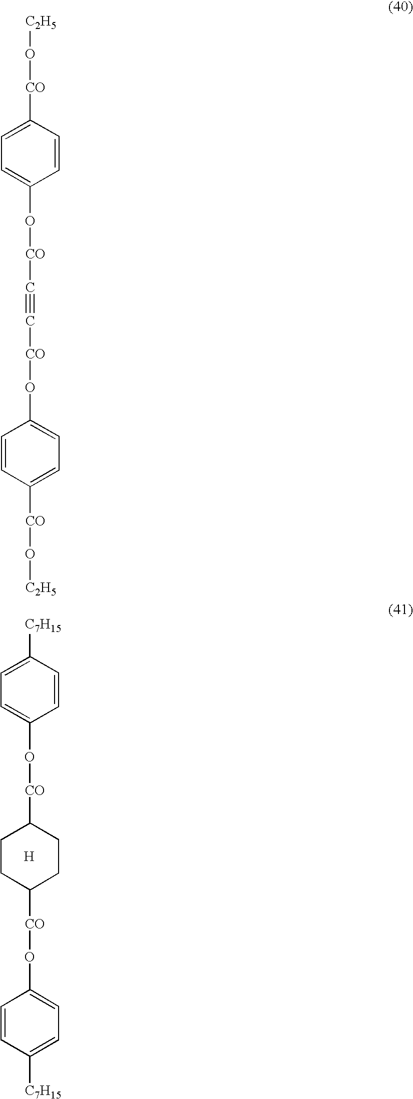

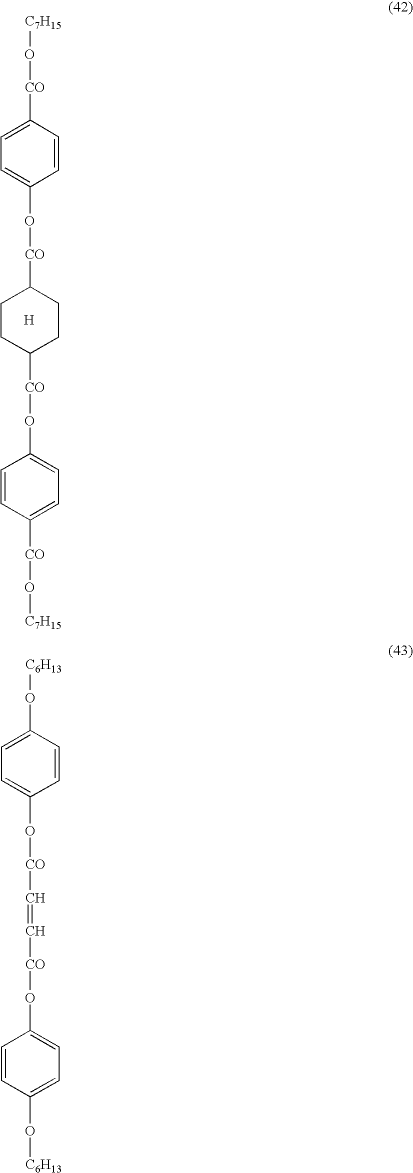

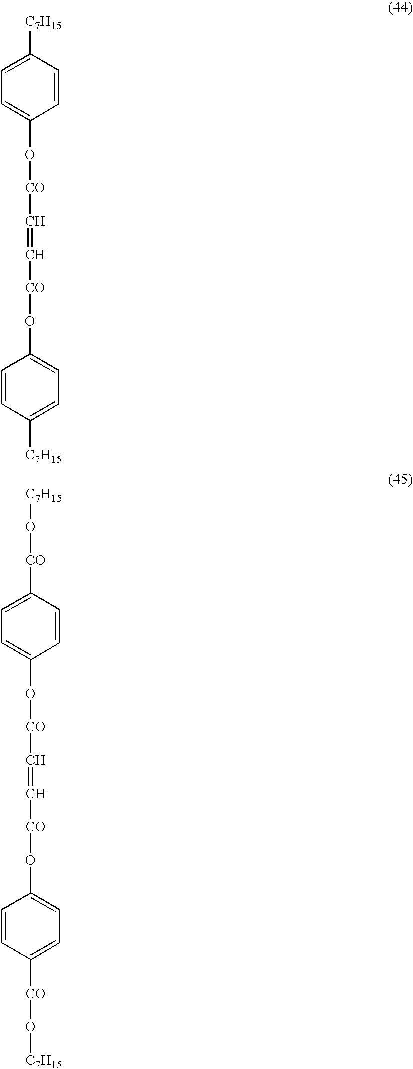

Exemplified Compounds (1) to (34), (41) and (42) each have two asymmetric carbon atoms at the 1- and 4-positions. However, the exemplified Compounds (1), (4) to (34), (41) and (42) have symmetric meso-form molecular structures, so neither of them has optical isomers (optical activity) but each has only geometric isomers (trans-form and cis-form). The trans-form (1-trans) and cis-form (1-cis) Exemplified Compound (1) are illustrated below.

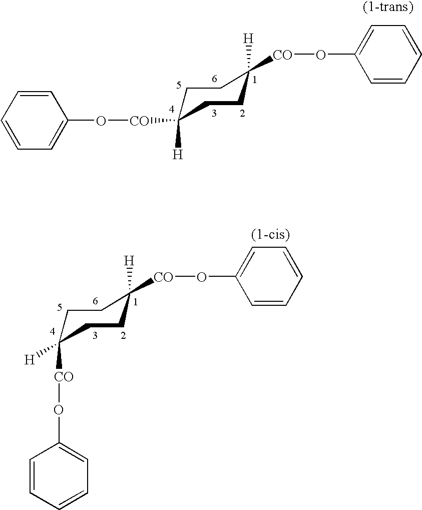

As mentioned above, it is preferable that rod-shaped compounds for use in the invention have linear structures. Therefore, the trans-form compounds are preferable to the cis-form compounds.

The exemplified Compounds (2) and (3) each have optical isomers in addition to geometric isomers (a total of 4 isomers). As to the geometric isomers, the trans-form is preferable to the cis-form as mentioned above. As to the optical isomers, however, it is not worth to mention that one is better than the other. So they may have any of dextro (D), levo (L) and racemic forms.

In each of the exemplified Compounds (43) to (45), the vinylene linkage at the center, though may have either trans or cis form, preferably has the trans form for the same reason as mentioned above.

Other suitable compounds are shown below.

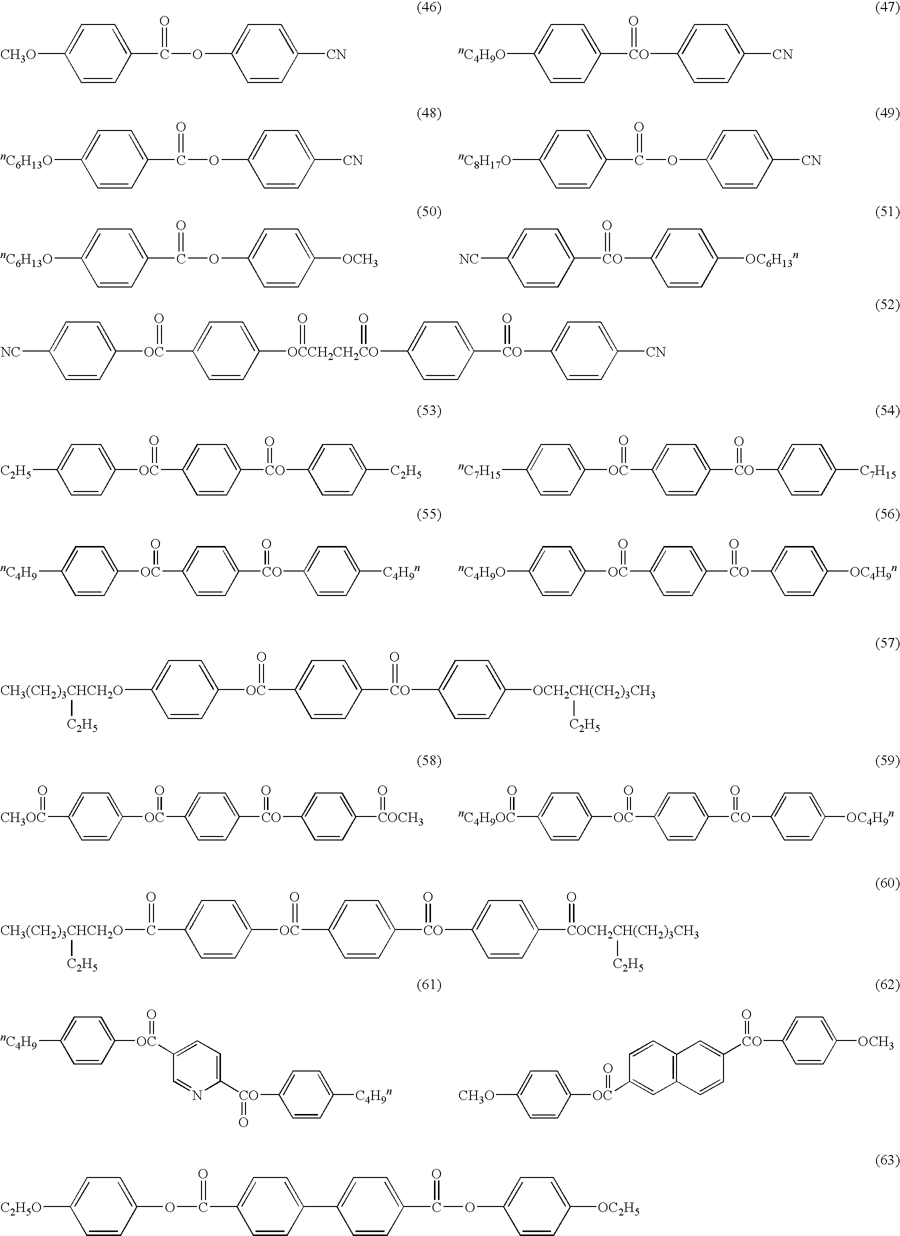

Two or more of rod-shaped compounds that show in the state of solutions ultraviolet absorption spectra wherein their maximum absorption wavelengths (λmax) are shorter than 250 nm may be used as a combination.

Rod-shaped compounds can be synthesized by reference to the methods described in documents. Examples of such documents include Mol. Cryst. Liq. Cryst., volume 53, page 229 (1979), ibid., volume 89, page 93 (1982), ibid., volume 145, page 111 (1987), ibid., volume 170, page 43 (1989), J. Am. Chem. Soc., volume 113, page 1349 (1991), ibid., volume 118, page 5346 (1996), ibid., volume 92, page 1582 (1970), J. Org. Chem., volume 40, page 420 (1975), and Tetrahedron, volume 48, number 16, page 3437 (1992).

The amount of a retardation developer added is preferably from 0.1% to 30% by mass, far preferably from 0.5% to 20% by mass, of the amount of polymer used.

The aromatic compound as recited above is used in an amount of preferably 0.01 to 20 parts by mass, far preferably 0.05 to 15 parts by mass, particularly preferably 0.1 to 10 parts by mass, per 100 parts by mass of cellulose acylate. Two or more of the aromatic compounds as recited above may be used as a combination.

Organic solvents in which the cellulose acylate is dissolved will be described in detail below.

### (Chlorine-Based Solvents)

In the preparation of the cellulose acylate solution in the invention, a chlorine-based organic solvent is preferably used as a main solvent. In the invention, the kind of chlorine-based organic solvent is not particularly limited, as long as its object can be attained within the range where the cellulose acylate can be dissolved to perform flow casting or film formation. These chlorine-based organic solvents are preferably dichloromethane and chloroform, and dichloromethane is particularly preferred. Further, there is no particular limitation on mixing with an organic solvent other than the chlorine-based organic solvent. In that case, it is necessary to use dichloromethane in an amount of at least 50% by mass. The non-chlorine-based organic solvent used in combination with the chlorine-based organic solvent will be described below. That is to say, the non-chlorine-based organic solvent is a solvent selected from an ester, ketone, ether and hydrocarbon, each of which has 3 to 12 carbon atoms. The ester, ketone, ether and hydrocarbon may have a cyclic structure. A compound having any two or more of ester, ketone and ether functional groups (that is to say, —O—, —CO— and —COO—) is also usable as a solvent. For example, the solvent may have another functional group such as an alcoholic hydroxyl group at the same time. In the case of the solvent having two or more kinds of functional groups, the number of carbon atoms of the solvent may be within the specified range for a compound having any one of the functional groups. Examples of the esters having 3 to 12 carbon atoms include ethyl formate, propyl formate, pentyl formate, methyl acetate, ethyl acetate and pentyl acetate. Examples of the ketones having 3 to 12 carbon atoms include acetone, methyl ethyl ketone, diethyl ketone, diisobutyl ketone, cyclopentanone, cyclohexanone and methylcyclohexane. Examples of the ethers having 3 to 12 carbon atoms include diisopropyl ether, dimethoxymethane, dimethoxyethane, 1,4-dioxane, 1,3-dioxolane, tetrahydrofuran, anisole and phenetole. Examples of the organic solvents having two or more kinds of functional groups include 2-ethoxyethyl acetate, 2-methoxyethanol and 2-butoxyethanol.

The alcohol used in combination with the chlorine-based organic solvent may be preferably straight-chain, branched or cyclic, and preferably a saturated aliphatic hydrocarbon among others. The hydroxyl group of the alcohol may be any of the primary to tertiary ones. Examples of the alcohols include methanol, ethanol, 1-propanol, 2-propanol, 1-butanol, 2-butanol, t-butanol, 1-pentanol, 2-methyl-2-butanol and cyclohexanol. As the alcohol, there is also usable a fluorine-based alcohol Examples thereof include 2-fluoroethanol, 2,2,2-trifluoroethanol and 2,2,3,3-tetrafluoro-1-propanol. Further, the hydrocarbon may be straight-chain, branched or cyclic. Either an aromatic hydrocarbon or an aliphatic hydrocarbon can be used. The aliphatic hydrocarbon may be saturated or unsaturated Examples of the hydrocarbons include cyclohexane, hexane, benzene, toluene and xylene.

Combinations of the chlorine-based organic solvents preferably used as main solvents in the invention include but are not limited to the following:
Dichloromethane/methanol/ethanol/butanol (75/10/5/5/5, parts by mass),
Dichloromethane/acetone/methanol/propanol (80/10/5/5, parts by mass),
Dichloromethane/methanol/butanol/cyclohexane (75/10/5/5/5, parts by mass),
Dichloromethane/methyl ethyl ketone/methanol/butanol (80/10/5/5, parts by mass),
Dichloromethane/acetone/methyl ethyl ketone/ethanol/isopropanol (75/8/5/5/7, parts by mass),
Dichloromethane/cyclopentanone/methanol/isopropanol (80/7/5/8, parts by mass),
Dichloromethane/methyl acetate/butanol (80/10/10, parts by mass),
Dichloromethane/cyclohexanone/methanol/hexane (70/20/5/5, parts by mass),
Dichloromethane/methyl ethyl ketone/acetone/methanol/ethanol (50/20/20/5/5, parts by mass),
Dichloromethane/1,3-dioxolane/methanol/ethanol (70/20/5/5, parts by mass),
Dichloromethane/dioxane/acetone/methanol/ethanol (60/20/10/5/5, parts by mass),
Dichloromethane/acetone/cyclopentanone/ethanol/isobutanol/cyclohexane (65/10/10/5/5/5, parts by mass),
Dichloromethane/methyl ethyl ketone/acetone/methanol/ethanol (70/10/10/5/5, parts by mass),
Dichloromethane/acetone/ethyl/acetate/ethanol/butanol/hexane (65/10/10/5/5/5, parts by mass),
Dichloromethane/methyl acetoacetate/methanol/ethanol (65/20/10/5, parts by mass), and
Dichloromethane/cyclopentanone/ethanol/butanol (65/20/10/5, parts by mass).

### (Non-Chlorine-Based Solvents)

Then, non-chlorine-based organic solvents preferably used in the preparation of the cellulose acylate solution in the invention will be described below. In the invention, the non-chlorine-based organic solvent is not particularly limited, as long as its object can be attained within the range where the cellulose acylate can be dissolved to perform flow casting or film formation. The non-chlorine-based organic solvent is preferably a solvent selected from an ester, ketone and ether, each of which has 3 to 12 carbon atoms. The ester, ketone, ether and hydrocarbon may have a cyclic structure. A compound having any two or more of ester, ketone and ether functional groups (that is to say, —O—, —CO— and —COO—) is also usable as a main solvent. For example, the solvent may have another functional group such as an alcoholic hydroxyl group. In the case of the solvent having two or more kinds of functional groups, the number of carbon atoms of the solvent may be within the specified range for a compound having any one of the functional groups. Examples of the esters having 3 to 12 carbon atoms include ethyl formate, propyl formate, pentyl formate, methyl acetate, ethyl acetate and pentyl acetate. Examples of the ketones having 3 to 12 carbon atoms include acetone, methyl ethyl ketone, diethyl ketone, diisobutyl ketone, cyclopentanone, cyclohexanone and methylcyclohexane. Examples of the ethers having 3 to 12 carbon atoms include diisopropyl ether, dimethoxymethane, dimethoxyethane, 1,4-dioxane, 1,3-dioxolane, tetrahydrofuran, anisole and phenetole. Examples of the organic solvents having two or more kinds of functional groups include 2-ethoxyethyl acetate, 2-methoxyethanol and 2-butoxyethanol.

The non-chlorine-based solvent used for the above-mentioned cellulose acylate is selected from the various viewpoints as described above, but is preferably as follows. That is to say, the preferred solvent for the cellulose acylate used in the invention is a mixed solvent composed of three or more kinds of solvents different from one another. The first solvent is at least one selected from methyl acetate, ethyl acetate, methyl formate, ethyl formate, acetone, dioxolane and dioxane, or a mixed solution thereof. The second solvent is selected from a ketone having 4 to 7 carbon atoms and an acetoacetic acid ester. The third solvent is selected from an alcohol or a hydrocarbon, each of which has 1 to 10 carbon atoms, and is preferably an alcohol having 1 to 8 carbon atoms. When the first solvent is a mixed solution of two or more solvents, the second solvent may not be used. The first solvent is more preferably methyl acetate, acetone, methyl formate, ethyl formate or a mixture thereof, and the second solvent is preferably methyl ethyl ketone, cyclopentanone, cyclohexanone, methyl acetylacetate or a mixed liquid thereof.

The alcohol, the third solvent, may be straight-chain, branched or cyclic, and preferably a saturated aliphatic hydrocarbon among others. The hydroxyl group of the alcohol may be any of the primary to tertiary ones. Examples of the alcohols include methanol, ethanol, 1-propanol, 2-propanol, 1-butanol, 2-butanol, t-butanol, 1-pentanol, 2-methyl-2-butanol and cyclohexanol. As the alcohol, there is also usable a fluorine-based alcohol. Examples thereof include 2-fluoroethanol, 2,2,2-trifluoroethanol and 2,2,3,3-tetrafluoro-1-propanol. Further, the hydrocarbon may be straight—chain, branched or cyclic. Either an aromatic hydrocarbon or an aliphatic hydrocarbon can be used. The aliphatic hydrocarbon may be saturated or unsaturated. Examples of the hydrocarbons include cyclohexane, hexane, benzene, toluene and xylene. These alcohols and hydrocarbons, the third solvents, may be used either alone or as a mixture of two or more thereof, and are not particularly limited thereby. Preferred specific examples of the third solvents include alcohols such as methanol, ethanol, 1-propanol, 2-propanol, 1-butanol, 2-butanol and cyclohexanol; and hydrocarbons such as cyclohexane and hexane. In particular, preferred are methanol, ethanol, 1-propanol, 2-propanol and 1-butanol.

It is preferred that the mixed solvent composed of the above-mentioned three kinds of solvents contains the first solvent in an amount of 20 to 95% by mass, the second solvent in an amount of 2 to 60% by mass and the third solvent in an amount of 2 to 30% by mass. More preferably, the mixed solvent contains the first solvent in an amount of 30 to 90% by mass, the second solvent in an amount of 3 to 50% by mass and the alcohol or the third solvent in an amount of 3 to 25% by mass. It is particularly preferred that the mixed solvent contains the first solvent in an amount of 30 to 90% by mass, the second solvent in an amount of 3 to 30% by mass and the alcohol or the third solvent in an amount of 3 to 15% by mass. When the first solvent is a mixed solution and the second solvent is not used, it is preferred that the mixed solvent contains the first solvent in an amount of 20 to 90% by mass and the third solvent in an amount of 5 to 30% by mass. More preferably, the mixed solvent contains the first solvent in an amount of 30 to 86% by mass and the third solvent in an amount of 7 to 25% by mass. The above-mentioned non-chlorine-based organic solvents used in the invention are described in JIII Journal of Technical Disclosure No. 2001-1745, pages 12 to 16 (published on May 15, 2001, Japan Institute of Invention and Innovation) in more detail. Preferred combinations of the non-chlorine-based organic solvents used in the invention include but are not limited to the following:
Methyl acetate/acetone/methanol/ethanol/butanol (75/10/5/5/5, parts by mass),
Methyl acetate/acetone/methanol/ethanol/propanol (75/10/5/5/5, parts by mass),
Methyl acetate/acetone/methanol/butanol/cyclohexane (75/10/5/5/5, parts by mass),
Methyl acetate/acetone/ethanol/butanol (81/8/7/4, parts by mass),
Methyl acetate/acetone/ethanol/butanol (82/10/4/4, parts by mass),
Methyl acetate/acetone/ethanol/butanol (80/10/4/6, parts by mass),
Methyl acetate/methyl ethyl ketone/methanol/butanol (80/10/5/5, parts by mass),
Methyl acetate/acetone/methyl ethyl ketone/ethanol/isopropanol (75/8/5/5/7, parts by mass),
Methyl acetate/cyclopentanone/methanol/isopropanol (80/7/5/8, parts by mass),
Methyl acetate/acetone/butanol (85/10/5, parts by mass),
Methyl acetate/cyclopentanone/acetone/methanol/butanol (60/15/14/5/6, parts by mass),
Methyl acetate/cyclohexanone/methanol/hexane (70/20/5/5, parts by mass),
Methyl acetate/methyl ethyl ketone/acetone/methanol/ethanol (50/20/20/5/5, parts by mass),
Methyl acetate/1,3-dioxolane/methanol/ethanol (70/20/5/5, parts by mass),
Methyl acetate/dioxane/acetone/methanol/ethanol (60/20/10/5/5, parts by mass),
Methyl acetate/acetone/cyclopentanone/ethanol/isobutanol/cyclohexane (65/10/10/5/5/5, parts by mass),
Methyl formate/methyl ethyl ketone/acetone/methanol/ethanol (50/20/20/5/5, parts by mass),
Methyl formate/acetone/ethyl acetate/ethanol/butanol/hexane (65/10/10/5/5/5, parts by mass),
Acetone/methyl acetoacetate/methanol/ethanol (65/20/10/5, parts by mass),
Acetone/cyclopentanone/ethanol/butanol (65/20/10/5, parts by mass),
Acetone/1,3-dioxolane/ethanol/butanol (65/20/10/5, parts by mass), and
1,3-Dioxolane/cyclohexanone/methyl ethyl ketone/methanol/butanol (55/20/10/5/5/5, parts by mass).

Further, there can also be used cellulose acylate solutions prepared by the following methods:

A cellulose acylate solution is prepared with methyl acetate/acetone/ethanol/butanol (81/8/7/4, parts by mass), filtered and concentrated, followed by further addition of 2 parts by mass of butanol;
A cellulose acylate solution is prepared with methyl acetate/acetone/ethanol/butanol (84/10/4/2, parts by mass), filtered and concentrated, followed by further addition of 4 parts by mass of butanol; and
A cellulose acylate solution is prepared with methyl acetate/acetone/ethanol (84/10/6, parts by mass), filtered and concentrated, followed by further addition of 5 parts by mass of butanol.

### (Characteristics of Cellulose Acylate Solutions)

The cellulose acylate solution used in the invention is characterized in that the cellulose acylate is dissolved in the organic solvent in an amount of 10 to 30% by mass, more preferably in an amount of 13 to 27% by mass, and particularly preferably in an amount of 15 to 25% by mass. As a method for adjusting the cellulose acylate solution to these concentrations, the solution may be adjusted to a specified concentration at a dissolution stage, or may be previously prepared as a low-concentrated solution (for example, 9 to 14% by mass), followed by adjustment to a specified high-concentrated solution at a concentration stage described later. Further, a high-concentrated cellulose acylate solution is previously prepared, and then various additives are added thereto, thereby preparing a specified low-concentrated cellulose acylate solution. Even when any of the methods is used, there is no particular problem, as long as the concentration of the cellulose acylate solution of the invention is obtained.

In the invention, the association molecular weight of the cellulose acylate in a solution obtained by diluting the cellulose acylate solution with an organic solvent having the same composition as the solution to a concentration of 0.1 to 5% by mass is preferably from 150,000 to 15,000,000. More preferably, the association molecular weight thereof is from 180,000 to 9,000,000. The association molecular weight can be determined by the static light-scattering method. The cellulose acylate is dissolved so that the square radius of inertia determined concurrently at that time becomes preferably 10 to 200 nm, and more preferably 20 to 200 nm. Furthermore, the cellulose acylate is dissolved so that the second virial coefficient becomes preferably −2×10⁻⁴ to 4×10⁻⁴, and more preferably −2×10⁻⁴ to 2×10⁻⁴. The definitions of the association molecular weight, the square radius of inertia and the second virial coefficient as used in the invention will be described. Theses were measured by the static light-scattering method according to the following process. The measurement was made in a dilute region as a matter of convenience of a measuring device. However, these measured values reflect the behavior of a dope of the invention in a region of high concentration. First, the cellulose acylate was dissolved in the solvent used for the dope to prepare a 0.1 mass %, 0.2 mass %, 0.3 mass % and 0.4 mass % solutions. In order to prevent moisture absorption, the cellulose acylate was previously dried at 120° C. for 2 hours, and then weighed at 25° C. and 10% RH. Dissolution was performed according to a method employed in dope dissolution (an ordinary dissolution method, a cooling dissolution method or a high-temperature dissolution method). Subsequently, these solutions and the solvent were filtered through a 0.2-μm Teflon filter. The static light scattering of the filtered solution was measured at 25° C. at intervals of 10 degrees from 30 degrees to 140 degrees by using a light-scattering measuring device (DLS-700, manufactured by Otsuka Electronics Co., Ltd.). The resulting data were analyzed according to the Berry plotting method. As the refractive index necessary for this analysis, the value of the solvent determined with an Abbe's refractometer was used, and the concentration gradient thereof (dn/dc) was measured with a differential refractometer (DRM-1021, Otsuka Electronics Co., Ltd.) using the solvent and solutions used for the light scattering measurement.

### (Dope Preparation)

In the preparation of the cellulose acylate solution (dope) of the invention, there is no particular restriction on the dissolution method thereof. The dope may be prepared at room temperature, or by the cooling dissolution method, the high-temperature dissolution method or a combination thereof. With respect to these, methods for preparing a cellulose acylate solution are described, for example, in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017 and JP-A-11-302388. The above-mentioned methods of dissolving a cellulose acylate in an organic solvent can be properly applied also in the invention, as long as they are within the scope of the invention. Details of these, particularly the non-chlorine-based solvent system, are described in JIII Journal of Technical Disclosure No. 2001-1745, pages 22 to 25 (published on May 15, 2001, Japan Institute of Invention and Innovation). Further, the cellulose acylate dope solution used in the invention is usually concentrated and filtered, and details thereof are also described in JIII Journal of Technical Disclosure No. 2001-1745, page 25 (published on May 15, 2001, Japan Institute of Invention and Innovation). When dissolved at high temperature, the cellulose acylate is almost always dissolved at a temperature equal to or higher than the boiling point of the organic solvent used. In that case, it is dissolved under pressure.

In the cellulose acylate solution used in the invention, the viscosity and dynamic storage elastic modulus of the solution are preferably within certain ranges. One milliliter of a sample solution was measured by using a rheometer (CLS 500) with a steel cone having a diameter of 4 cm/2° (both manufactured by TA Instruments Inc.). As for measuring conditions, Oscillation Step/Temperature Ramp was changed at a rate of 2° C./min within the range of 40° C. to −10° C. to determine the static non-Newtonian viscosity n*(Pa·s) at 40° C. and the storage elastic modulus G′ (Pa) at −5° C. The temperature of the sample solution was previously kept at a measurement initiating temperature until the solution temperature became constant, and then the measurement was initiated. In the invention, the viscosity at 40° C. is preferably from 1 to 400 Pa·s, and the dynamic storage elastic modulus at 15° C. is preferably 500 Pa or more. More preferably, the viscosity at 40° C. is from 10 to 200 Pa·s, and the dynamic storage elastic modulus at 15° C. is from 100 to 1,000,000 Pa. Furthermore, the higher dynamic storage elastic modulus at low temperature is preferred. For example, when the temperature of a flow-casting support is −5° C., the dynamic storage elastic modulus at −5° C. is preferably from 10,000 to 1,000,000 Pa, and when the temperature of the support is −50° C., the dynamic storage elastic modulus at −50° C. is preferably from 10,000 to 5,000,000 Pa.

As described above, the cellulose acylate solution is characterized in that it is obtained as a high-concentrated dope, and the cellulose acylate solution having a high concentration and excellent stability is obtained without relying on a means of concentration. In order to make dissolution further easier, the cellulose acylate may be dissolved at a low concentration, and then the resulting solution may be concentrated by using concentration means. Although there is no particular limitation on the method for concentration, there is used, for example, a method of obtaining a high-concentrated solution with evaporation of a solvent that comprises the steps of introducing a low-concentrated solution between a cylinder and a rotating locus formed by the outer periphery of a blade rotating in the peripheral direction inside the cylinder, and applying a difference in temperature between the cylinder and the solution (for example, JP-A-4-259511); or a method of blowing a heated low-concentrated solution from a nozzle into a chamber, conducting flash evaporation of the solvent until the solution from the nozzle strikes upon an inner wall of the chamber, removing solvent vapor from the chamber at the same time, and taking out a high-concentrated solution (for example, methods described in U.S. Pat. Nos. 2,541,012, 2,858,229, 4,414,341 and 4,504,355).

Prior to flow casting, it is preferred to eliminate from the solution, unsolved matter and foreign matter such as dust and impurities by filtration through an appropriate filter medium such as metal gauze (wire mesh) or flannel. For filtration of the cellulose acylate solution, a filter having an absolute filtration accuracy of 0.1 to 100 μm is used, and a filter having an absolute filtration accuracy of 0.5 to 25 μm is preferably used. The thickness of the filter is preferably within the range of 0.1 to 10 mm, and more preferably within the range of 0.2 to 2 mm. In that case, filtration is preferably performed at a filtration pressure of 16 kgf/cm² or less, more preferably 12 kgf/cm² or less, still more preferably 10 kgf/cm² or less, and particularly preferably 2 kg f/cm² or less. As the filter media, there are used conventionally known materials such as glass fiber, cellulose fiber, filter paper and a fluororesin such as a tetrafluoroethylene resin. In particular, ceramics and metals are preferably used. The viscosity of the cellulose acylate solution just before the film formation may be any, as long as it is within the range in which flow casting is possible at the time of film formation. Generally, the cellulose acylate solution is prepared so as to have a viscosity preferably within the range of 10 Pa·s to 2,000 Pa·s, more preferably within the range of 30 Pa·s to 1,000 Pa·s, and still more preferably within the range of 40 Pa·s to 500 Pass. The temperature at this time is not particularly limited, as long as the temperature is that at the time of flow casting. However, it is preferably from −5 to 70° C., and more preferably from −5 to 55° C.

### (Film Formation)

A method for producing the film using the cellulose acylate solution will be described below. As the method and apparatus for producing the cellulose acylate film of the invention, there are used a solution-casting film-forming method and a solution-casting film-forming apparatus which are conventionally subjected to the production of cellulose triacetate films. A dope (a cellulose acylate solution) prepared in a dissolving device (pot) is once stored in a storing pot, and bubbles contained in the dope are removed to conduct final adjustment. From a dope exhaust, the dope is fed to a pressurized die, for example, through a pressurized metering gear pump capable of quantitatively feeding liquid with high precision by controlling the number of rotations thereof. The dope is homogeneously cast from a cap (slit) of the pressurized die onto a metal support of a flow-casting unit that is running endlessly, and a half-dried dope film (also referred to as a web) is peeled from the metal support at a peeling point at which the metal support has circulated approximately once around. Both ends of the resulting web were pinched with clips, and the web is transported with a tenter while keeping the width of the web and dried. Subsequently, the web is transported with a group of rolls of a drying machine to complete drying, and taken up on a winder to a prescribed length. A combination of a tenter and a drying machine equipped with a group of rolls may vary depending upon its purpose. In the solution-casting film-forming method used for the production of films for electronic displays, not only a solution-casting film-forming apparatus, but also a coater is often added for surface treatment of the films, to which layers such as a subbing layer, an antistatic layer, an antihalation layer and a protective layer are provided. Respective production processes will be described in brief below, but the invention is not limited thereto.

First, when the cellulose acylate film is prepared by a solvent-cast method, the cellulose acylate solution (dope) prepared is cast over a drum or a band, and a solvent is evaporated therefrom, thereby forming a film. It is preferred to adjust the concentration of the dope before flow casting so as to give a solid content of 5 to 40% by mass. The surface of the drum or band is preferably finished to a mirror-smooth state. The dope is preferably cast over the drum or band having a surface temperature of 30° C. or lower. In particular, the metal support temperature is preferably from −10 to 20° C. Further, in the invention, there can be applied techniques described in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511 and JP-A-02-208650.

### (Multilayer Flow Casting)

The cellulose acylate solution may be cast as a single layer over the smooth band or drum that acts as the metal support, or a plurality of cellulose acylate solutions may be cast as two or more layers. When the plurality of cellulose acylate solutions are cast, a film may be prepared while successively casting the cellulose acylate-containing solutions from their respective plural casting dies disposed at intervals in the direction of progress of the metal support and laminating them. For example, methods described in JP-A-61-158414, JP-A-1-122419 and JP-A-11-198285 can be adapted. Further, the film may be formed by casting the cellulose acylate solutions from two casting dies, and this can be performed by methods described for example, in JP-B-60-27562, JP-A-61-94724, JP-A-61-947245, JP-A-61-104813, JP-A-61-158413 and JP-A-6-134933. Furthermore, there may be used a cellulose acylate film casting method described in JP-A-56-162617, in which a flow of a high-viscosity cellulose acylate solution is enveloped in a low-viscosity cellulose acylate solution and both of the high and low-viscosity cellulose acylate solutions are extruded simultaneously. In addition, it is also preferred embodiment to allow an alcohol component which is a poor solvent to be contained in an outer solution in an amount larger than in an inner solution, as described in JP-A-61-94724 and JP-A-61-94725. Alternatively, using two casting dies, a film formed on a metal support from the first casting die is peeled, and the second casting may be conducted on the side of the film contacted with the metal support surface, thereby preparing a film. This method is described, for example, in JP-B-44-20235. The cellulose acylate solutions to be caste may be the same or different, and they are not particularly limited. In order to give functions to the plurality of cellulose acylate layers, cellulose acylate solutions corresponding to the respective functions may be extruded from different casting dies respectively. Further, the cellulose acylate solution can also be cast simultaneously together with other functional layers (for example, an adhesive layer, a dye layer, an antistatic layer, an antihalation layer, a UV absorbing layer and a polarizing layer).

In the conventionally known single layer solution, it is necessary to extrude the cellulose acylate solution having a high concentration and a high viscosity, in order to obtain a desired film thickness. In that case, stability of the cellulose acylate solution is poor, so that solid matter is generated to induce spot troubles and inferior flatness, which causes a problem in many cases. As a measure to solve this problem, a plurality of cellulose acylate solutions are cast from casting dies, thereby being able to extrude high viscosity solutions on a metal support at the same time. Not only a film also improved in flatness and having excellent face quality can be prepared, but also a reduction in drying load can be achieved by use of the concentrated cellulose acylate solution to enhance the production rate of the film.

In the case of co-casting, the thickness of the inside layer and the outside layer is not particularly limited. However, the thickness of the outside layer is preferably from 1 to 50%, and more preferably from 2 to 30%, of the entire film thickness. In the case of co-casting of at least three layers, the total film thickness of the layer in contact with the metal support and the layer in contact with air is defined as the film thickness of the outside. In the case of co-casting, it is also possible to co-cast cellulose acylate solutions different in concentration of the above-mentioned additive such as the plasticizer, the UV absorbing agent or the matting agent, thereby preparing a cellulose acylate film having a stacked structure. For example, a cellulose acylate film having a constitution of a skin layer/a core layer/a skin layer can be prepared. For example, the matting agent can be added to the skin layer in an amount larger than to the core layer, or only to the skin layer. The plasticizer and an UV absorber can be added to the core layer in an amount larger than to the skin layer, or only to the core layer. Further, the kinds of plasticizer and UV absorber can also be changed between the core layer and the skin layer. For example, it is possible to add the low volatile plasticizer and/or UV absorber to the skin layer and the plasticizer excellent in plasticity or the UV absorber excellent in UV absorption to the core layer. Further, it is also a preferred embodiment that a releasing agent is added only to the skin layer on the metal support side. Furthermore, in order to allow the solution to gel by cooling the metal support by a cooling drum method, it is also preferred to add an alcohol as a poor solvent to the skin layer in an amount larger than to the core layer. Tg may be different between the skin layer and the core layer, and Tg of the core layer is preferably lower than that of the skin layer. In addition, the viscosity of a solution containing the cellulose acylate at the time of casting may be different between the skin layer and the core layer. The viscosity of the skin layer is preferably lower than that of the core layer, but the viscosity of the core layer may be lower than that of the skin layer.

### (Flow Casting)

As a method for casting the solution, there is a method of uniformly extruding the prepared dope from the pressurized die onto the metal support, a doctor blade method in which the film thickness of the dope once cast over the metal support is adjusted with a blade, or a reverse roll coater method in which the film thickness is adjusted with counter-rotating rolls. Of these, the method of using the pressurized die is preferred. The pressurized dies include coat-hanger type and T-die type dies, both of which can be preferably used. In addition to the methods described herein, there can be used various methods of casting a cellulose triacetate solution to form a film, which have hitherto been known. Effects similar to contents described in respective publications are obtained by setting respective conditions, considering the difference in boiling point or the like between solvents used. As the endlessly running-metal support used to produce the cellulose acylate film of the invention, there is used a drum mirror-finished with a chrome-plating surface or a stainless belt (which may be said to be a band) mirror-finished by surface polishing. As the pressurized die used to produce the cellulose acylate film of the invention, one or two or more dies may be installed above the metal support. One or two dies are preferred. When two or more dies are installed, the amount of the dope cast may be divided to the respective dies with various proportions, or the dope may be transferred from a plurality of precision metering gear pumps to the dies with respective proportions. The temperature of the cellulose acylate solution used for flow casting is preferably from −10 to 55° C., and more preferably from 25 to 50° C. In that case, the temperature may be the same during all steps, or different in each step. When the temperature is different, it is only required to be a specified temperature just before casting.

### (Drying)

As methods for drying the dope on the metal support in the production of the cellulose acylate film, there are generally a method of blowing hot air from the surface side of the metal support (drum or belt), namely from the surface side of a web on the metal support; a method of blowing hot air from the back side of the drum or belt; and a liquid heat-transfer method of allowing a temperature-controlled liquid to contact with the drum or belt at the back side opposite to a dope-casting surface thereof, and heating the drum or belt by heat transfer to control the surface temperature. However, the back-side liquid heat-transfer method is preferred. The surface temperature of the metal support before flow casting may be any, as long as the temperature is equal to or lower than the boiling point of a solvent used in the dope. However, in order to accelerate drying or to reduce flowability of the dope on the metal support, it is preferably set to a temperature 1 to 10° C. lower than the boiling point of a solvent having the highest boiling point of the solvents used. The above is not applied to the case where the cast dope is peeled without drying after cooling.

### (Stretching Treatment)

In the cellulose acylate film of the invention, the retardation can be adjusted by stretching treatment. Further, there is a method of positively stretching the film in the width direction, as described, for example, in JP-A-62-115035, JP-A-4-152125, JP-A-4-284211, JP-A-4-298310, and JP-A-11-48271. In order to increase the in-plane retardation value of the cellulose acylate film, the film produced is stretched.

Stretching of the film is carried out at ordinary temperature or under heated conditions. The heating temperature is preferably lower than the glass transition temperature of the film. The stretching of the film may be only longitudinal or lateral uniaxial stretching, or simultaneous or sequential biaxial stretching. The stretching is carried out at a ratio of 1 to 200%, preferably at a ratio of 1 to 100%, and particularly preferably at a ratio of 1 to 50%. With respect to the birefringence of the optical film, it is appropriate that the refractive index in the width direction be greater than the refractive index in the length direction. Therefore, it is preferable that the film is stretched to a larger extent in the width direction. In addition, the stretch processing may be performed in the course of film formation, or after the whole film formed in the form of web is wound into a roll. In the former case, the stretch processing may be carried out as the film formed still contains a solvent residue, and the film formed can be favorably stretched in a state that the solvent residue content therein is from 2 to 30%.

The thickness of cellulose acylate film in its finish (after drying), though depends on the end-use purpose, is generally from 5 μm to 500 μm, preferably from 20 μm to 300 μm, particularly preferably from 40 μm to 180 μm. For VA liquid crystal displays in particular, it is appropriate that the film thickness be from 40 μm to 110 μm. Alternatively, it is also favorable that the film thickness is adjusted to the range of 110 μm to 180 μm. In this range, water becomes difficult to pass through the film. So the film having such a thickness is favorable and can offer an advantage in 500-hour durability test of polarizing plates under conditions of 60° C. and 95% RH. This is because it is thought that the moisture permeability becomes lower the greater the film thickness is made since the magnitude of optical characteristics is proportional to the film thickness and the moisture permeability decreases inversely with the thickness.

The film thickness may be controlled so as to obtain the desired thickness by regulating the concentration of solid matter contained in the dope, the interval between slits of the cap of the die, the extrusion pressure from the die, the speed of the metal support and the like. The width of the cellulose acylate film thus obtained is preferably from 0.5 to 3 m, more preferably from 0.6 to 2.5 m, and still more preferably from 0.8 to 2.2 m. The film is taken up to a length of preferably 100 to 10,000 in, more preferably 500 to 7,000 m, and still more preferably 1,000 to 6,000 m, per roll. At the time of taking up, knurling is preferably given to at least one end of the film. The width thereof is from 3 to 50 mm, and preferably from 5 to 30 mm. The height thereof is from 0.5 to 500 μm, and preferably from 1 to 200 μm. This may be a one-sided press or a two-sided press. Further, the variation in Re values over the whole width is preferably within ±5 nm, and more preferably within ±3 nm. Furthermore, the variation in Rth values is preferably within ±10 nm, and more preferably within ±5 nm. The variations in Re values and Rth values in the longitudinal direction are preferably within the range of the variations in the width direction. For retention of a sense of clarity, it is appropriate that the haze be controlled to the range of 0.01% to 2%. In order to reduce the haze, it is required for a particulate matting agent to be well dispersed and thereby reduced in number of agglomerated particles, and to be used in a skin layer alone and thereby reduced in addition amount.

### (Optical Characteristics of Cellulose Acylate Film)

The Re value of a cellulose acylate film for use in the invention is preferably from 20 nm to 150 nm. In order to effectively reduce light leakages in oblique directions of IPS mode liquid crystal displays, the Re values ranging from 40 nm to 115 nm are far preferred, and those ranging from 60 nm to 95 nm are further preferred. In addition, the Rth/Re ratio is adjusted to the range of 1.5 to 7. In order to effectively reduce light leakages in oblique directions of IPS mode liquid crystal displays, the Rth/Re ratios ranging from 2.0 to 5.5 are far preferred, and those ranging from 2.5 to 4.5 are further preferred.

For OCB mode liquid crystal displays, as to optical characteristics of a cellulose acylate film according to the present invention, it is preferable that the Re retardation value and the Rth retardation value satisfy the following relations (V) and (VI), respectively;

20nm≦Re(550)≦100nm (V)

70nm≦Rth(550)≦350nm (VI)

(wherein Re(λ) is an in-plane retardation value expressed in the units nm at a wavelength of λ nm and Rth(λ) is a thickness-direction retardation value expressed in the units nm at a wavelength of λnm).

It is preferable by far that the Re retardation value and the Rth retardation value satisfy the following relations (VI) and (VIII), respectively.

30nm≦Re(550)≦70nm (V)

150nm≦Rth(550)≦250nm (VI)

The Re(λ) value is measured with KOBRA 21ADH (made by Oji Scientific Instruments) as light with a wavelength of λ nm is made to strike upon a film in the direction of the normal to the film surface. In addition, the Rth(λ) value is calculated on the basis of three retardation values measured in three different directions, namely the retardation value Re(λ), a retardation value measured under conditions that the in-plane slow axis is taken as an axis of tilt and light with a wavelength of λ nm is made to strike from a direction tilting to +40° with respect to the direction of the normal to the film and a retardation value measured under conditions that the in-plane slow axis is taken as an axis of tilt and light with a wavelength of λ nm is made to strike from a direction tilting to −40° with respect to the direction of the normal to the film, and by inputting the value 1.48 assumed as the average refractive index and a film thickness.

In the present specification, λ is 550 nm unless otherwise indicated.

The optical characteristic values including Re and Rth vary as the mass and dimensions are changed by a humidity change and a lapse of time under high temperatures. The smaller changes in Re and Rth values are, the more suitable the film is for use. For reduction of optical characteristic changes caused by humidity, cellulose acylate having a high degree of acyl substitution at the 6-position is used, and besides, the moisture permeability and equilibrium moisture content of the film are lowered by use of hydrophobic additives (including a plasticizer, a retardation developer and a ultraviolet absorbent). The suitable moisture permeability is from 400 g/m² to 2,300 g/m² as measured under conditions of 60° C., 95% RH and 24 hours. As to the equilibrium moisture content, the suitable value, as measured at 25° C. and 80% RH, is 3.4% or below. As to the amounts of changes in optical characteristics caused by changing the humidity from 10% RH to 80% RH at 25° C., it is preferable that the amount of the change in Re is 12 nm or below and that in Rth is 32 nm or below. The suitable amount of additives used is from 10% to 30% by mass, preferably from 12% to 25% by mass, particularly preferably from 14.5% to 20% by mass, of the amount of cellulose acylate used. When the film causes changes in mass and dimensions by vaporization or decomposition of additives incorporated therein, optical characteristic changes occur. Accordingly, it is preferable that the amount of the mass change caused in the film after a lapse of 48 hours at 80° C. and 90% RH is 5% or below. Similarly thereto, the amount of the dimensional change caused in the film after a lapse of 24 hours at 60° C. and 95% RH is preferably 5% or below. In addition, the amount of the dimensional change caused in the film after a lapse of 24 hours at 90° C. and 5% RH is preferably 5% or below. Even when there are a little dimensional change and a little mass change, the amount of the changes in optical characteristics becomes smaller so far as the photo-elastic modulus of the film is small. Therefore, it is preferable that the photoelasticity coefficient of the film is 50×10⁻¹³ cm²/dyne or below. The glass transition temperature Tg of the cellulose acylate film is preferably from 80° C. to 180° C. The elasticity modulus of the cellulose acylate film is preferably from 1,500 MPa to 5,000 MPa. Moreover, it is preferable that the cellulose acylate film contains fine particles of silicon dioxide having an average secondary particle diameter of 0.2 μm to 1.5 μm.

### (Optically Anisotropic Layer)

An optically anisotropic layer is made from a liquid crystalline compound. The optically anisotropic layer can be formed directly on the surface of a transparent support. It is also allowable to form an alignment layer on a transparent support and then to form the optically anisotropic layer on the alignment layer. Alternatively, the optically anisotropic layer is formed from a liquid crystalline compound on a separate substrate, and then transferred to a transparent support, thereby making an optical compensation film. The transparent support to which the optically anisotropic layer is transferred may be provided in advance with a pressure-adhesive layer.

Preferred examples of the liquid crystalline compound include a rod-shaped or discotic crystalline compound. The rod-shaped or discotic liquid crystalline compound may be a macromolecular liquid crystal. In forming the optically anisotropic layer, the liquid crystalline compound may lose liquid crystallinity by undergoing polymerization or cross-linking.

### <Rod-Shaped Liquid Crystalline Compound>

Examples of a rod-shaped liquid crystalline compound include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles. Further, metal complexes are also included in rod-shaped liquid crystalline compounds. In addition, liquid crystalline polymers the repeating units of which contain molecular structures corresponding to rod-shaped liquid crystalline compounds can also be used. In other words, rod-shaped liquid crystalline compounds may form liquid crystalline polymers by being combined with polymers.

Descriptions of rod-shaped liquid crystalline compounds can be found, e.g., in Kikan Kagaku Sosetsu (Quarterly Review of Chemistry), volume 22 (entitled “Ekisho no Kagaku” (Chemistry of Liquid Crystals), chapters 4, 7 and 11. The Chemical Society of Japan (1994), and Ekisho Debaisu Handobukku (Handbook of Liquid Crystal Devices), chapter 3. The 142-th Committee of Japan Society for the Promotion of Science.

It is preferable that rod-shaped liquid crystalline compounds have their birefringence factors in a range of 0.001 to 0.7.

For fixation of their aligned state, it is appropriate that the rod-shape liquid crystalline compounds have polymerizable groups. The polymerizable groups are preferably unsaturated polymerizable groups or epoxy groups, far preferably unsaturated polymerizable groups, particularly preferably ethylenic unsaturated polymerizable groups.

In forming the layer, it is preferable that the molecules of a rod-shaped liquid crystalline compound for use in the invention are made to align in a substantially vertical direction and fixed in the aligned state. The expression “substantially vertical” as used herein means that the angle with which the film surface forms with the director of a rod-shaped liquid crystalline compound used is within the range of 70° to 90°.

These rod-shaped liquid crystalline molecules may be aligned obliquely, or may be aligned so that their tilt angles vary gradually (hybrid-aligned). In both oblique-alignment and hybrid-alignment, the average tilt angle is preferably from 70° to 90°, far preferably from 80° to 90°, especially preferably from 85° to 90°.

The optically anisotropic layer made up of a rod-shaped liquid crystalline compound can be formed by applying a layer of coating solution, which contains the rod-shaped liquid crystalline compound and, if needed, the additives mentioned hereinafter including a polymerization initiator and an air-interface vertical alignment agent, to a vertical alignment film formed on a support, causing a vertically aligned state in the layer, and then fixing the vertically aligned state. The optically anisotropic layer can also be formed by transfer of a layer made up of a rod-shaped liquid crystalline compound onto a cellulose acylate film. In order to attain the intended optical characteristics, the optically anisotropic layer can be formed of not only one constituent layer but also a stacke of two or more constituent layers. Alternatively, the optically anisotropic layer may be formed so as to satisfy the intended optical characteristics by a layered product of a support and a retardation film in its entirety.

As solvents for use in preparing the coating solution, organic solvents are suitable. Examples of such organic solvents include amides (such as N,N-dimethylformamide), sulfoxides (such as dimethyl sulfoxide), heterocyclic compounds (such as pyridine), hydrocarbons (such as benzene and hexane), alkyl halides (such as chloroform and dichloromethane), esters (such as methyl acetate and butyl acetate), ketones (such as acetone and methyl ethyl ketone) and ethers (such as tetrahydrofuran and 1,2-dimethoxyethane). Of these solvents, alkyl halides and ketones are preferred over the others. Two or more of those solvents may be used in combination. The application of a coating solution can be performed using known methods (such as extrusion coating, direct gravure coating, reverse gravure coating and die coating methods).

The vertically aligned liquid crystalline compound molecules are preferably fixed so that their aligned state is retained. It is appropriate that the liquid crystalline compound molecules be fixed by polymerization reaction of polymerizable groups (P) introduced therein. The polymerization reaction includes thermal polymerization reaction using a thermal polymerization initiator and photopolymerization reaction using a photopolymerization initiator. Herein, the photopolymerization reaction is preferable to the thermal polymerization reaction. Examples of a photopolymerization initiator usable herein include the α-carbonyl compounds (disclosed in U.S. Pat. Nos. 2,367,661 and 2,357,670), the acyloin ethers (disclosed in U.S. Pat. No. 2,448,828), the α-hydrocarbon-substituted aromatic acyloin compounds (disclosed in U.S. Pat. No. 2,722,512), the polynuclear quinone compounds (disclosed in U.S. Pat. Nos. 3,046,127 and 2,951,758), the combinations of triarylimidazole dimers and p-aminophenyl ketones (disclosed in U.S. Pat. No. 3,549,367), the acridine and phenazine compounds (disclosed in JP-A-60-105667 and U.S. Pat. No. 4,239,850) and the oxadiazole compounds (disclosed in U.S. Pat. No. 4,212,970).

The amount of a photopolymerization initiator used is preferably from 0.01% to 20% by mass, far preferably from 0.5% to 5% by mass, of the solids content in the coating solution. For polymerization of rod-shaped liquid crystalline molecules, it is appropriate to employ irradiation with ultraviolet rays. The irradiation energy is preferably from 20 mJ/cm² to 50 J/cm², far preferably from 100 mJ/cm² to 800 mJ/cm². For speeding up the photopolymerization reaction, light irradiation may be carried out under heating. The thickness of a first retardation zone including the optically anisotropic layer is preferably from 0.1 μm to 10 μm, far preferably from 0.5 μm to 5 μm, especially preferably from 1 μm to 5 μm.

### <<Vertical Alignment Film>>

In order to make the liquid crystalline compound align vertically on the side of an alignment film, it is important to lower the surface energy of the alignment film. More specifically, the surface energy of the alignment film is lowered with the aid of functional groups of a polymer and thereby the liquid crystal compound is brought to an upright state. As functional groups for lowering the surface energy of the alignment film, fluorine atoms and hydrocarbon groups containing 10 or more carbon atoms per group are effective. In order to allow fluorine atoms or hydrocarbon groups to be present at the surface of the alignment film, it is appropriate that the fluorine atoms or the hydrocarbon groups be rather introduced into side chains than the main chain of the polymer. The proportion of fluorine atoms in a fluorine-containing polymer is preferably from 0.05% to 80% by mass, far preferably from 0.1% to 70% by mass, further preferably from 0.5% to 65% by mass, particularly preferably from 1% to 60% by mass. The hydrocarbon groups are aliphatic groups, aromatic groups or combinations of these groups. The aliphatic groups may have any of cyclic, branched-chain and straight-chain structures. The aliphatic groups are preferably alkyl groups (including cycloalkyl groups) or alkenyl groups (including cycloalkenyl groups). The hydrocarbon groups may have substituents not having a strong affinity for water, such as halogen atoms. The number of carbon atoms in each of the hydrocarbon groups is preferably from 10 to 100, far preferably from 10 to 60, particularly preferably from 10 to 40. And it is preferable that the main chain of the polymer has a polyimide structure or a polyvinyl alcohol structure.

Polyimide is generally synthesized by condensation reaction between tetracarboxylic acid and diamine. By increasing the variety of tetracarboxylic acid or diamine used, polyimides equivalent to copolymers may be synthesized. The fluorine atoms or the hydrocarbon groups may be present in repeating units of tetracarboxylic-acid origin, repeating units of diamine origin, or repeating units of both origins. In the case of introducing hydrocarbon groups into polyimide, it is especially preferable that steroid structures are formed in the main chain or side chains of the polyimide. The steroid structure present in a side chain is equivalent to a hydrocarbon group containing 10 or more carbon atoms, and has a function of making a liquid crystalline compound align vertically. The term “steroid structure” as used herein refers to a cyclopentanohydrophenanthrene ring structure or the ring structure in which part of the bonds are modified into double bonds within the scope of an aliphatic ring (so far as no aromatic ring is formed by such a modification).

As to another method of making a liquid crystalline compound align vertically, the method of mixing an organic acid with a high polymer, such as polyvinyl alcohol, modified polyvinyl alcohol or polyimide, can be employed to advantage. Examples of an organic acid usable suitably for the mixing include carboxylic acids, sulfonic acids and amino acids.

Acidic ones of the air-interface alignment agents described hereinafter may be used. In addition, quaternary ammonium salts can also be used to advantage. Their mixing amount is preferably from 0.1% to 20% by mass, far preferably from 0.5% to 10% by mass, of the amount of high polymer used.

It is preferable that the polyvinyl alcohol has a saponification degree of 70 to 100%, especially 80 to 100%, and a polymerization degree of 100 to 5,000.

In the case of orienting a rod-shaped liquid crystalline compound, it is preferable that the alignment film is made up of a polymer having hydrophobic groups as functional groups in side chains. The kinds of functional groups are selected according to the type of liquid crystalline molecules and the aligned state required. For instance, modifying groups for a modified polyvinyl alcohol can be introduced by copolymerization modification, chain transfer modification or block polymerization modification. Examples of the modifying groups include hydrophilic groups (such as a carboxylic acid group, a sulfonic acid group, a phosphonic acid group, an amino group, an ammonium group, an amido group and a thiol group), hydrocarbon groups containing 10 to 100 carbon atoms, fluorine-substituted hydrocarbon groups, thioether groups, polymerizable groups (such as unsaturated polymerizable groups, an epoxy group and an aziridinyl group) and alkoxysilyl groups (such as trialkoxysilyl, dialkoxysilyl and monoalkoxysilyl groups). Examples of such modified polyvinyl alcohol compounds include those disclosed in JP-A-2000-155216, par. Nos. [0022] to [0145], and JP-A-2002-62426, par. Nos. [0018] to [0022].

When the alignment film is formed by use of a polymer having side chains containing cross-linkable functional groups attached to the main chain or a polymer having cross-linkable groups in side chains having a function of aligning liquid crystal molecules and thereon a retardation film is formed using a composition containing a multifunctional monomer, it becomes possible to copolymerize the polymer in the alignment film and the multifunctional monomer in the retardation film formed on the alignment film. As a result, covalent bonds are formed not only between multifunctional monomer molecules, but also between polymer molecules in the alignment film, and besides, between the multifunctional monomer and the polymer in the alignment film, thereby firmly uniting the alignment film and the retardation film. Accordingly, formation of the alignment film by use of a polymer having cross-linkable functional groups can significantly improve the strength of the optical compensation film. Therein, it is preferable that the cross-linkable functional groups of the polymer in the alignment film include polymerizable groups as in the case of the multifunctional monomers. Examples of such polymerizing groups include those disclosed in JP-A-2000-155216, par. Nos. [0080] to [0100].

Aside from the cross-linkable functional groups, the polymer in the alignment film can also be cross-linked by use of a cross-linking agent. Examples of a cross-linking agent usable therein include aldehydes, N-methylol compounds, dioxane derivatives, compounds working through activation of carboxyl groups, active vinyl compounds, active halogen compounds, isooxazole and dialdehyde starch. Two or more of cross-linking agents may be used in combination. Examples of those compounds usable as the cross-linking agent include the compounds disclosed in JP-A-2002-62426, par. Nos. [0023] to [0024]. Of those compounds, aldehydes having high reaction activity, glutaraldehyde in particular, are preferred over the others.

The amount of a cross-linking agent added is preferably from 0.1% to 20% by mass, far preferably from 0.5% to 15% by mass, of the amount of polymer used. The proportion of a cross-linking agent remaining unreacted in the alignment film is preferably 1.0% or below by mass, far preferably 0.5% or below by mass. By controlling like the foregoing, sufficient durability free from occurrence of reticulation can be achieved even in the case of long-term use of the alignment film in a liquid crystal display, or even in the case of letting the alignment film stand for a long time under atmosphere of high temperature and humidity.

The alignment film can be basically formed by coating on a transparent support a layer of composition containing ingredients for forming the alignment layer, including the polymer and the cross-linking agent as recited above, drying the layer by heating (to cause cross-linking reaction therein), and then subjecting the dried layer to rubbing treatment. As described above, the cross-linking reaction may be performed at any time after coating on the transparent support. When a water-soluble polymer, such as polyvinyl alcohol, is used as an alignment layer forming material, it is preferable to use a mixture of water and an organic solvent having an antifoaming action (e.g., methanol) as a solvent for the coating composition. The ratio of water to methanol is preferably from 0:100 to 99:1 by mass, far preferably from 0:100 to 91:9 by mass. By adjusting the mixing ratio to the foregoing range, foaming can be prevented and thereby defects in the alignment film and further at the retardation layer surface can be significantly reduced.

Examples of a coating method suitable for the alignment film include a spin coating method, a dip coating method, a curtain coating method, an extrusion coating method, a rod coating method and a roll coating method. Of these coating methods, a rod coating method in particular is preferable. The thickness of the film after drying is preferably from 0.1 μm to 10 μm. The drying by heating can be performed at temperatures ranging from 20° C. to 100° C. For formation of sufficient cross-linkages, it is appropriate that the heating temperature be within the range of 60° C. to 100° C., especially 80° C. to 100° C. The drying may be continued over a 1-minute to 36-hour period, but the suitable drying time is from 1 minute to 30 minutes. In addition, it is appropriate that the pH be adjusted to a value best-suited to a cross-linking agent used. When the cross-linking agent used is glutaraldehyde, it is preferable that the pH is adjusted to a range of 4.5 to 5.5, especially 5.

The alignment film is preferably provided on a transparent support. The alignment film is put to use after the polymer film is cross-linked in the foregoing way. For vertical orientation of a rod-shaped liquid crystalline compound, it is appropriate that the alignment film undergoes no rubbing treatment. Alternatively, it may carried out that a retardation film is formed by making the liquid crystalline compound molecules align by use of an alignment film and fixing them as they are in the aligned state, and then the retardation film alone is transferred to a polymer film (or a transparent support). In the case of requiring rubbing treatment, it is appropriate for dust prevention that the cross-linking degree of the alignment film be heightened in advance. When the value obtained by subtracting a ratio of the amount of a cross-linking agent remaining after cross-linking treatment (Ma) to the amount of the cross-linking agent added to a coating solution (Mb), an Ma/Mb ratio, from 1, namely the value of (1-(Ma/Mb)), is defined as a cross-linking degree, the cross-linking degree is preferably from 50% to 100%, far preferably from 65% to 100%, especially preferably from 75% to 100%. <<Air-interface Vertical Alignment Agent>>

In general, liquid crystalline compounds have a property of becoming oriented in a slanting direction on the air-interface side. For achieving a uniform vertically-aligned state, therefore, it is required to control liquid crystalline compound molecules present on the air-interface side so as to align vertically. To this end, it is appropriate that a compound capable of being unevenly distributed at the air-interface and acting so as to orient liquid crystalline compound molecules in the vertical direction through its excluded volume effect or antistatic effect be incorporated in a liquid crystal coating solution and then used for forming a retardation film.

As such air-interface alignment agents, the compounds disclosed in JP-A-2002-20363 and JP-A-2002-129162 can be used. Further, the particulars described in Japanese Patent Application No. 2002-212100, par. Nos. [0072] to [0075], Japanese Patent Application No. 2002-262239, par Nos. [0037] to [0039], Japanese Patent Application No. 2003-91752, par. Nos. [0071] to [0078], Japanese Patent Application No 2003-119959, par. Nos. [0052] to [0054], [0065] to [0066] and [0092] to [0094], Japanese Patent Application No 2003-330303, par. Nos. [0028] to [0030], and Japanese Patent Application No. 2004-003804, par. Nos. [0087] to [0090], can be applied to the invention as appropriate. In addition, mixing of those compounds in a liquid crystal coating solution can improve the coating suitability and control the occurrence of unevenness and repellency in the layer coated.

The proportion of the air-interface alignment agent used in a liquid crystal coating solution is preferably from 0.05% to 5% by mass. When the air-interface alignment agent of fluorine-containing compound type is used, the proportion thereof is preferably 1% or below by mass.

### <Discotic Liquid Crystalline Compound>

The discotic liquid crystalline compounds include the benzene derivatives described in the research report of C. Destrade et al., Mol. Cryst., vol. 71, p. 111 (1981), the truxene derivatives described in the research reports of C. Destrade et al., Mol. Cryst., vol. 122, p. 141 (1985) and Physics lett. A, vol. 78, p. 82 (1990), the cyclohexane derivatives described in the research report of B. Kohne et al., Angew. Chem., vol. 96, p. 70 (1984), and the azacrown macrocycles and the phenylacetylene macrocycles described in the research report of J. M. Lehn et al., J. Chem. Commun., p. 1794 (1985), and the research report of J. Zhang et al., J. Am. Chem. Soc., vol. 116, p. 2655 (1994).

In general a discotic liquid crystalline compound has a structure that side chains (such as linear alkyl groups, alkoxy groups or substituted benzoyloxy groups) are attached radially to its mother nucleus at the molecular center. And it is preferable that each individual molecule or molecular self-assembly of a discotic liquid crystalline compound has rotational symmetry and the discotic liquid crystalline compound is a compound capable of giving a definite orientation.

When an optically anisotropic layer is formed from a discotic liquid crystalline compound, the compound contained finally in the optically anisotropic layer is not required to exhibit liquid crystallinity. For instance, when a low-molecular discotic liquid crystal compound has a group capable of reacting to heat or light, an optically anisotropic layer can be formed by the compound being converted into a high-molecular compound through polymerization reaction or cross-linking reaction under exposure to heat or light. It is a general rule that a discotic liquid crystalline compound loses its liquid crystallinity by conversion into a high-molecular compound. Discotic liquid crystalline compounds usable to advantage are disclosed in JP-A-8-50206. As to the polymerization of discotic liquid crystalline compounds, there are descriptions thereof in JP-A-8-27284.

For fixation of a discotic liquid crystalline compound by polymerization, it is required to combine polymerizable groups as substituents with the discotic core of the discotic liquid crystalline compound. However, direct binding of polymerizable groups to the discotic core makes it difficult to keep the aligned state of the discotic core during the polymerization reaction. This being the case, linkage groups are introduced between the discotic core and polymerizable groups. Accordingly, it is appropriate that the discotic liquid crystalline compound having polymerizable groups be a compound represented by the following formula:

D(-L-Q)ₙ

wherein D is a discotic core, L is a divalent linkage group, Q is a polymerizable group and n is an integer of 4 to 12.

Examples of a discotic core (D) are illustrated below. In each of the following examples, LQ (or QL) means a combination of a divalent linkage group (L) and a polymerizable group (Q).

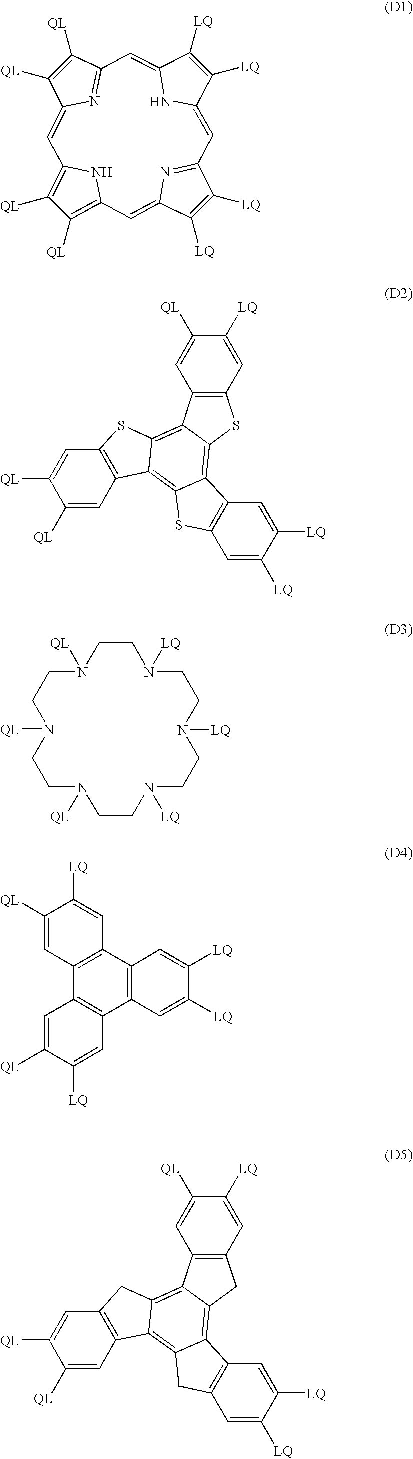

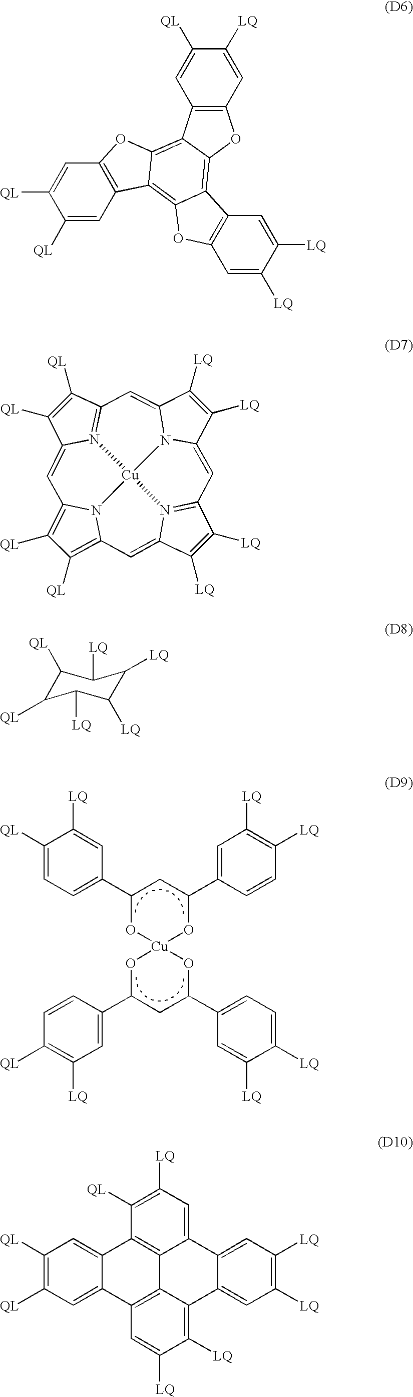

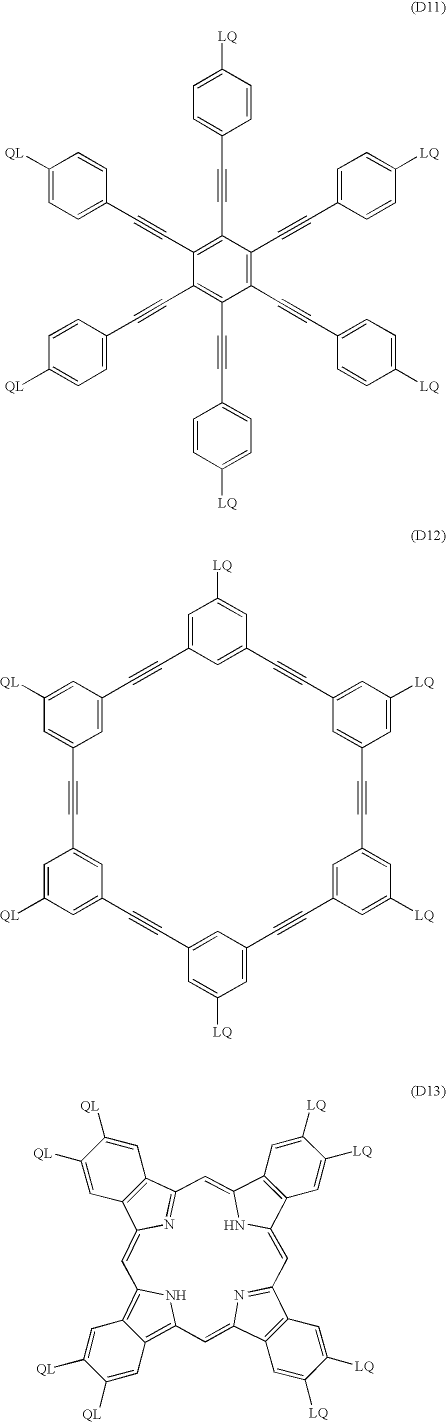

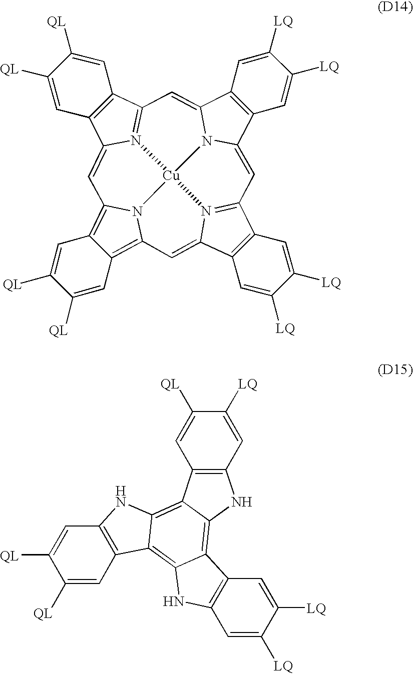

In the foregoing formula, the divalent linkage group (L) is preferably a divalent linkage group selected from alkylene groups, alkenylene groups, arylene groups, —CO—, —NH—, —O—, —S— or combinations of two or more of those groups. And it is preferable by far that the divalent linkage group (L) is a divalent linkage group formed by combining at least two divalent linkage groups selected from alkylene groups, arylene groups, —CO—, —NH—, —O— or —S—. Of such divalent linkage groups, the divalent linkage groups formed by combining at least two divalent linkage groups selected from alkylene groups, arylene groups, —CO— or —O— are especially preferred as the divalent linkage group (L). The suitable number of carbon atoms contained in each alkylene group is from 1 to 12, that in each alkenylene group is from 2 to 12, and that in each arylene group is from 6 to 10.

Examples of a divalent linkage group (L) are shown below. Each linkage group is bound to a discotic core (D) at the left side, and it is bound to a polymerizable group at the right side AL stands for an alkylene or alkenylene group, and AR stands for an arylene group. Additionally, the alkylene, alkenylene and arylene groups may have substituents (such as alkyl groups).

L1: -AL-CO—O-AL-

L2: -AL-CO—O-AL-O—

L3: -AL-CO—O-AL-O-AL-

L4: -AL-CO—O-AL-O—CO—

L5: —CO-AR-O-AL-

L6: —CO-AR-O-AL-O—

L7: —CO-AR-O-AL-O—CO—

L8: —CO—NH-AL-

L9: —NH-AL-O—

L10: —NH-AL-O—CO—

L11: —O-AL-

L12: —O-AL-O—

L13: —O-AL-O—CO—

L14: —O-AL-O—CO—NH-AL-

L15: —O-AL-S-AL-

L16: —O—CO-AR-O-AL-CO—

L17: —O—CO-AR-O-AL-O—CO—

L18: —O—CO-AR-O-AL-O-AL-O—CO—

L19: —O—CO-AR-O-AL-O-AL-O-AL-O—CO—

L20: —S-AL-

L21: —S-AL-O—

L22: —S-AL-O—CO—

L23: —S-AL-S-AL-

L24: —S-AR-AL-

The polymerizable group (Q) in the foregoing formula is chosen according to the type of polymerization reaction employed. Specifically, the polymerizable group (Q) is preferably an unsaturated polymerizable group or an epoxy group, far preferably an unsaturated polymerizable group, especially preferably an ethylenic unsaturated polymerizable group.

In the foregoing formula, n is an integer of 4 to 12. The specific figure is chosen according to the type of a discotic core (D) employed. A plurality of L-Q combinations may be the same or different, but it is preferable that they are the same.

As to the alignment of liquid crystalline compound molecules, it is preferable that the average direction of molecular symmetry axes in the optically anisotropic layer forms an angle of 43° to 47° with respect to the length direction.

In a hybrid alignment, the angles that molecular symmetry axes of liquid crystalline compound molecules make with the support surface increase or decrease with increase in distance from the support surface in the depth direction of the optically anisotropic layer. However, it is preferable that the angles decrease with increase in the distance. The angles may change in various states, such as a state of continuous increase, a state of continuous decrease, a state of intermittent increase, a state of intermittent decrease, a state including continuous increase and continuous decrease, and a state of intermittent change including increases and decreases. The intermittent change includes zones having no change in tilt angle at midpoints in the thickness direction.

As far as the angles are, on the whole, in an increased or decreased state, zones having no angle change may be included, but it is preferable that the angles are in a continuously changed state.

The average direction of molecular symmetry axes of liquid crystalline compound molecules can be generally controlled by a proper selection of liquid crystalline compound or material for the alignment film, or an appropriate selection of rubbing treatment method. In the case of an optical compensation film wherein the slow axis of the transparent support is neither orthogonal nor parallel to the slow axis of the optically anisotropic layer, the direction of the slow axis of the optically anisotropic layer can be adjusted by performing rubbing treatment in a direction different from the slow axis of the transparent support.

The directions of molecular symmetry axes of liquid crystalline compound molecules on the surface side (air side) of the optically anisotropic layer can be generally controlled by a proper selection of liquid crystalline compound or kinds of additives with which the liquid crystalline compound is used in combination. Examples of additives usable in combination with the liquid crystalline compound include a plasticizer, a surfactant, a polymerizable monomer and a polymer. The degree of a change in alignment directions of molecular symmetry axes, similarly to the above, can be controlled by properly selecting the species of a liquid crystalline compound and the kinds of additives. In selecting a surfactant, it is preferable to secure coordination with its surface tension controlling effect on a coating solution.

As to the plasticizer, the surfactant and the polymerizable monomer with which the liquid crystalline compound is used in combination, it is preferable that they have compatibility with the liquid crystalline compound and can impart a tilt angle change to the liquid crystalline compound or have no hindrance to alignment. Of these additives, the polymerizable monomer (such as a compound containing a vinyl group, a vinyloxy group, an acryloyl group or a methacryloyl group) is preferred. The amount of the compounds added is preferably from 1% to 50% by mass, far preferably from 5% to 30% by mass, based on the liquid crystalline compound. In addition, mixing of a monomer having 4 or more polymerizable functional groups in the additives can heighten adhesion between an alignment film and an optically anisotropic layer.

When the liquid crystalline compound used is a discotic liquid crystalline compound, it is preferable that a polymer having a measure of compatibility with the discotic liquid crystalline compound and capable of imparting a tilt angle change to the discotic liquid crystalline compound is added to the optically anisotropic layer.

As the polymer added, cellulose ester and cellulose ether are suitable, and cellulose ester is preferable to cellulose ether. Examples of cellulose ester include cellulose acetate, cellulose acetate propionate and cellulose acetate butyrate. An example of cellulose ether is hydroxypropyl cellulose. The addition amount of such a polymer is adjusted so as not to hinder alignment of discotic liquid crystalline compound molecules. Specifically, the amount of a polymer added is preferably from 0.1% to 10% by mass, far preferably from 0.1% to 8% by mass, further preferably from 0.1% to 5% by mass, based on the discotic liquid crystalline compound.

The temperature of discotic nematic liquid crystal phase-solid phase transition in the discotic liquid crystalline compound is preferably from 70° C. to 300° C., far preferably from 70° C. to 170° C.

The thickness of the optically anisotropic layer is preferably from 0.1 μm to 20 μm, far preferably from 0.5 μm to 15 μm, further preferably from 1 μm to 10 μm.

### <<Alignment Film>>

It is preferable that an alignment film is provided between the transparent support and the optically anisotropic layer.

The alignment film is preferably a layer made up of cross-linked polymers. For formation of such a layer, cross-linkable polymers can be used. For instance, polymers having cross-linkable functional groups are made to react with each other by application of light or heat or by changing pH, resulting in formation of cross-links. Alternatively, polymers may be cross-linked by use of a cross-linking agent. The cross-linking agent used is a highly reactive compound, and linkage groups derived from the cross-linking agent are introduced between polymers to form cross-links between polymers.

The alignment film made up of cross-linked polymers can be generally formed by coating on a transparent support a layer of coating solution containing cross-linkable polymers or a mixture of a polymer and a cross-linking agent, and then by subjecting the coating layer to light or heat treatment or pH adjustment.

For dust prevention during the process of rubbing the alignment film, it is appropriate that the cross-linking degree of the alignment film be heightened in advance. When the value obtained by subtracting a ratio of the amount of a cross-linking agent remaining after cross-linking treatment (Ma) to the amount of the cross-linking agent added to a coating solution (Mb), an Ma/Mb ratio, from 1, namely the value of (1-(Ma/Mb)), is defined as a cross-linking degree, the cross-linking degree is preferably from 50% to 100%, far preferably from 65% to 100%, especially preferably from 75% to 100%.

Examples of a polymer usable in the alignment film include polymethyl methacrylate, polyacrylic acid, polymethacrylic acid, polystyrene, polymaleinimide, polyvinyl alcohol, modified polyvinyl alcohol, poly(N-methylolacrylamide), polyvinyl toluene, chlorosulfonated polyethylene, nitrocellulose, polyvinyl chloride, chlorinated polyolefin, polyester, polyimide, polyvinyl acetate, polyethylene, carboxymethyl cellulose, gelatin, polypropylene, polycarbonate and copolymers of monomers constituting any two of the polymers recited above (such as acrylic acid-methacrylic acid copolymer, styrene-maleinimide copolymer, styrene-vinyltoluene copolymer, vinyl acetate-vinyl chloride copolymer and ethylene-vinyl acetate copolymer). Silane coupling agents can also be used as polymers. As polymers used for the alignment film, water-soluble polymers are suitable.

Of those polymers, poly(N-methylolacrylamide), carboxymethyl cellulose, gelatin, polyvinyl alcohol and modified polyvinyl alcohol are preferred over the others, gelatin, polyvinyl alcohol and modified polyvinyl alcohol in particular are favorable, and polyvinyl alcohol and modified polyvinyl alcohol are best suited.

The saponification degree of polyvinyl alcohol and that of modified polyvinyl alcohol are preferably from 70% to 100%, far preferably from 80% to 100%, further preferably from 85% to 95%. The polymerization degree of polyvinyl alcohol and that of modified polyvinyl alcohol are preferably from 100 to 3,000.

In modification of polyvinyl alcohol, modifying groups may be introduced by any of copolymerization modification, chain transfer modification and block polymerization modification. Examples of a modifying group introduced by copolymerization —COONa, —Si(OX)₃ (wherein X is a hydrogen atom or an alkyl group), —N(CH₃)₃ Cl, —C₉H₁₉, —COO, —SO₃Na and —C₁₂H₂₅. Examples of a modifying group introduced by chain transfer include —COONa, —SH and —C₁₂H₂₅. Examples of a modifying group introduced by block polymerization include —COOH, —CONH₂, —COOR (wherein R is an alkyl group) and —C₆H₅. In addition, alkylthio groups are also suitable modifying groups.

Descriptions of modified polyvinyl alcohol can be found in JP-A-8-338913.

When a hydrophilic polymer like polyvinyl alcohol is used in the alignment film, it is preferable that the percentage of moisture content is controlled from the viewpoint of film hardness. The percentage of moisture content is preferably from 0.4% to 2.5%, far preferably from 0.6% to 1.6%. The percentage of moisture content can be measured with a commercially available moisture-percentage measuring device utilizing the Karl Fischer technique.

It is preferable that the alignment film has a thickness of 10 μm or below.

### <Other Ingredients in Retardation Layer>

In combination with the liquid crystalline compound as mentioned above, a plasticizer, a surfactant and a polymerizable monomer can be used, and thereby the uniformity of the coating layer, the layer strength and the orientability of the liquid crystalline compound can be improved. And it is preferable that those ingredients have good compatibility with the liquid crystalline compound and do not interfere with the orientation of the liquid crystalline compound.

Examples of the polymerizable monomer include radical polymerizable compounds and cation polymerizable compounds. Multifunctional radical-polymerizable monomers are preferable, and monomers copolymerizable with liquid crystal compounds having the polymerizable groups as recited above are used to advantage. Specifically, the compounds disclosed in JP-A-2002-296423, par. Nos. [0018] to [0020], are usable. The amount of such compounds added is generally from 1% to 50% by mass, preferably from 5% to 30% by mass, based on discotic liquid crystalline molecules.

Examples of the surfactant include compounds hitherto known as surfactants, but fluorine-containing compounds in particular are preferable. More specifically, the compounds disclosed in JP-A-2002-330725, par. Nos. [0028] to [0056], and the compounds described in Japanese Patent Application No. 2003-295212, par. Nos. [0069] to [0126], can be used to advantage.

It is preferable that the polymer used in combination with the liquid crystalline compound can raise viscosity of the coating solution. Examples of such a polymer include cellulose esters, and suitable examples of cellulose esters include those disclosed in JP-A-2000-155216, par. No. [0178]. In order not to interfere with the orientation of the liquid crystal compound, it is appropriate to add the polymer to liquid crystalline molecules in a proportion of 0.1% to 10% by mass, preferably 0.1% to 8% by mass.

Additionally, the optically anisotropic layer preferably has its Re value within a range of 0 nm to 10 nm and its Rth value within a range of −80 nm to −400 nm.

### (Production of Optical Compensation Film)

The optical compensation film is generally produced in the form of a roll. It is preferable to produce the rolled optical compensation film by continuously performing the following processes (1) to (4):

(1) a process of forming an alignment film on a long length of transparent support fed in the length direction by coating a layer of resin solution, drying the layer and carrying out rubbing treatment for making the resin layer an alignment film, or by lamination coating of an alignment film formed in advance;

(2) a process of applying a coating solution containing a liquid crystalline compound to the surface of the alignment film;

(3) a process of making molecules of the liquid crystalline compound align by heating them at a temperature not lower than the transition temperature of the liquid crystalline compound simultaneously with or subsequently to the drying of the coating solution applied, and fixing the aligned state to form an optically anisotropic layer; and

(4) a process of reeling up a long length of layered product provided with the optically anisotropic layer.

In the process (3), it is preferable that the film-surface velocity of a wind blowing in the liquid crystalline compound surface from directions other than the direction of the rubbing treatment while the liquid crystalline molecules are made to align at a temperature not lower than the transition temperature thereof satisfies the following mathematical expression:

0<V<5.0×10⁻³×η

wherein V is the film-surface velocity (m/sec) of a wind blowing in the liquid crystalline compound surface and η is the viscosity (cp) of the optically anisotropic layer at the alignment temperature of the liquid crystalline compounds.

The most suitable range of V is from 0 to 2.5×10⁻³×η.

According to the processes (1) to (4), it becomes possible to continuously and consistently produce an optical compensation film in which the average direction of orthogonal projections of molecular symmetry axes of liquid crystalline compound molecules onto the transparent support surface (average direction of molecular symmetry axes in the optically anisotropic layer) is different from the in-plane slow axis of the transparent support (the length direction of the transparent support), and further the angle between the average direction of molecular symmetry axes and the rubbing direction is from −2° to +2°, preferably −1° to +1°, or substantially 0°. In other words, the production method including the processes (1) to (4) is suitable for mass production.

When the optical compensation film is applied in an OCB mode liquid crystal display, it is preferable that the angle which the average direction of molecular symmetry axes forms with the in-plane slow axis of the transparent support (the length direction of the transparent support) is 45° in a substantial sense.

In the process (2), a polymerizable liquid crystalline compound having a cross-linkable functional groups is used as the liquid crystalline compound, and in the process (3) the coating layer is cured by polymerizing the polymerizable liquid crystalline compound as the coating layer is continuously exposed to light to result in fixation of the aligned state, and successively thereto the process (4) can be carried out.

Prior to the process (2), a process of eliminating dust from the rubbing-treated surface of transparent support or alignment film may be carried out.

Prior to the process (4), an examination process for examining the optically anisotropic layer formed in the process (3) by continuously measuring its optical characteristics may be performed.

Detailed descriptions of the processes (1) to (4) can be found in JP-A-9-73081.

From the viewpoints of handling suitability and web life, the diameter of a rubbing roller used in the process (1) is preferably from 100 mm to 500 mm, far preferably from 200 mm to 400 mm. The rubbing roller is required to have a width wider than the width of a film conveyed thereby, and the width of the rubbing roller is preferably (film width)×2^{1/2} or above. The number of revolutions of the rubbing rollers is preferably set at a low value from the viewpoint of dust prevention. Depending on the susceptibility of a liquid crystalline compound to orientate, the revs are preferably from 100 rpm to 1,000 rpm, far preferably from 250 rpm to 850 rpm.

For retaining the orientation of a liquid crystalline compound even when the number of revolutions of the rubbing roller is set at a low value, it is preferable to heat the transparent support or the alignment film during the rubbing treatment. It is appropriate to set the heating temperature so that the surface temperature of the transparent support or the alignment film becomes within the range of (glass transition temperature of the material minus 50° C.) to (glass transition temperature of the material plus 50° C.). When the alignment film made from polyvinyl alcohol is used, it is appropriate that the ambient humidity during the rubbing treatment be controlled. The relative humidity at 25° C. is preferably from 25% to 70%, far preferably from 30% to 60%, especially preferably from 35% to 55%.

From the viewpoints of productivity and orientability of the liquid crystal, the feeding speed of the transparent support is preferably from 10 m/min to 100 m/min, far preferably from 15 m/min to 80 m/min. For the feeding, various devices hitherto used for feeding of films can be utilized. The way of feeding has no particular restrictions.

The alignment film can be formed by a coating solution prepared by dissolving a material, such as polyvinyl alcohol, in water or an organic solvent being applied to a transparent support and then dried. The formation of alignment film can be carried out prior to the series of processes. Alternatively, the alignment film may be formed continuously on the surface of a long length of transparent support under feeding.

In the process (2), the coating solution containing a liquid crystalline compound is applied to the alignment film surface. The solvent of the coating solution is preferably an organic solvent. Examples of such an organic solvent include amides (such as N,N-dimethylformamide), sulfoxides (such as dimethyl sulfoxide), heterocyclic compounds (such as pyridine), hydrocarbons (such as benzene and toluene), alkyl halides (such as chloroform, dichloromethane and tetrachloroethane), esters (such as methyl acetate and butyl acetate), ketones (such as acetone and methyl ethyl ketone) and ethers (such as tetrahydrofuran and 1,2-dimethoxyethane). Of these solvents, alkyl halides and ketones are preferred over the others. Two or more of the organic solvents may be used in combination.

For formation of a highly uniform optically anisotropic layer, it is appropriate that the surface tension of the coating solution be from 25 mN/m or below, preferably 22 mN/m or below.

For achievement of a low surface tension, it is adequate to add a surfactant to the coating solution for the optically anisotropic layer. The surfactant is preferably a fluorine-containing surfactant, far preferably a surfactant of fluorine-containing polymer type, especially preferably a surfactant including a polymer having fluoroaliphatic groups. The fluorine-containing polymer may be a copolymer constituted of fluorine-containing repeating units and other repeating units (e.g., those derived from polyoxyalkylene (meth)acrylates).

The mass average molecular weight of the fluorine-containing polymer is preferably from 3,000 to 100,000, far preferably 6,000 to 80,000. The amount of the fluorine-containing polymer added is preferably from 0.005% to 8% by mass, far preferably from 0.01% to 1% by mass, especially preferably from 0.05% to 0.5% by mass, of the solids content in the coating solution containing the liquid crystalline compound as a main component.

The application of the coating solution to the alignment film surface can be carried out using any of known methods (such as a wire bar coating method, an extrusion coating method, a direct gravure coating method, a reverse gravure coating method and a die coating method). The amount of the coating solution applied can be determined appropriately on the basis of the thickness of the optically anisotropic layer.

In the process (3), the liquid crystalline compound molecules are made to align at a temperature not lower than the transition temperature thereof simultaneously with or subsequently to the drying of the coating solution applied, and the aligned state is fixed to result in formation of an optically anisotropic layer. By the heating during or after the drying, the liquid crystalline compound becomes oriented as desired. The drying temperature can be determined with consideration given to the boiling point of a solvent used in the coating solution and materials used for the transparent support and the alignment film. The orientation temperature can be determined on a basis of the liquid crystal phase-solid phase transition temperature of the liquid crystalline compound used. When the liquid crystalline compound used is a discotic liquid crystalline compound, the orientation temperature is preferably chosen from the range of 70° C. to 300° C., far preferably from the range of 70° C. to 170° C.

The viscosity in a liquid crystalline state is preferably from 10 cp to 10,000 cp, far preferably from 100 cp to 1,000 cp. When the viscosity is too low, the liquid crystalline molecules are susceptible to the wind blowing at the time of alignment, so very precise velocity/direction control of the wind is required for continuous production. On the other hand, when the viscosity is high, liquid crystalline molecules become less sensitive to the wind, but alignment thereof becomes slow and a considerable drop in productivity is caused.

The viscosity of the liquid crystal layer can be controlled by molecular structure given to the liquid crystalline compound. It is also possible to adjust the viscosity by using additives (cellulose polymers in particular) to the optically anisotropic layer and a gelling agent in appropriate amounts.

The heating can be performed by blasts of an air warmed at a predetermined temperature or travel through a heating room kept at a predetermined temperature.

The optically anisotropic layer is formed through fixation of the aligned liquid crystalline compound molecules while keeping the aligned state. Fixation of the liquid crystalline compound molecules can be performed by cooling down to the solid phase transition temperature, or by polymerization reaction. The fixation by polymerization reaction is preferable. The polymerization reaction includes thermal polymerization reaction using a thermal polymerization initiator and photopolymerization reaction using a photopolymerization initiator. The photopolymerization reaction is preferable.

Examples of a photopolymerization initiator usable herein include the α-carbonyl compounds (disclosed in U.S. Pat. Nos. 2,367,661 and 2,357,670), the acyloin ethers (disclosed in U.S. Pat. No. 2,448,828), the α-hydrocarbon-substituted aromatic acyloin compounds (disclosed in U.S. Pat. No. 2,722,512), the polynuclear quinone compounds (disclosed in U.S. Pat. Nos. 3,046,127 and 2,951,758), the combinations of triarylimidazole dimers and p-aminophenyl ketones (disclosed in U.S. Pat. No. 3,549,367), the acridine and phenazine compounds (disclosed in JP-A-60-105667 and U.S. Pat. No. 4,239,850) and the oxadiazole compounds (disclosed in U.S. Pat. No. 4,212,970).
The amount of a photopolymerization initiator used is preferably from 0.01% to 20% by mass, far preferably from 0.5% to 5% by mass, of the solids content in the coating solution.

In light irradiation for promoting polymerization of liquid crystalline compound molecules and thereby fixing their aligned state, it is preferable to use ultraviolet rays. The irradiation energy is preferably from 20 mJ/cm² to 50 J/cm², far preferably from 100 mJ/cm² to 800 mJ/cm². For speeding up the photopolymerization reaction, light irradiation may be carried out under heating. The light irradiation can be carried out by the transparent support coated with a coating solution for the optically anisotropic layer being passed along the traveling course above or under, or at the left or right of which a light source is placed.

Before progression to the process (4), a protective layer can be provided on the optically anisotropic layer formed in the process (3). For instance, a protective film made in advance may be stacked continuously on the surface of the optically anisotropic layer made in a long length.

In the process (4), a long length of layered product provided with the optically anisotropic layer is wound into a roll. For instance, the continuously transported support having the optically anisotropic layer may be wound around a cylindrical core.

The optical compensation film obtained in the process (4) has the form of a roll, so the handling thereof is easy even when the film is made in large quantity. In addition, the film obtained can be stored and transported as its form is retained.

### (Polarizing Plate)

A polarizing plate comprises a polarizer and two transparent protective films arranged on both sides thereof. As one protective film, there can be used the cellulose acylate film of the invention. As the other protective film, there may be used an ordinary cellulose acetate film. The polarizers include an iodine-based polarizer, a dye-based polarizer using a dichroic dye and a polyene-based polarizer. The iodine-based polarizer and the dye-based polarizer are generally produced using a polyvinyl alcohol-based film. When the cellulose acylate film of the invention is used as the protective film for the polarizer, the production method of the polarizing plate is not particularly limited, and it can be produced by ordinary methods. There is a method of producing the polarizing plate, which comprises the steps of alkali-treating the resulting cellulose acylate film, and bonding it to both sides of the polarizer prepared by dipping a polyvinyl alcohol film in an iodine solution, followed by stretching, using an aqueous solution of completely saponificated polyvinyl alcohol. In place of the alkali treatment, processing for making adhesion easy as described in JP-A-6-94915 and JP-A-6-118232 may be employed. The adhesives used for bonding the treated surface of the protective film to the polarizer include, for example, polyvinyl alcohol-based adhesives such as polyvinyl alcohol and polyvinyl butyral, and vinyl-based latexes such as butyl acrylate. The polarizing plate generally comprising the polarizer and the protective films for protecting both surfaces of the polarizer, and further comprising a protective film bonded to one surface of the polarizing plate, and a separate film bonded to the opposite surface thereof. The protective film and the separate film are used in order to protect the polarizing plate in shipping of the polarizing plate and product inspection thereof. In this case, the protective film is bonded in order to protect the surface of the polarizing plate, and used on the opposite side to the surface on which the polarizing plate is bonded to a liquid crystal plate. The separate film is used for covering an adhesive layer bonded to the liquid crystal plate, and used on the side of the surface on which the polarizing plate is bonded to the liquid crystal plate.

The cellulose acylate film of the invention is preferably bonded to the polarizer so as to bring a transmission axis of the polarizer into line with the slow phase axis of the cellulose acylate film of the invention. Evaluations of the prepared polarizer under polarizer cross nicol have revealed that when the orthogonal precision between the slow phase axis of the cellulose acylate film of the invention and an absorption axis (an axis orthogonal to the transmission axis) of the polarizer is larger than 1°, polarization degree performance under polarizer cross nicol deteriorates to generate light omission. In this case, when it is combined with the liquid crystal cell, sufficient black levels and contrast fail to be obtained. Accordingly, deviation between the direction of the main refractive index nx of the cellulose acylate film of the invention and the direction of the transmission axis of the polarizer is preferably 1° or less, and more preferably 0.5° or less.

In the polarizing plate of the invention, it is preferred that the single plate transmittance (TT), parallel transmittance (PT), cross transmittance (CT) and polarization degree (P) at 25° C. and 60% RH meet at least one of the following equations (a) to (d):

40.0≦TT≦45.0 (a)

30.0≦PT≦40.0 (b)

CT≦2.0 (c)

95.0≦P (d)

In the order of the single plate transmittance (TT), the parallel transmittance (PT) and the cross transmittance (CT), more preferred are 40.5≦TT≦45, 32≦PT≦39.5 and CT≦1.5, respectively, and still more preferred are 41.0≦TT≦44.5, 34≦PT≦39.0 and CT≦1.3, respectively. polarization degree P is preferably 95.0% or more, more preferably 96.0% or more, and still more preferably 97.0% or more.

In the polarizing plate of the invention, when the cross transmittance at a wavelength of λ is taken as CT(λ), CT₍₃₈₀₎, CT₍₄₁₀₎ and CT₍₇₀₀₎ preferably meet at least one of the following equations (e) to (g):

CT₍₃₈₀₎≦2.0 (e)

CT₍₄₁₀₎≦1.0 (f)

CT₍₇₀₀₎≦0.5 (g)

More preferred are CT₍₃₈₀₎≦1.95, CT₍₄₁₀₎≦0.9 and CT₍₇₀₀₎≦0.49, and still more preferred are CT₍₃₈₀₎≦1.90, CT₍₄₁₀₎≦0.8 and CT₍₇₀₀₎≦0.48.

In the polarizing plate of the invention, the variation (ΔCT) in cross transmittance and the variation in polarization degree (ΔP) at the time when the polarizing plate has been allowed to stand under conditions of 60° C. and 95% RH for 500 hours meet at least one of the following equations (j) and (k):

−6.0≦ΔCT≦6.0 (j)

−10.0≦ΔP≦0.0 (k)

wherein the variation indicates a value obtained by subtracting a measured value before the test from a measured value after the test.

More preferred are −5.8≦ΔCT≦5.8 and −9.5≦ΔP≦0.0, and still more preferred are −5.6≦ΔCT≦5.6 and −9.0≦ΔP≦0.0.

In the polarizing plate of the invention, the variation (ΔCT) in cross transmittance and the variation in polarization degree (ΔP) at the time when the polarizing plate has been allowed to stand under conditions of 60° C. and 90% RH for 500 hours meet at least one of the following equations (h) and (i):

−3.0≦ΔCT≦3.0 (h)

−5.0≦ΔP≦0.0 (i)

In the polarizing plate of the invention, the variation (ΔCT) in cross transmittance and the variation in polarization degree (ΔP) at the time when the polarizing plate has been allowed to stand under conditions of 80° C. for 500 hours meet at least one of the following equations (l) and (m):

−3.0≦ΔCT≦3.0 (l)

−2.0≦ΔP≦0.0 (m)

The single plate transmittance (TT), parallel transmittance (PT) and cross transmittance (CT) of the polarizing plate are measured within the range of 380 to 780 nm using UV3100PC (manufactured by Shimadzu Corporation), and the average value of ten measurements (the average value at 400 to 700 nm) is used as each of TT, PT and CT. The polarization degree (P) can be found from polarization degree (%)=100×[(parallel transmittance−cross transmittance)/(parallel transmittance+cross transmittance)]^{1/2}. Polarizing plate durability tests are made in two types of forms, (1) only the polarizing plate and (2) the polarizing plate bonded to a glass with an adhesive. In the measurement in the form of only the polarizing plate, the cellulose acylate film of the invention is combined so that it is put between two polarizers, and the two same ones are prepared, followed by measurement. In the glass-bonded form, two samples (about 5 cm×5 cm) are prepared in which the polarizing plate is bonded onto the glass so that the cellulose acylate film of the invention is disposed on the glass side. In the measurement of the single plate transmittance, this sample is set directing the film side thereof to a light source, and the measurement is made. The measurements are made for the two samples, respectively, and the average value therefrom is taken as the single plate transmittance.

### (Bag Subjected to Moisture-Proof Treatment)

In the invention, a “bag subjected to moisture-proof treatment (moisture-proof bag)” is defined by moisture permeability measured based on the cup method (JIS-Z208). Considering the influence of environmental humidity outside the bag, it is preferred to use a material having a moisture permeability at 40° C. and 90% RH of 30 g/(m²·day) or less. Exceeding 30 g/(m²·day) results in failure to prevent the influence of environmental humidity outside the bag. The moisture permeability is more preferably 10 g/(m²·day) or less, and most preferably 5 g/(m²·day) or less.

There is no particular limitation on the material for the bag subjected to moisture-proof treatment, as long as it satisfies the above-mentioned moisture permeability, and known materials can be used (Hoso Zairyo Binran (Manual of Packaging Materials), Japan Packaging Institute (1995), Hoso Zairyo no Kiso Chisiki (Basic Knowledge of Packaging Materials), Japan Packaging Institute (November, 2001), Kinosei Hoso Nyumon (Introduction to Functional Packaging), 21st Century Packaging Research Institute (Feb. 28, 2002, first edition, first copy)) In the invention, a material low in moisture permeability, light in weight and easy to handle is desirable, and a deposited film obtained by depositing silica, alumina, a ceramic material or the like over a plastic film, or a composite film such as a stacked film of a plastic film and an aluminum foil can be particularly preferably used. There is no particular limitation on the thickness of the aluminum foil, as long as the foil has such a thickness that the humidity in the bag is not influenced by environmental humidity. However, the thickness of the foil is preferably from several micrometers to several hundred micrometers, and more preferably from 10 μm to 500 μm. The humidity in the moistureproof-treated bag used in the invention preferably satisfies either of the following:

When the polarizing plate is in a packaged state, it is required that the humidity in the package at a temperature of 25° C. be adjusted to the range of 43% RH to 70% RH, preferably 45% RH to 65% RH, far preferably 45% RH to 63% RH.

The humidity inside a bag in which the polarizing plate is packaged is required to be adjusted so as to differ by 15% RH or below from the ambient humidity at which the polarizing plate is stacked on a liquid crystal panel.

### (Antireflective Layer)

A functional film such as an antireflective layer is preferably provided on the transparent protective film disposed on the opposite side of the liquid crystal cell of the polarizing plate. In particular, in the invention, there is suitably used an antireflective layer in which at least a light scattering layer and a low refractive index layer are stacked on the transparent protective film in this order, or an antireflective layer in which a medium refractive index layer, a high refractive index layer and a low refractive index layer are stacked on the transparent protective film in this order. Preferred examples thereof are described below.

Preferred examples of the antireflective layers in which the light scattering layer and the low refractive index layer are provided on the transparent protective film will be described.

Matte particles are dispersed in the light scattering layer used in the invention, and the refractive index of a material of the light scattering layer excluding the matte particles is preferably within the range of 1.50 to 2.00, and the refractive index of the low refractive index layer is preferably within the range of 1.35 to 1.49. In the invention, the light scattering layer has both anti-glare properties and hard coat properties, and may be composed of either one layer or a plurality of layers, for example, 2 to 4 layers.

The surface unevenness shape of the antireflective layer is preferably designed so as to provide a center-line average roughness Ra of 0.08 to 0.40 μm, a 10-point average roughness Rz of 10 times or more of Ra, an average concave-convex distance Sm of 1 to 100 μm, a standard deviation of the convex height from the deepest part of concaves and convexes of 0.5 μm or less, a standard deviation of the average concave-convex distance Sm on the basis of the center line of 20 μm or less, and 10% or more of a face having an angle of inclination of 0 to 5 degrees, thereby achieving sufficient anti-glare properties and visually uniform matte texture. For the color of reflected light under a C light source, when the a* value is from −2 to 2, the b* value is from −3 to 3, and the ratio of the minimum value and the maximum value of the reflectance within the range of 380 to 780 nm is from 0.5 to 0.99, the color of reflected light preferably become neutral. Further, by adjusting the b* value of transmitted light under the C light source to 0 to 3, the yellowish color of a white indication at the time when it is applied to a display is preferably decreased. Furthermore, when the standard deviation of luminance distribution measured on the film by inserting a lattice of 120 μm×40 μm between the surface light source and the antireflective film is 20 or less, dazzling at the time when the film of the invention is applied to a high definition panel is preferably decreased.

When the antireflective layer used in the invention has a mirror reflectance of 2.5% or less, a transmittance of 90% or more and a 60-degree gloss value of 70% or less, as optical characteristics, reflection of outside light can be inhibited, and visibility is improved. Accordingly, such an antireflective layer is preferred. In particular, the mirror reflectance is more preferably 1% or less, and most preferably 0.5% or less. The antireflective layer having a haze of 20 to 50%, an inner haze/total haze value of 0.3 to 1, a decrease in a haze value after formation of the low refractive index layer from a haze value up to the light scattering layer of 15% or less, a transmitted image clarity at a comb width of 0.5 mm of 20 to 50%, and a vertical transmitted light/transmittance in a direction inclined at 2 degrees to the vertical direction ratio of 1.5 to 5.0 achieves prevention of dazzling on a high definition LCD panel and reduction in blurring of letters and the like. This is therefore preferred.

### (Low Refractive Index Layers)

The refractive index of the low refractive index layer of the antireflective film used in the invention is from 1.20 to 1.49, and preferably within the range of 1.30 to 1.44. In terms of a decrease in reflectance, it is preferred that the refractive index of the low refractive index layer to meet the following equation (IX):

(m/4)×0.7<n1d1<(m/4)×1.3 (IX)

wherein m is a positive odd number, n1 is a refractive index of the low refractive index layer, and d1 is a thickness (nm) of the low refractive index layer. λ is a wavelength, and a value within the range of 500 to 550 nm.

Materials for forming the low refractive index layer used in the invention will be described below.

The low refractive index layer used in the invention contains a fluorine-containing polymer as a low refractive index binder. The fluorine-containing polymer is preferably a fluorine-containing polymer crosslinkable by heat or ionizing radiation, which has a coefficient of dynamic friction of 0.03 to 0.20, a contact angle to water of 90 to 120° and a slide-down angle of pure water of 70° or less. When the antireflective film used in the invention is attached to an image display, lower peeling force from a commercially available adhesive tape preferably results in easy peeling of a seal or memo adhered thereto. The peeling force is preferably 500 gf or less, more preferably 300 gf or less, and most preferably 100 gf or less. The higher the surface hardness measured with a microhardness meter is, the more difficult to be scratched the film is. The surface hardness of the film is preferably 0.3 GPa or more, and more preferably 0.5 GPa or more.

The fluorine-containing polymers used in the low refractive index layer include a fluorine-containing copolymer having fluorine-containing monomer units and constitutional units for imparting crosslinking reactivity as constituent components, as well as a hydrolysate and a dehydrated condensate of a perfluoroalkyl group-containing silane compound (for example, (heptadecafluoro-1,1,2,2-tetrahydrodecyl)triethoxysilane.

Specific examples of the fluorine-containing monomer units include a fluoroolefin (for example, fluoroethylene, vinylidene fluoride, tetrafluoroethylene, perfluorooctylethylene, hexafluoropropylene or perfluoro-2,2-dimethyl-1,3-dioxole), a partially or completely fluorinated alkyl ester derivative of (meth)acrylic acid (for example, Biscoat 6FM (manufactured by Osaka Organic Chemical Industry, Ltd.) or M-2020 (manufactured by Daikin Industries, Ltd.)), and a completely or partially fluorinated vinyl ether. Preferred is a perfluoroolefin, and from the viewpoints of refractive index, solubility, transparency and availability, particularly preferred is hexafluoropropylene.

The constitutional units for imparting crosslinking reactivity include a constitutional unit obtained by polymerization of a monomer previously having a self crosslinkable functional group in its molecule, such as glycidyl (meth)acrylate or glycidyl vinyl ether, a constitutional unit obtained by polymerization of a monomer having a carboxyl group, a hydroxyl group, an amino group or a sulfo group (for example, (meth)acrylic acid, methylol (meth)acrylate, hydroxyalkyl (meth)acrylate, allyl acrylate, hydroxyethyl vinyl ether, hydroxybutyl vinyl ether, maleic acid or crotonic acid), and a constitutional unit obtained by introducing a crosslinkable group such as a (meth)acryloyl group into the above-mentioned constitutional unit by polymer reaction (for example, the crosslinkable group can be introduced by a technique of reacting acryloyl chloride with a hydroxyl group).

In addition to the above-mentioned fluorine-containing monomer unit and constitutional unit for imparting crosslinking reactivity, a fluorine-free monomer can also be appropriately copolymerized from the viewpoints of solubility in the solvent and transparency of the film. There is no particular limitation on the simultaneously usable monomer unit, and examples thereof include an olefin (such as ethylene, propylene, isoprene, vinyl chloride or vinylidene chloride), an acrylic ester (such as methyl acrylate, methyl acrylate, ethyl acrylate or 2-ethylhexyl acrylate), a methacrylic ester (such as methyl methacrylate, ethyl methacrylate, butyl methacrylate or ethylene glycol dimethacrylate), a styrene derivative (such as styrene, divinylbenzene, vinyltoluene or α-methylstyrene), a vinyl ether (such as methyl vinyl ether, ethyl vinyl ether or cyclohexyl vinyl ether), a vinyl ester (such as vinyl acetate, vinyl propionate or vinyl cinnamate), an acrylamide (such as N-tert-butylacrylamide or N-cyclohexylacrylamide), a methacrylamide and an acrylonitrile derivative.

A hardener may be appropriately used in combination with the above-mentioned polymer as described in JP-A-10-25388 and JP-A-10-147739.

### (Light Scattering Layers)

The light scattering layer is formed in order to impart light diffusibility caused by surface scattering and/or internal scattering and hard coat properties for improving scratch resistance of the film to the film. Accordingly, the light scattering layer is formed containing a binder for imparting hard coat properties, matte particles for imparting light diffusibility and an inorganic filler for increasing refractive index, preventing crosslinking contraction and increasing strength as needed.

In order to impart hard coat properties, the thickness of the light scattering layer is preferably from 1 to 10 μm, and more preferably from 1.2 to 6 μm. When the thickness is too thin, hard coat properties become insufficient. On the other hand, when the thickness is too thick, curling or brittleness is deteriorated, resulting in insufficient processing aptitude.

The binder of the scattering layer is preferably a polymer having a saturated hydrocarbon chain or a polyether chain as a main chain, and more preferably a polymer having a saturated hydrocarbon chain as a main chain. Further, it is preferred that the binder polymer has a crosslinked structure. The binder polymer having a saturated hydrocarbon chain as a main chain is preferably a polymer of an ethylenic unsaturated monomer. The binder polymer having a saturated hydrocarbon chain as a main chain and a crosslinked structure is preferably a (co)polymer of a monomer having two or more ethylenic unsaturated groups. In order to increase the refractive index, there can also be selected a monomer containing an aromatic ring or at least one atom selected from a halogen atom, a sulfur atom, a phosphorous atom and a nitrogen atom in its molecule.

The monomers having two or more ethylenic unsaturated groups include an ester of a polyhydric alcohol and (meth)acrylic acid (for example, ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate or polyester polyacrylate), an ethylene oxide-modified product thereof, vinylbenzene and a derivative thereof (for example, 1,4-divinylbenzene, 4-vinylbenzoic acid-2-acryloyl ethyl ester or 1,4-divinylcyclohexanone), a vinylsulfone (for example, divinylsulfone), an acrylamide (for example, methylenebisacrylamide) and methacrylamide. The above-mentioned monomers may be used as a combination of two or more thereof.

Specific examples of the high refractive index monomers include bis(4-methacryloylthiophenyl)sulfide, vinylnaphthalene, vinylphenylsulfide and 4-methacryloxyphenyl-4′-methoxyphenyl thioether. These monomers may also be used as a combination of two or more thereof.

Polymerization of these ethylenic unsaturated group-containing monomers can be conducted by irradiation of ionizing radiation or heating in the presence of a photo-radical initiator or a thermal radical initiator.

Accordingly, a coating solution containing the ethylenic unsaturated group-containing monomer, the photo-radical initiator or the thermal radical initiator, the matte particles and the inorganic filler is prepared, and applied onto a transparent support. Then, the coating solution applied can be cured by polymerization reaction using ionizing radiation or heat to form an antireflective film. As these photo-radical initiators and the like, known ones can be used.

The polymer having a polyether as a main chain is preferably a ring-opening polymer of a multifunctional epoxy compound. Ring-opening polymerization of the multifunctional epoxy compound can be performed by irradiation of ionizing radiation or heating in the presence of the photo-radical initiator or the thermal radical initiator. Accordingly, a coating solution containing the multifunctional epoxy compound, the photo-radical initiator or the thermal radical initiator, the matte particles and the inorganic filler is prepared, and applied onto a transparent support. Then, the coating solution applied can be cured by polymerization reaction using ionizing radiation or heat to form an antireflective film.

In place of or in addition to the monomer having two or more ethylenic unsaturated groups, a monomer having a crosslinkable functional group is used to introduce the crosslinkable functional group into the polymer, and the crosslinked structure may be introduced into the binder polymer by the reaction of this crosslinkable functional group.

Examples of the crosslinkable functional groups include an isocyanate group, an epoxy group, an aziridine group, an oxazoline group, an aldehyde group, a carbonyl group, a hydrazine group, a carboxyl group, a methylol group and an active methylene group. Vinylsulfonic acid, an acid anhydride, a cyanoacrylate derivative, melamine, etherified methylol, an ester, an urethane and a metal alkoxide such as tetramethoxysilane can also be utilized as a monomer for introducing the crosslinked structure. A functional group showing crosslinkability as a result of decomposition reaction, such as a block isocyanate group, may also be used. That is to say, in the invention, the crosslinkable functional group may be a group showing reactivity as a result of decomposition without immediately showing reactivity.

These crosslinkable functional group-containing binder polymers can form the crosslinked structure by heating after coating.

The light scattering layer contains matte particles larger than filler particles and having an average particle size of 1 to 10 μm, preferably 1.5 to 7.0 μm, for example, inorganic compound particles or resin particles, in order to impart anti-glare properties.

Preferred specific examples of the above-mentioned matte particles include, for example, inorganic compound particles such as silica particles and TiO₂ particles; and resin particles such as acrylic resin particles, crosslinked acrylic resin particles, polystyrene particles, crosslinked styrene particles, melamine resin particles and benzoguanamine resin particles. Above all, crosslinked styrene particles, crosslinked acrylic resin particles, crosslinked acrylic styrene resin particles and silica particles are preferred.

The usable form of the particles may be either spherical or irregular.

Further, two or more kinds of matte particles different in particle size may be used in combination. The matte particles larger in particle size can impart anti-glare properties, and the matte particles smaller in particle size can impart another optical characteristic.

Further, the particle size distribution of the above-mentioned matte particles is most preferably monodisperse, and it is preferred that the respective particles are as similar as possible in particle size. For example, when particles having a particle size 20% or more larger than the average particle size are defined as coarse particles, the ratio of the coarse particles to the total number of particles is preferably 1% or less, more preferably 0.1% or less, and still more preferably 0.01% or less. The matte particles having such a particle size distribution is obtained by classification after ordinary synthesis reaction, and the matte particles having a more preferred distribution can be obtained by increasing the number of times of classification or intensifying the degree thereof.

The above-mentioned matte particles are contained in the light scattering layer so that the amount of the matte particles in the light scattering layer formed is preferably from 10 to 1000 mg/m², and more preferably from 100 to 700 mg/m².

The particle size distribution of the matte particles is measured by the Coulter counter method, and the distribution measured is converted to a particle number distribution.

In order to increase the refractive index of the layer, the light scattering layer preferably contain an inorganic filler selected from titanium, zirconium, aluminum, indium. Zinc, tin and antimony and having an average particle size of 0.2 μm or less, preferably 0.1 μm or less and more preferably 0.06 μm or less, in addition to the above-mentioned matte particles.

Conversely, in the light scattering layer in which high refractive index particles are used in order to increase the difference in refractive index from the matte particles, it is also preferred to use an oxide of silicon in order to keep the refractive index of the layer rather low. The preferred particle size is the same as that of the inorganic filler described above.

Specific examples of the inorganic fillers used in the light scattering layer include TiO₂, ZrO₂, Al₂O₃, In₂O₃, ZnO, SnO₂, Sb₂O₃, ITO and SiO₂. TiO₂ and ZrO₂ are particularly preferred in terms of increasing the refractive index. A surface of the inorganic filler is preferably subjected to silane coupling treatment or titanium coupling treatment, and a surface treating agent which gives a functional group reactable with a binder species to the filler surface is preferably used.

The amount of these inorganic fillers added is preferably from 10 to 90%, more preferably from 20 to 80%, and particularly preferably from 30 to 75%, based on the total mass of the light scattering layer.

Such a filler has a particle size sufficiently small compared to the wavelength of light, so that scattering does not occur, and a dispersion in which the filler is dispersed in a binder polymer behaves as an optically uniform material.

The refractive index of a bulk of a mixture of the binder and the inorganic filler in the light scattering layer is preferably from 1.48 to 2.00, and more preferably from 1.50 to 1.80. In order to adjust the refractive index within the above-mentioned range, the kind and amount ratio of binder and inorganic filler may be appropriately selected. How to select them can be previously experimentally easily known.

In the light scattering layer, in order to prevent uneven coating, uneven drying, point defects and the like to secure surface uniformity, either of a fluorine-containing surfactant and a silicone-based surfactant or both thereof are contained in a coating composition for formation of the anti-glare layer. In particular, the fluorine-based surfactant is preferably used, because the addition thereof in a smaller amount manifests the effect of improving surface failures such as uneven coating, uneven drying and point defects. An object thereof is to enhance productivity by giving high-speed coating aptitude while upgrading surface uniformity.

The antireflective layer in which the medium refractive index layer, the high refractive index layer and the low refractive index layer are stacked on the transparent protective film in this order will be described below.

The antireflective film having the layer structure of the medium refractive index layer, the high refractive index layer and the low refractive index layer (outermost layer) on the substrate in this order is designed so as to have refractive indexes satisfying the following relationship:

The refractive index of the high refractive index layer>the refractive index of the medium refractive index layer>refractive index of the transparent support>the refractive index of the low refractive index layer

Further, a hard coat layer may be provided between the transparent support and the medium refractive index layer. Furthermore, the antireflective layer may comprise an medium refractive index hard coat layer, the high refractive index layer and the low refractive index layer. Examples thereof are described in JP-A-8-122504, JP-A-8-110401, JP-A-10-300902, JP-A-2002-243906 and JP-A-2000-111706.

In addition, another function may be imparted to each layer, and examples thereof include a soil-resistant low refractive index layer and an antistatic high refractive index layer (for example, see JP-A-10-206603 and JP-A-2002-243906).

The haze of the antireflective film is preferably 5% or less, and more preferably 3% or less. Further, the strength of the film measured by the pencil hardness test according to JIS K5400 is preferably H or more, more preferably 2H or more, and most preferably 3H or more.

### (High Refractive Index Layers and Medium Refractive Index Layers)

The high refractive index layer of the antireflective film is composed of a curable film containing at least ultrafine inorganic compound particles having an average particle size of 100 nm or less and a high refractive index and a matrix binder.

The ultrafine inorganic compound particles having a high refractive index include an inorganic compound having a refractive index of 1.65 or more, preferably 1.9 or more. Examples thereof include oxides of Ti, Zn, Sb, Sn, Zr, Ce, Ta, La and In, and complex oxides containing these metal atoms.

Such ultrafine particles are produced by treatment of particle surfaces with a surface treating agent (for example, see JP-A-11-295503, JP-A-11-153703 and JP-A-2000-9908 for a silane coupling agent, and JP-A-2001-310432 for an anionic compound or an organic metal coupling agent), formation of a core-shell structure in which the high refractive index particles are taken as a core (see JP-A-2001-166104) and combined use of a specified dispersing agent (see JP-A-11-153703, U.S. Pat. No. 6,210,858 and JP-A-2002-2776069).

The materials for forming the matrix include a thermoplastic resin and a thermosetting resin which have hitherto been known.

Further, preferred is at least one composition selected from a multifunctional compound-containing composition having at least two or more of radical and/or cationic polymerizable groups, a hydrolytic group-containing organic metal compound and a partial condensate composition thereof. Examples thereof include compositions described in JP-A-2000-47004, JP-A-2001-315242, JP-A-2001-31871 and JP-A-2001-296401.

Furthermore, a colloidal metal oxide obtained from a hydrolyzed condensate of a metal alkoxide and a curable film obtained from a metal alkoxide composition are also preferred. These are described, for example, in JP-A-2001-293818.

The refractive index of the high refractive index layer is generally from 1.70 to 2.20. The thickness of the high refractive index layer is preferably from 5 nm to 10 μm, and more preferably from 10 nm to 1 μm.

The refractive index of the medium refractive index layer is adjusted to a value between the refractive index of the low refractive index layer and that of the high refractive index layer. The refractive index of the medium refractive index layer is preferably from 1.50 to 1.70. Further, the thickness thereof is preferably from 5 nm to 10 μm, and more preferably from 10 nm to 1 μm.

### (Low Refractive Index Layers)

The low refractive index layer is sequentially stacked on the high refractive index layer. The refractive index of the low refractive index layer is from 1.20 to 1.55, and preferably from 1.30 to 1.50.

The low refractive index layer is preferably constructed as an outermost layer having scratch resistance and soil resistance. As a means for largely improving scratch resistance, it is effective to impart slipperiness to the surface, and a means using a silicone-introduced or fluorine-introduced thin film layer which has hitherto been known can be applied.

The refractive index of the fluorine-containing compound is preferably from 1.35 to 1.50, and more preferably from 1.36 to 1.47. Further, the fluorine-containing compound is preferably a compound containing fluorine atoms in an amount ranging from 35 to 80% by mass and having a crosslinkable or polymerizable functional group.

The fluorine-containing compounds include, for example, compounds described in JP-A-9-222503, paragraph numbers [0018] to [0026], JP-A-11-38202, paragraph numbers [0019] to [0030], JP-A-2001-40284, paragraph numbers [0027] to [0028] and JP-A-2000-284102.

The silicone compound is a compound having a polysiloxane structure, and preferably one containing a curable functional group or a polymerizable functional group in its polymer chain to form a crosslinked structure in the film. Examples thereof include a reactive silicone (for example, Silaplane (manufactured by Chisso Corporation) and a polysiloxane having silanol groups at both ends thereof (JP-A-11-258403).

The crosslinking or polymerization reaction of the fluorine-containing and/or siloxane polymer having a crosslinkable or polymerizable group is preferably conducted by light irradiation or heating of a coating composition containing a polymerization initiator, a sensitizer and the like for forming the outermost layer, simultaneously with or after the coating thereof.

Further, a sol-gel cured film is also preferred which is obtained by curing an organic metal compound such as a silane coupling agent and a silane coupling agent containing a specified fluorine-containing hydrocarbon group by condensation reaction under the coexistence of a catalyst.

Examples thereof include polyfluoroalkyl group-containing silane compounds or partially hydrolyzed condensates thereof (compounds described in JP-A-58-142958, JP-A-58-147483, JP-A-58-147484, JP-A-9-157582 and JP-A-11-106704), and fluorine-containing long chain group—containing or perfluoroalkylether group-containing silyl groups (compounds described in JP-A-2000-117902, JP-A-2001-48590 and JP-A-2002-53804).

The low refractive index layer can contain, as additives other than the above, a filler (for example, silicon dioxide (silica), a low refractive index inorganic compound having an average primary particle size of 1 to 150 nm such as fluorine-containing particles (magnesium fluoride, calcium fluoride or barium fluoride) or fine organic particles described in JP-A-11-3820, paragraph numbers [0020] to [0038]), a silane coupling agent, a slipping agent, a surfactant and the like.

When the low refractive index layer is positioned as an under layer to the outermost layer, it may be formed by a vapor phase method (such as a vacuum deposition method, a sputtering method, an ion plating method or a plasma CVD method). A coating method is preferred in that the low refractive index layer can be inexpensively produced.

The film thickness of the low refractive index layer is preferably from 30 to 200 nm, more preferably from 50 to 150 nm, and most preferably from 60 to 120 nm.

(Layers Other than Antireflective Layer)

Further, a hard coat layer, a forward scattering layer, a primer layer, an antistatic layer, an undercoat layer, a protective layer or the like may be provided.

### (Hard Coat Layers)

The hard coat layer is provided on a surface of the support in order to impart physical strength to the transparent protective film having the antireflective layer. In particular, it is preferably provided between the transparent support and the above-mentioned high refractive index layer. The hard coat layer is preferably formed by crosslinking reaction or polymerization reaction of a light- and/or heat-curable compound. The curable functional group is preferably a light-polymerizable functional group, and a hydrolysable functional group-containing organic metal compound, particularly an organic alkoxysilyl compound is preferred.

Specific examples of these compounds include compounds similar to those exemplified for the high refractive index layers. Specific constituent compositions of the hard coat layers include, for example, ones described in JP-A-2002-144913, JP-A-2000-9908 and PCT International Publication No. 00/46617 pamphlet.

The high refractive index layer can serve as the hard coat layer. In such a case, it is preferred that fine particles are finely dispersed using the technique described for the high refractive index layer and allowed to be contained in the hard coat layer to form it.

The hard coat layer can also serve as an anti-glare layer (described later) which is allowed to contain particles having an average particle size of 0.2 to 10 μm to impart anti-glare properties.

The thickness of the hard coat layer can be suitably designed according to its use. The thickness of the hard coat layer is preferably from 0.2 to 10 μm, and more preferably from 0.5 to 7 μm.

The strength of the hard coat layer measured by the pencil hardness test according to JIS K5400 is preferably H or more, more preferably 2H or more, and most preferably 3H or more. Further, in the Taber test according to JIS K5400, it is preferred that the abrasion loss of a test piece after the test is as small as possible.

### (Antistatic Layers)

When the antistatic layer is provided, it is preferred to impart a conductivity of 10⁻⁸ (Ωcm⁻³) or less in volume resistivity. It is possible to impart a volume resistivity of 10⁻⁸ (Ωcm⁻³) by use of a hygroscopic material, a water-soluble inorganic salt, a certain surfactant, a cationic polymer, an anionic polymer or colloidal silica. However, it largely depends on temperature and humidity, so that there is the problem that sufficient conductivity can not be secured at low humidity. Accordingly, a metal oxide is preferred as a material for a conductive layer. Some metal oxides are colored, and such metal oxides are unfavorable because the whole film is colored when they are used as the materials for the conductive layer. Metals forming non-colored metal oxides include Zn, Ti, Sn, Al, In, Si, Mg, Ba, Mo, W and V, and metal oxides containing these as main components are preferably used. Specific examples thereof include ZnO, TiO₂, SnO₂, Al₂O₃. In₂O₃, SiO₂, MgO, BaO, MoO₃, WO₃, V₂O₅ and a complex oxide thereof, and particularly preferred are ZnO, TiO₂ and SnO₂. As for examples containing heteroatoms, addition of Ai or In to ZnO, addition of Sb, Nb or a halogen atom to SnO₂, and addition of Nb or Ta to TiO₂ are effective. Furthermore, as described in JP-B-59-6235, there may be used a material in which the above-mentioned metal oxide is adhered to different crystalline metal particles or a fibrous material (for example, titanium oxide). The volume resistivity and the surface resistivity are physical values different from each other, and therefore can not be simply compared. However, in order to secure a conductivity of 10⁻⁸ (Ωcm⁻³) or less in volume resistivity, the conductive layer may have a surface resistivity of approximately 10⁻¹⁰ (Ω/square) or less, more preferably 10⁻⁸ (Ω/square) or less. The surface resistivity of the conductive layer is required to be measured as a value at the time when the antistatic layer is disposed as the uppermost layer, and can be measured at a stage in the course of formation of the stacked film described in this specification.

### (Liquid Crystal Display)

The cellulose acylate film according to the invention, the optical compensation film including the cellulose acylate film and the polarizing plate using the optical compensation film can be used in various display-modes of liquid crystal cells and liquid crystal displays. The various display modes hitherto proposed include TN (Twisted Nematic), IPS (In-Plane Switching), FLC (Ferroelectric Liquid Crystal), AFLC (Anti-Ferroelectric Liquid Crystal), OCB (Optical Compensatory Bend), STN (Super Twisted Nematic), VA (Vertically Aligned) and HAN (Hybrid Aligned Nematic) modes. Of these modes, IPS, OCB or TN mode can be used to advantage.

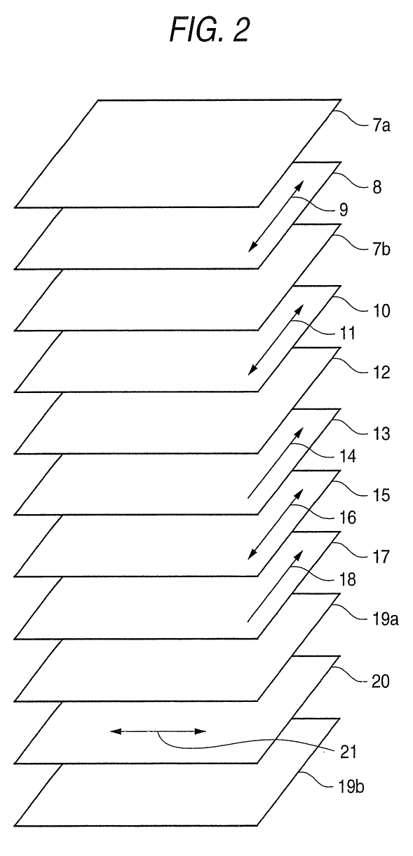

A liquid crystal display as shown in FIG. 2 has polarizing films 8 and 20, a first retardation zone 10, a second retardation zone 12, substrates 13 and 17, and a liquid crystal layer 15 sandwiched between these substrates. The polarizing film 8 is sandwiched between protective films 7a and 7b, and the polarizing film 20 is sandwiched between protective films 19a and 19b.

In the liquid crystal display shown in FIG. 2, the liquid crystal cell is made up of substrates 13 and 17 and a liquid crystal layer 15 sandwiched between them. In an IPS type of liquid crystal cell having no twisted structure, the optimum value of the product of the liquid crystal layer thickness d (μm) and the refractive-index anisotropy Δn, namely Δn d, in a transmission mode is in the range of 0.2 to 0.4 μm. In this range, white-state display brightness is high and black-state display brightness is low, so a well-lit, high-contrast display can be obtained. The substrates 12 and 17 have alignment films (not shown in the figure) which are formed on the their respective sides to be brought into contact with the liquid crystal layer 15, and thereby liquid crystalline molecules are made to align nearly parallel to the substrate surface, and besides, the directions of liquid-crystal molecular alignments in a no-voltage-applied state or a low-voltage-applied state can be controlled by the directions 14 and 18 of rubbing treatments given to the alignment films, respectively. In addition, an electrode (not shown in FIG. 2) enabling application of a voltage to liquid crystalline molecules is formed at the inner surface of the substrate 13 or 17.

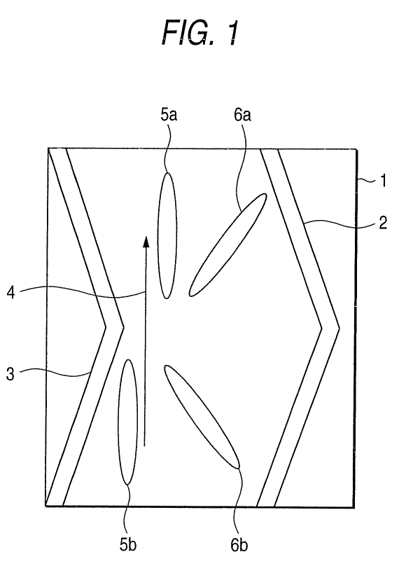

In FIG. 1, an arrangement of liquid crystalline molecules in one pixel region of the liquid crystal layer 15 is shown schematically. FIG. 1 is a schematic diagram showing an arrangement of liquid crystalline molecules in a region having an extremely small area nearly equal to one pixel in the liquid crystal layer 15, together with the rubbing direction 4 of the alignment films, which are formed on the inner surfaces of the substrates 13 and 17, and the electrodes 2 and 3 capable of applying a voltage to the liquid crystalline molecules, which are formed at the inner surfaces of the substrates 13 and 17. When an active drive is carried out using a nematic liquid crystal having a positively induced anisotropy as field-effect liquid crystal, the directions of liquid-crystal molecular alignment in a no-voltage-applied state or a low-voltage-applied state are 5a and 5b, and at this time, black-state display is obtained. When a voltage is applied between the electrodes 2 and 3, the liquid crystalline molecules change their orientations to the directions of 6a and 6b, respectively, according to the voltage applied. In this condition, bright-state display is generally performed.

To return to the explanation of FIG. 2, a transmission axis 9 of the polarizing film 8 and a transmission axis 21 of the polarizing film 20 are placed so as to be perpendicular to each other. The slow axis 11 in the first retardation zone 10 (the cellulose acylate film according to the invention) is parallel to the transmission axis 9 of the polarizing film 8 and to the slow axis direction 16 of liquid crystalline molecules in the liquid crystal layer 16 at the time of black-state display.

The liquid display shown in FIG. 2 is configured such that the polarizing film 8 is sandwiched between two protective films 7a and 7b, but the protective film 7b may be absent. In addition, the polarizing film 20 also is sandwiched between two protective films 19a and 19b, but the protective film 19 on the side near the liquid crystal layer 15 may be absent. In the embodiment shown in FIG. 2, the first retardation zone and the second retardation zone (the rod-shaped liquid crystalline compound layer according to the invention) may be placed, on a base of the position of the liquid crystal cell, between the liquid crystal cell and the polarizing film on the viewing side, or between the liquid crystal cell and the polarizing film situated at the back of the display. In each of these configurations according to a mode carrying out the invention, the second retardation zone is located closer to the liquid crystal cell.

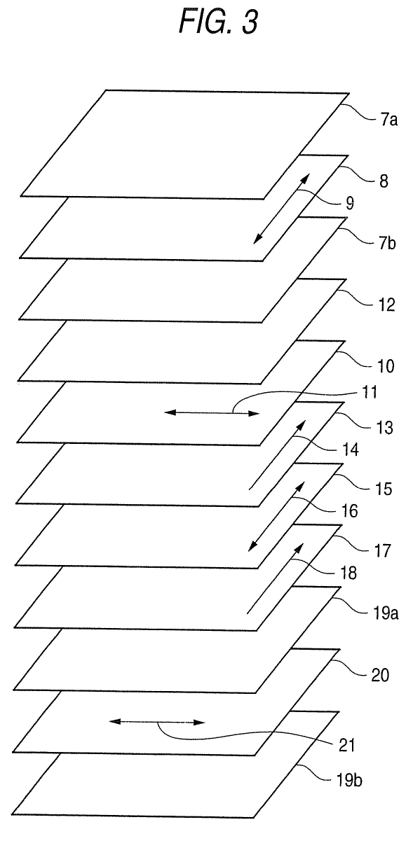

Another mode for carrying out the invention is shown in FIG. 3. In the liquid crystal display shown in FIG. 3, the second retardation zone 12 is placed between the polarizing film 8 and the first retardation zone 10. In the liquid crystal display shown in FIG. 3, the protective film 7b and the protective film 19a may be absent. In the embodiment shown in FIG. 3, the slow axis 11 in the first retardation zone 10 is arranged orthogonal to the transmission axis 9 of the polarizing film 8 and the slow axis direction 16 of liquid crystalline molecules in the liquid crystal layer 15 at the time of black-state display. In the embodiment shown in FIG. 3 also, the first retardation zone and the second retardation zone may be placed, on a base of the position of the liquid crystal cell, between the liquid crystal cell and the polarizing film on the viewing side, or between the liquid crystal cell and the polarizing film situated at the back of the display. In each of these configurations according to a mode carrying out the invention, the first retardation zone is located closer to the liquid crystal cell.

Additionally, in FIG. 3, an embodiment of transmission-mode display provided with an upper-side polarizing plate and a lower-side polarizing plate is shown, but an embodiment of the invention may be a reflection-mode display provided with only one polarizing plate. In this case, the optical path inside the liquid crystal cell is doubled, so the optimum Δn d value becomes of the order of ½ the value as mentioned above. The liquid crystal cell used in the invention is not limited to those of IPS mode, but any of liquid crystal displays can be suitably used so far as their liquid crystalline molecules can align substantially parallel to the surfaces of one pair of the substrates described above at the time of black-state display. Examples of such displays include a ferroelectric liquid crystal display, an anti-ferroelectric liquid crystal display and an ECB-mode liquid crystal display.

The structure the liquid crystal display according to the invention can have is not limited to those shown in FIG. 1 to FIG. 3, but may include other members. For instance, a color filter may be placed between the liquid crystal layer and a polarizing film. Further, the surface of the protective film on the polarizing film may be subjected to antireflection treatment and provided with a hard coating. In addition, conductivity-imparted constituent members may be used. In the case of using the display as transmission type, a backlight using as a light source a cold cathode or hot cathode fluorescent tube, a light-emitting diode, a field emission device or an electroluminescent device can be arranged at the back of the display. In this case, the position of the backlight may be either the upper side or the lower side in FIG. 2 and FIG. 3 each. Moreover, it is possible to place between the liquid crystal layer and the backlight a reflection-type polarizing plate, a diffusing plate, a prism sheet and an optical waveguide. Alternatively, as mentioned above, the liquid crystal display according to the invention may be a reflection type. In this case, only one polarizing plate may be placed on the viewing side, and a reflective film is arranged on the back of the liquid crystal cell or on the inner surface of the substrate on the under side of the liquid crystal cell. Of course, it is also possible to provide a front light using a light source as recited above on the side of viewing the liquid crystal cell.

The liquid crystal display according to the invention includes a direct-image-viewing-type display, an image-projection-type display and a light-modulation-type display. The present invention is especially effective in embodiments applied to an active matrix liquid crystalline display using 3- or 2-terminal semiconductor devices, such as TFT or MIM. Needless to say, the invention is also effective in embodiments applied to a passive matrix liquid crystal display referred to as time-shared derive.

The OCB mode liquid crystal display is a liquid crystal display using a bend alignment mode liquid crystal cell in which rod-shaped liquid crystalline molecules present in the top region of the liquid crystal cell are aligned in the direction substantially opposite to the direction in which those present in the bottom region are aligned (the former are aligned in symmetry with respect to the latter). OCB mode liquid crystal cells are disclosed in U.S. Pat. Nos. 4,583,825 and 5,410,422. Since the alignment of rod-shaped liquid crystalline molecules in the top region of a liquid crystal cell and that in the bottom region are in symmetry, the bend alignment liquid crystal cell has an optically self-compensating function. Therefore, this liquid crystal mode is also referred to as an OCB (Optically Compensatory Bend) liquid crystal mode. The bend alignment mode liquid crystal display has an advantage in rapidity of response.

The invention will now be illustrated in more detail by reference to the following examples, but these examples should not be construed as limiting the scope of the invention.

### [Measurement Methods]

### (Retardation)

The Re(λ) value was measured with KOBRA 21ADH (made by Oji Scientific Instruments) as light with a wavelength of λ nm was made to strike upon a film in the direction of the normal to the film surface. In addition, the Rth(λ) value was calculated on the basis of three retardation values measured in three different directions, namely the retardation value Re(λ) described above, a retardation value measured under conditions that the in-plane slow axis was taken as an axis of tilt and light with a wavelength of λ nm was made to strike from a direction tilting to +40° with respect to the direction of the normal to the film and a retardation value measured under conditions that the in-plane slow axis was taken as an axis of tilt and light with a wavelength of λ nm was made to strike from a direction tilting to −40° with respect to the direction of the normal to the film, and by inputting the value 1.48 assumed as the average refractive index and a film thickness. Incidentally, the wavelength λ for measurements of Re and Rth was set at 550 nm unless otherwise indicated.

### (Moisture Content Rate)

The moisture content in a sample measuring 7 mm×35 mm was determined using the Karl Fischer technique, a moisture-measuring device and sample dryers (CA-03 and VA-05, made by Mitsubishi Chemical Corporation). And the moisture content rate was calculated by dividing the moisture content (g) by the mass of the sample (g).

### (Thermal Shrinkage Rate)

Samples measuring 30 mm×120 mm were allowed to sand for 24 hours and 120 hours, respectively, under conditions of 90° C. and 5% RH, and holes of 6 mm φ were punched at intervals of 100 mm along the both edges of each sample by use of an automatic pin gauge (made by Shinto Scientific Co., Ltd.). The actual size (L1) of each interval was read down to the least division of the scale, 1/1000 mm. Further, each sample was allowed to stand for 24 hours under a 60° C.-95% RH condition or a 90° C.-5% RH condition, and the dimension (L2) of each punched interval was measured. And thermal shrinkage rate was determined by the expression {(L1−2)/L1}×100.

### (Glass Transition Temperature Tg)

A film sample (undergoing no stretching treatment) measuring 5 mm×30 mm underwent moisture control for at least 2 hours in the 25° C.-60% RH atmosphere, and then examined for Tg using a dynamic viscoelasticity measuring equipment (Vibron DVA-225, made by I. T. Keisoku Seigyo K. K.) at settings that the intergrip distance was 20 mm, the speed of rising in temperature was 2° C./min, the temperature range of measurement was from 30° C. to 200° C. and the frequency was 1 Hz. When the storage elasticity modulus was plotted as ordinate with a logarithmic scale and the temperature (° C.) as abscissa with a linear scale, sharp reductions in storage elasticity modulus were found at the occasion of transfer from the solid region to the glass transition region. A straight line 1 was drawn along the sharp reduction in the solid region and a straight line 2 along the sharp reduction in the glass transition region. The intercept of the straight line 1 and the straight line 2 was taken as a glass transition temperature Tg (dynamic viscoelasticity) because it corresponded to a temperature at which the film sample began softening by sudden decrease in the storage elasticity modulus under rise in temperature and the transfer to the glass transition region started

### (Elasticity Modulus)

A film sample measuring 10 mm×200 mm was subjected to moisture control for 2 hours under conditions of 25° C. and 60% RH, and then stretched using a tensile tester (Strograph R-2, made by Toyo Seiki Seisaku-sho, Ltd.) at settings that the initial sample length was 100 mm and the stretching speed was 100 mm/sec. And the elasticity thereof was calculated from the initial tensile stress and the elongation.

### (Photoelasticity Coefficient)

Tensile stress was applied to the major axis of a film sample measuring 10 mm×100 mm, and the Re value under this tensile stress was measured with an ellipsometer (M150, made by JASCO Corporation). The photoelasticity coefficient was calculated from the amount of retardation change with the stress.

### (Haze)

Haze measurement of a sample having a size of 40 mm×80 mm was made using a haze meter (HGM-2DP, made by Suga Test Instruments Co., Ltd.) at 25° C. and 60% RH in accordance with JIS K6714.

### (Method of Measuring Hydraulic Permeability)

To a method of measuring hydraulic permeability (moisture permeability), the methods described in Kobunshi Jikken Koza 4 (Course 4 in Experiments of High Polymers)—Kobunshi no Bussei II (Physical Properties of High Polymers II)—, pages 285-294 (wherein measurement of vapor permeation quantity (including a weight method, a thermometer method, a vapor pressure method and an adsorbed quantity method) is explained), Kyoritsu Shuppan Co., Ltd., can be applied. In the following examples, the measurements were carried out at a temperature of 40° C. and a humidity of 90% RH in accordance with JIS Standards JISZ0208, Condition B.

### EXAMPLE 1

### I. Formation of Cellulose Acylate Film

### (1) Cellulose Acylate

Cellulose acylates having different degrees of acyl substitution as presented in Table 1-1 were prepared. More specifically, acylation reaction was carried out at 40° C. by addition of sulfuric acid as a catalyst (in an amount of 7.8 parts by mass per 100 parts by mass of cellulose) besides carboxylic acids. Thereafter, the total degree of substitution and the degree of 6-position substitution were adjusted by controlling the content of sulfuric acid catalyst, the water content and the ripening time. The ripening was performed at 40° C. Further, low molecular components of the cellulose acylates thus prepared were removed by washing with acetone.

### (2) Dope Preparation

Into each of the cellulose acylates presented in Table 1-1, a plasticizer (a 2:1 mixture of triphenyl phosphate and biphenyldiphenyl phosphate), a retardation developer having the structure illustrated below and a mixed solvent (a 87:13 by mass mixture of dichloromethane and methanol) were charged with stirring in amounts that the resulting mixture had a total solids concentration of 19% by mass. The stirring was further continued under heating to prepare a solution. Concurrently therewith, 0.05 parts by mass of fine particles [silicon dioxide (primary particle size: 20 nm, Mohr's hardness: about 7)], 0.375 parts by mass of ultraviolet absorbent B (TINUVIN327, produced by Ciba Specialty Chemicals) and 0.75 parts by mass of ultraviolet absorbent C (TINUVIN328, produced by Ciba Specialty Chemicals) were charged into 100 parts by mass of each cellulose acylate, and stirred under heating. The proportions of the plasticizer and the retardation developer added are shown in Table 1, expressed in parts by mass per 100 parts by mass of cellulose acylate. From the thus prepared dopes, films F1 to F10 and F14 to F17 were formed in accordance with the method described below.

Retardation Developer

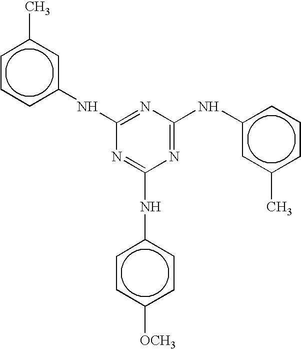

While being stirred, a plasticizer (a 2:1 mixture of triphenylphosphate and biphenyldiphenyl phosphate), the retardation developer of the structure illustrated above and a 81:8:7:4 by mass mixture of methyl acetate, acetone, ethanol and butanol were further charged into the cellulose acylate CA3 presented in Table 1 in amounts that the resulting mixture had a total solids concentration of 16.4% by mass, thereby swelling the cellulose acylate. Concurrently therewith, 0.05 parts by mass of fine particles [silicon dioxide (primary particle size: 20 nm, Mohr's hardness: about 7)] and 0.04 parts by mass of ethyl citrates (a 1:1 mixture of monoethyl citrate and diethyl citrate) were charged into 100 parts by mass of cellulose acylate with stirring. The proportions of the plasticizer and the retardation developer added are shown in Table 1, expressed in parts by mass per 100 parts by mass of cellulose acylate. The thus swollen solution was cooled to −70° C., and then melted by heating up to 40° C. The dope thus obtained was filtrated, and further subjected to flash concentration by heating at 120° C. until the solids concentration in the dope be adjusted to about 21%. From the thus prepared dope, films F11 to F13 were formed in accordance with the following method.

### (Flow Casting)

Each of the dopes was subjected to flow casting on a band casting machine. Each film thus formed was peeled away from the band when the content of residual solvents was reduced to a range of 25% to 35% by mass, and stretched in the direction of the width at a stretch rate of 15% to 23% (See Table 2) by use of a tenter, thereby forming a cellulose acylate film. In the tenter, the film was stretched in the direction of the width as it was dried by exposure to hot air, and then made to shrink by about 5%. Thereafter, the tenter transport was changed to roll transport, further dried, subjected to knurling, and then reeled. The stretch rate was calculated from the film width measured at the entrance of the tenter and the film width measured at the exit of the tenter, and presented in Table 1-2. On the thus formed cellulose acylate films (optical compensation films) each, values of Re retardation and Rth retardation at a wavelength of 550 nm under a 25° C.-60% RH condition were measured. Further, Re and Rth retardation values of each film were measured in a state that each film was subjected to humidity conditioning under humidity of 10% RH or 80% RH at 25° C. for at least two hours, and then sandwiched between two sheets of glass via silicone, and further sealed hermetically. The amount of Re retardation change caused in each cellulose acylate film by a change in humidity from 80% RH to 10% RH, Re(10% RH)-Re(80% RH), and the amount of Rth retardation change caused by a change in humidity from 80% RH to 10% RH, Rth(10% RH)-Rth(80% RH), are shown in Table 1-2, symbolized as ΔRe and ΔRth, respectively.

TABLE 1-1

| | Raw | Acetyl | Propionyl | 6-Position | Ratio of 6-position |
|---|---|---|---|---|---|
| | Cotton | Substitution | substitution | Substitution | Substitution Degree to |
| | No. | Degree | Degree | Degree | Total substitution Degree |
| Example | CA1 | 2.849 | 0.000 | 0.934 | 0.328 |
| Example | CA2 | 2.847 | 0.000 | 0.947 | 0.333 |
| Example | CA3 | 2.785 | 0.000 | 0.910 | 0.327 |
| Example | CA4 | 2.753 | 0.000 | 0.903 | 0.328 |
| Example | CA5 | 2.745 | 0.000 | 0.882 | 0.321 |
| Example | CA6 | 1.952 | 0.808 | 0.897 | 0.325 |
| Comparative | CA7 | 2.751 | 0.000 | 0.844 | 0.307 |
| Example | | | | | |

The total substitution degree is the sum of the degrees of 2-, 3- and 6-position substitutions, and equal to the acetyl substitution degree plus the propionyl substitution degree.

TABLE 1-2

| | | | | Stretch | Tenter | Dry | | | | | Moisture | | |
|---|---|---|---|---|---|---|---|---|---|---|---|---|---|
| | | Plasticizer | Developer | rate | Temp. | Thickness | Re | Rth | | | Content | Moisture | Tg |
| No. | Cotton | Content | Content | (%) | (° C.) | (μm) | (nm) | (nm) | ΔRe | ΔRth | (%) | Permeability | (° C.) |
| F1 | CA1 | 11.7 | 4.0 | 23 | 135 | 92 | 51 | 130 | 11 | 29 | 2.96 | 850 | 143 |
| F2 | CA2 | 11.7 | 5.0 | 20 | 135 | 92 | 47 | 211 | 10 | 29 | 2.94 | 854 | 143 |
| F3 | CA3 | 11.7 | 0.0 | 20 | 140 | 92 | 16 | 114 | 12 | 41 | 3.36 | 1500 | 145 |
| F4 | CA3 | 11.7 | 5.0 | 20 | 135 | 92 | 74 | 220 | 9 | 28 | 2.96 | 1144 | 142 |
| F5 | CA3 | 11.7 | 6.5 | 15 | 135 | 92 | 67 | 237 | 8 | 27 | 2.95 | 1037 | 142 |
| F6 | CA3 | 11.7 | 6.5 | 25 | 135 | 110 | 140 | 303 | 10 | 32 | 2.95 | 867 | 142 |
| F7 | CA3 | 5.7 | 6.5 | 15 | 145 | 92 | 68 | 274 | 8 | 29 | 2.95 | 1444 | 147 |
| F8 | CA3 | 11.7 | 6.5 | 15 | 130 | 80 | 63 | 223 | 8 | 26 | 2.95 | 1190 | 142 |
| F9 | CA3 | 11.7 | 6.5 | 15 | 130 | 92 | 72 | 256 | 9 | 27 | 2.95 | 1035 | 142 |
| F10 | CA3 | 11.7 | 5.0 | 23 | 135 | 60 | 48 | 132 | 8 | 25 | 2.96 | 1689 | 142 |
| F11 | CA3 | 11.7 | 0.0 | 20 | 135 | 80 | 17 | 155 | 10 | 44 | 3.36 | 1725 | 145 |
| F12 | CA3 | 11.7 | 5.0 | 22 | 135 | 86 | 58 | 275 | 10 | 28 | 2.96 | 1265 | 142 |
| F13 | CA3 | 11.7 | 6.5 | 20 | 135 | 110 | 80 | 298 | 11 | 27 | 2.95 | 954 | 142 |
| F14 | CA4 | 11.7 | 5.0 | 20 | 135 | 92 | 51 | 274 | 9 | 28 | 3.17 | 1127 | 142 |
| F15 | CA5 | 11.7 | 5.0 | 20 | 135 | 92 | 52 | 277 | 9 | 31 | 3.18 | 1130 | 142 |
| F16 | CA6 | 11.7 | 5.0 | 20 | 135 | 80 | 55 | 121 | 9 | 26 | 2.34 | 1420 | 138 |
| F17 | CA7 | 11.7 | 5.0 | 15 | 135 | 92 | 66 | 278 | 9 | 36 | 3.2 | 1136 | 141 |

Further, measurements of a glass transition temperature (Tg), a moisture content after moisture conditioning at 25° C. and 80% RH and a moisture permeability under conditions of 60° C., 95% RH and 24 hours were made on each of the films formed, and the measured values obtained are also shown in Table 2. All these films had their haze values in the range of 0.1 to 0.9, the average diameter of secondary particles of the matting agent used was 1.0 μm, the tensile elasticity modulus was 4 Gpa or above, and the change in mass by 48-hour standing under conditions of 80° C. and 90% RH was from 0% to 3%. In addition, the dimensional change by 24-hour standing under conditions of 60° C. and 95% RH and that by 24-hour standing under 90° C. and 5% RH were in the range of 0% to 4.5%. Further, every sample film had a photoelasticity coefficient of 50×10⁻¹³ cm²/dyne or below.

Other films were formed in the same manner as the optical film F13 presented in Table 2, except that their dry thicknesses were changed to 143 μm and 176 μm, respectively, which were 1.3 times and 1.6 times the dry thickness of F13. From these films, it was confirmed that the Re and Rth values increased in rough proportion to the thickness and the moisture permeability was almost inversely proportional to the thickness. The humidity dependences of Re and Rth, namely ΔRe and ΔRth, the glass transition temperature Tg and the moisture content were each irrelevant to the thickness, and the films had the same value with respect to each of those factors.

Each of the cellulose acylate films (F1 to F17) was coated with 10 cc/m² of a 1.0 N potassium hydroxide solution (solvent: water/isopropyl alcohol/propylene glycol=69.2 parts by mass/15 parts by mass/15.8 parts by mass) on the band-contact side, and the alkali solution was kept on each film for 30 seconds under a temperature of about 40° C. Then, the solution was scraped off, the film surface was washed with pure water, and further water drops were eliminated with an air knife. Thereafter, drying at 100° C. was carried out for 15 seconds. The contact angle of pure water with respect to the alkali-treated surface was found to be 42 degrees.

### (Formation of Alignment Film)

A commercially available composition for vertical alignment film formation (JALS-204R, produced by JSR Corporation) was diluted with methyl ethyl ketone in proportions of 1:1, applied to each of the cellulose films (F1 to F17) at a coverage of 2.4 ml/m² by use of a wire-bar coater, and immediately afterward dried for 120 seconds with 120° C. hot air.

In the next place, a solution was prepared by dissolving 3.8 g of a rod-shaped liquid crystalline compound illustrated below, 0.06 g of a photopolymerization initiator (Irgacure907, produced by Ciba Geigy AG), 0.02 g of a photosensitizer (KAYACURE DETX, produced by Nippon Kayaku Co., Ltd.) and 0.002 g of an air-interface side vertical alignment agent illustrated below in 9.2 g of methyl ethyl ketone. And, on the alignment film surface side, the solution was applied to each of the films on which the alignment film was formed by using each of wire bars having the counts described below. To each of the solution-applied films, a metal frame was bonded, and heated for 2 minutes in a 100° C. thermostatic chamber, thereby aligning the rod-shaped compound molecules. Then, UV irradiation was carried out for 20 seconds at 80° C. with a 120 W/cm high-pressure mercury vapor lamp to form cross-links between rod-shaped liquid crystalline molecules. Thereafter, each film was cooled to room temperature. Thus, optically anisotropic films were made.

The viscosity of the optically anisotropic films each was 495 cp, measured at a film-surface temperature of 90° C. This viscosity value was a result of measuring the liquid crystal layer (from which the solvent was removed) having the same composition as the optically anisotropic layer by means of a rotational viscometer of heating type.

Rod-Shaped Liquid Crystalline Compound

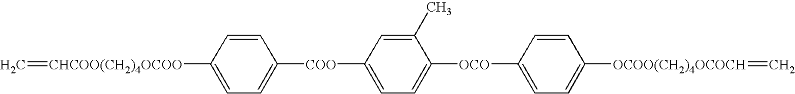

Air-Interface Side Vertical Alignment Agent:

Exemplified Compound (II-4) described in Japanese Patent No. 2003-119959

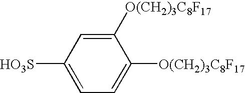

| Film No. | Cellulose Acylate film | Wire Bar Count |
|---|---|---|
| KH-01 | F5 | #4.5 |
| KH-02 | F8 | #6.0 |
| KH-03 | F6 | #3.6 |
| KH-04 | F2 | #5.0 |
| KH-H1 | F17 | #4.5 |

The dependence of Re of each of the thus formed films on incident angle of light was determined with an automatic birefringence measuring instrument (KOBRA-21ADH, made by Oji Scientific Instruments, measuring wavelength: 550 nm), and the optical characteristic of each individual optically anisotropic layer alone was calculated by deducting the predetermined contributory share of the support. As a result, it was found that KH-01 and KH-H1 each had an Re value of 0 nm and an Rth value of −225 nm, KH-02 had an Re value of 0 nm and an Rth value of −295 nm, KH-03 had an Re value of 0 nm and an Rth value of −180 nm and KH-04 had an Re value of 0 nm and an Rth value of −260 nm, whereby it was verified that rod-shaped crystalline molecules were aligned vertically in every film.

### <Making of Polarizing-Plate Protective Film 1>

The following composition was charged in a mixing tank, and the ingredients thereof were dissolved with stirring under heating to prepare a cellulose acetate Solution A.

### Composition of Cellulose Acetate Solution A:

| | | |
|---|---|---|
| Cellulose acetate with substitution degree of 2.86 | 100 | parts by mass |
| Triphenyl phosphate (plasticizer) | 7.8 | parts by mass |
| Biphenyldiphenyl phosphate (plasticizer) | 3.9 | parts by mass |
| Methylene chloride (first solvent) | 300 | parts by mass |
| Methanol (second solvent) | 54 | parts by mass |
| 1-Butanol | 11 | parts by mass |

The following composition was charged in another mixing tank, and the ingredients thereof were dissolved with stirring under heating to prepare an additive Solution B-1.

### <Composition of Additive Solution B-1>

| | | |
|---|---|---|
| Methylene chloride | 80 | parts by mass |
| Methanol | 20 | parts by mass |
| Optical anisotropy lowering agent below | 40 | parts by mass |
| 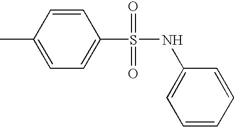 | | |

The additive Solution B-1 in an amount of 40 parts by mass was added to 477 parts by mass of cellulose acetate Solution A, and thoroughly stirred to prepare a dope. The dope was cast from a casting die over a drum cooled at 0° C. The film formed was peeled away from the drum in a state that the solvent content reached to 70% by mass, and dried in a state that both the film edges in the width direction were fixed by a pin tenter (as illustrated in FIG. 3 of JP-A-4-1009) while keeping such a distance as to achieve the stretch rate of 3% in the cross direction (vertical to the machine direction) at the time when the solvent content reached to 3-5% by mass. Thereafter, the film was further dried by conveyance between rolls installed in a heat treatment apparatus, thereby making a polarizing-plate protective film 1 having a thickness of 80 μm.

The dependence of Re of the thus formed film on incident angle of light was determined with an automatic birefringence measuring instrument (KOBRA-21ADH, made by Oji Scientific Instruments), and the optical characteristic of the film was calculated. By this calculation, it was ascertained that Re was 1 nm and Rth was 6 nm.

### (Making of Polarizer)

The optical compensation film (KH-01 to KH-04, and KH-H1) was stacked on a polarizing film with the aid of an adhesive of polyvinyl alcohol type in a state that it adjoined the polarizing film on the side of its transparent support. In addition, an antireflective film (Fiji Film CV Clear View UA, made by Fuji Photo Film Co., Ltd.) was subjected to saponification treatment, and then stacked on the opposite side of the polarizing film with the aid of an adhesive of polyvinyl alcohol type.

A commercially available 80 μm-thick triacetyl cellulose film (TD-80U, made by Fuji Photo Film Co., Ltd.) was subjected to saponification treatment, and then stacked on the opposite side of the polarizing film with the aid of an adhesive of polyvinyl alcohol type.

The polarizing film, the transparent support and the commercially available triacetyl cellulose film were arranged so that their length directions became parallel to one another. In this way, a polarizer (polarizing plate 1) having the optical compensation was made.

In addition, the polarizing-plate protective film 1 having undergone saponification treatment was stacked on one side of the polarizing film with the aid of an adhesive of polyvinyl alcohol type, and a commercially available 80 μm-thick triacetyl cellulose film (TD-80U, made by Fuji Photo Film Co., Ltd.) saponified in advance was stacked on the other side of the polarizing film with the aid of an adhesive of polyvinyl alcohol type.

The polarizing film, the transparent support and the commercially available triacetyl cellulose film were arranged so that their length directions became parallel to one another. In this way, a polarizer (polarizing plate 2) having the optical compensation film and antireflective film was made.

On polarizing plates prepared by combining each polarizer with cellulose acylate films formed in Example so that the films were situated inside the polarizer, singl plate transmittance TT, parallel transmittance PT and cross transmittance CT in the wavelength region of 380 nm to 780 nm under conditions of 25° C. and 60% RH were measured with a spectrophotometer (UV3100PC). From these measurements, the average values thereof in the 400-700 nm wavelength region and the polarization degree P were determined. As a result, TT was found to be from 40.8 to 44.7, PT from 34 to 38.8, CT 1.0 or below, and P from 99.98 to 99.99. In addition, the cross transmittances at the wavelengths 380 nm, 410 nm and 700 nm, CT(380), CT(410) and CT(800), were 1.0 or below, 0.5 or below and 0.3 or below, respectively. Further, in the durability test by 500-hour standing under conditions of 60° C. and 95% RH, all the polarizing plates fell within the ranges −0.1≦ΔCT≦0.2 and −2.0≦ΔP≦0 while in the durability test at 60° C. and 90% RH, they fell within the ranges −0.05≦ΔCT≦0.15 and −1.5≦ΔP≦0.

One part of each of the polarizing plates 1 and 2 (polarizing plate integral with a functional film-free optical compensation film as shown in FIG. 2) was stored in a moisture-proof bag as it was, and the other part underwent 2-hour moisture control at 25° C. and 60% RH and then stored in a moisture-proof bag. The moisture-proof bag was a package made of a lamination of polyethylene terephthalate, aluminum and polyethylene, and the moisture permeability thereof was found to be 0.01 mg/m² (24 hours).

### <Making of IPS Mode Liquid Crystal Cell>

As shown in FIG. 1, electrodes (2 and 3 in FIG. 1) were placed on one sheet of glass substrate so that the distance of 20 μm was kept between the adjacent electrodes. Thereon, a polyimide film was placed and subjected to rubbing treatment to prepare an alignment film. The rubbing treatment was performed in the direction 4 as shown in FIG. 1. Another alignment film was prepared by providing a polyimide film on one side of another sheet of glass substrate and performing rubbing treatment. These two glass substrate sheets were stacked so that the alignment films were made to face each other, the gap (d) between the two sheets of glass substrate was kept at 3.9 μm and their rubbing directions became parallel, and bonded to each other. And therein was sealed a nematic liquid crystal composition having a refractive-index anisotropy (Δn) of 0.0769 and a permittivity anisotropy (Δε) of +4.5. The value d Δn of the liquid crystal layer was 300 nm.

### (Making of Liquid Crystal Display)

On one side of the IPS mode liquid crystal cell, the polarizing plate 1 was stacked so that the slow axis of the cellulose acylate film became parallel to the rubbing direction of the liquid crystal cell (in other words, the slow axis of the cellulose acylate film became parallel to the slow axis of liquid crystalline molecules in a black-state liquid crystal cell), and besides, the rod-shaped compound layer was situated on the side of the liquid crystal cell.

Subsequently thereto, on the other side of the IPS mode liquid crystal cell (1 in FIG. 1), the polarizing plate 2 was stacked so that the side of its polarizing-plate protective film 1 faced to the liquid crystal cell side, and besides, the polarizing plates 1 and 2 were in a crossed Nicol arrangement, thereby making a liquid crystal display. The thus made liquid crystal display was examined for light leakage. In all the cases of using the films KH-01 to 04 and KH-H1, the light leakage was found to be 0.1% or below when viewed from a direction tilting to the left at an angle of 60°.

On the other hand, the light leakage was 0.6% in the case of using no optical compensation film.

Further, after 1-week storage under the 25° C.-80% RH condition and the 25° C.-10% RH condition, respectively, the liquid crystal display using KH-01 and the liquid crystal display using KH-H1 were examined for viewing angle characteristics.

### (Evaluation of Liquid Crystal Display)

A 55 Hz rectangular-wave voltage was applied to the liquid cell. In a normally black mode, the black-state display was set at 0V and the white-state display at 7V. The transmittance ratio (white-state display/black-state display) was taken as contrast ratio, and viewing angles were measured at 8 stages from the black-state display (L1) to the white-state display (L8). In addition, the frontal contrast (CR: brightness of white-state display/brightness of black-state display) was also determined.

Results obtained are shown in Table 1-3.

TABLE 1-3

| | | Viewing Angle | | | |
|---|---|---|---|---|---|
| Optical | Frontal | (Contrast > 10) | | | |
| compensation Film | Contrast | top/bottom | left/right | 25° C. 80% | 25° C. 10% |
| KH-01 | 480 | 80°/80° | 80°/80° | nothing wrong | nothing wrong |
| KH-H1 | 480 | 80°/80° | 80°/80° | lateral tone | vertical tone |
| | | | | reversal | reversal |

### EXAMPLE 2

### I. Formation of Cellulose Acylate Film

### (1) Cellulose Acylate

Cellulose acylates having different degrees of acyl substitution as presented in Table 2-1 were prepared. More specifically, acylation reaction was carried out at 40° C. by addition of sulfuric acid as a catalyst (in an amount of 7.8 parts by mass per 100 parts by mass of cellulose) besides carboxylic acids. Thereafter, the total degree of substitution and the degree of 6-position substitution were adjusted by controlling the content of sulfuric acid catalyst, the water content and the ripening time. The ripening was performed at 40° C. Further, low molecular components of the cellulose acylates thus prepared were removed by washing with acetone.

### (2) Dope Preparation

Into each of the cellulose acylates presented in Table 2-1, a plasticizer (a 2:1 mixture of triphenyl phosphate and biphenyldiphenyl phosphate), a retardation developer having the structure illustrated below and a mixed solvent, or a dichloromethane/methanol (87:13 by mass) mixture, were charged with stirring in amounts that the resulting mixture had a total solids concentration of 19% by mass. And the stirring was further continued under heating to prepare a solution. Simultaneously therewith, 0.05 parts by mass of fine particles [silicon dioxide (primary particle size: 20 nm, Mohr's hardness: about 7)], 0.375 parts by mass of ultraviolet absorbent B (TINUVIN327, produced by Ciba Specialty Chemicals) and 0.75 parts by mass of ultraviolet absorbent C (TINUVIN328, produced by Ciba Specialty Chemicals) were charged into 100 parts by mass of each cellulose acylate, and stirred under heating. The proportions of the plasticizer and the retardation developer added are shown in Table 1, expressed in parts by mass per 100 parts by mass of cellulose acylate. From the thus prepared dopes, films F1 to F10 and F14 to F17 were formed in accordance with the method described below.

Retardation Developer

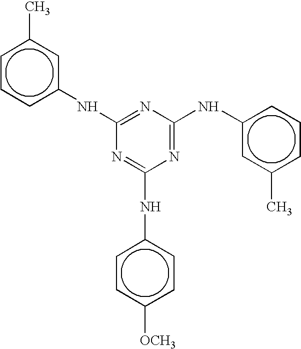

While being stirred, a plasticizer (a 2:1 mixture of triphenylphosphate and biphenyldiphenyl phosphate), the retardation developer of the structure illustrated above and a 81:8:7:4 by mass mixture of methyl acetate, acetone, ethanol and butanol were further charged into the cellulose acylate CA3 presented in Table 1 in amounts that the resulting mixture had a total solids concentration of 16.4% by mass, thereby swelling the cellulose acylate. Concurrently therewith, 0.05 parts by mass of fine particles [silicon dioxide (primary particle size: 20 nm, Mohr's hardness: about 7)] and 0.04 parts by mass of ethyl citrates (a 1:1 mixture of monoethyl citrate and diethyl citrate) were charged into 100 parts by mass of cellulose acylate with stirring. The proportions of the plasticizer and the retardation developer added are shown in Table 1, expressed in parts by mass per 100 parts by mass of cellulose acylate. The thus swollen solution was cooled to −70° C., and then melted by heating up to 40° C. The dope thus obtained was filtrated, and further subjected to flash concentration by heating at 120° C. until the solids concentration in the dope be adjusted to about 21%. From the thus prepared dope, films F11 to F13 were formed in accordance with the following method.

### (Flow Casting)

Each of the dopes was subjected to flow casting on a band casting machine. Each film thus formed was peeled away from the band when the content of residual solvents was reduced to a range of 25% to 35% by mass, and stretched in the direction of the width at a stretch rate of 15% to 23% (See Table 2-2) by use of a tenter, thereby forming a cellulose acylate film. In the tenter, the film was stretched in the direction of the width as it was dried by exposure to hot air, and then made to shrink by about 5%. Thereafter, the tenter transport was changed to roll transport, further dried, subjected to knurling, and then reeled. The stretch rate was calculated from the film width measured at the entrance of the tenter and the film width measured at the exit of the tenter, and presented in Table 2-2. On the thus formed cellulose acylate films (optical compensation films) each, values of Re retardation and Rth retardation at a wavelength of 550 nm under a 25° C.-60% RH condition were measured. Further, Re and Rth retardation values of each film were measured in a state that each film was subjected to humidity conditioning under humidity of 10% RH or 80% RH at 25° C. for at least two hours, and then sandwiched between two sheets of glass via silicone, and further sealed hermetically. The amount of Re retardation change caused in each cellulose acylate film by a change in humidity from 80% RH to 10% RH, Re(10% RH)-Re(80% RH), and the amount of Rth retardation change caused by a change in humidity from 80% RH to 10% RH, Rth(10% RH)-Rth(80% RH), are shown in Table 2-2, symbolized as ΔRe and ΔRth, respectively.

TABLE 2-1

| | | | | | Ratio of 6-position |
|---|---|---|---|---|---|
| | Raw | Acetyl | Propionyl | 6-Position | Substitution Degree |
| | Cotton | Substitution | substitution | Substitution | to Total substitution |
| | No. | Degree | Degree | Degree | Degree |
| Example | CA1 | 2.849 | 0.000 | 0.934 | 0.328 |
| Example | CA2 | 2.847 | 0.000 | 0.947 | 0.333 |
| Example | CA3 | 2.785 | 0.000 | 0.910 | 0.327 |
| Example | CA4 | 2.753 | 0.000 | 0.903 | 0.328 |
| Example | CA5 | 2.745 | 0.000 | 0.882 | 0.321 |
| Example | CA6 | 1.952 | 0.808 | 0.897 | 0.325 |
| Comparative | CA7 | 2.751 | 0.000 | 0.844 | 0.307 |
| Example | | | | | |

The total substitution degree is the sum of the degrees of 2-, 3- and 6-position substitutions, and equal to the acetyl substitution degree plus the propionyl substitution degree.

TABLE 2-2

| | | | | Stretch | Tenter | Dry | | | | | Moisture | | |
|---|---|---|---|---|---|---|---|---|---|---|---|---|---|
| | | Plasticizer | Developer | rate | Temp. | Thickness | Re | Rth | | | Content | Moisture | Tg |
| No. | Cotton | Content | Content | (%) | (° C.) | (μm) | (nm) | (nm) | ΔRe | ΔRth | (%) | Permeability | (° C.) |
| F1 | CA1 | 11.7 | 4.0 | 23 | 135 | 92 | 51 | 130 | 11 | 29 | 2.96 | 850 | 143 |
| F2 | CA2 | 11.7 | 5.0 | 18 | 135 | 92 | 40 | 205 | 10 | 29 | 2.94 | 854 | 143 |
| F3 | CA3 | 11.7 | 0.0 | 20 | 140 | 92 | 16 | 114 | 12 | 41 | 3.36 | 1500 | 145 |
| F4 | CA3 | 11.7 | 4.5 | 22 | 135 | 92 | 45 | 200 | 8 | 28 | 2.96 | 1144 | 142 |
| F5 | CA3 | 11.7 | 6.0 | 25 | 135 | 92 | 80 | 220 | 7 | 27 | 2.95 | 867 | 142 |
| F6 | CA3 | 11.7 | 5.5 | 17 | 135 | 88 | 38 | 175 | 5 | 23 | 2.95 | 1037 | 142 |
| F7 | CA3 | 11.7 | 7.5 | 15 | 145 | 92 | 68 | 274 | 8 | 29 | 2.95 | 1444 | 147 |
| F8 | CA3 | 11.7 | 6.2 | 18 | 145 | 80 | 40 | 180 | 8 | 18 | 2.95 | 1190 | 142 |
| F9 | CA3 | 11.7 | 7.5 | 15 | 130 | 92 | 75 | 250 | 9 | 27 | 2.95 | 1035 | 142 |
| F10 | CA3 | 11.7 | 4.0 | 23 | 135 | 60 | 48 | 132 | 7 | 25 | 2.96 | 1689 | 142 |
| F11 | CA3 | 11.7 | 0.0 | 20 | 135 | 80 | 17 | 155 | 10 | 44 | 3.36 | 1725 | 145 |
| F12 | CA3 | 11.7 | 5.0 | 22 | 135 | 86 | 58 | 275 | 10 | 28 | 2.96 | 1265 | 142 |
| F13 | CA3 | 11.7 | 6.5 | 20 | 135 | 110 | 80 | 298 | 11 | 27 | 2.95 | 954 | 142 |
| F14 | CA4 | 11.7 | 5.0 | 20 | 135 | 92 | 51 | 274 | 9 | 28 | 3.17 | 1127 | 142 |
| F15 | CA5 | 11.7 | 5.0 | 20 | 135 | 92 | 52 | 277 | 9 | 31 | 3.18 | 1130 | 142 |
| F16 | CA6 | 11.7 | 5.0 | 20 | 135 | 80 | 55 | 121 | 9 | 26 | 2.346 | 1420 | 138 |
| F17 | CA7 | 11.7 | 4.0 | 15 | 135 | 92 | 40 | 180 | 9 | 40 | 3.2 | 1136 | 141 |

Further, measurements of a glass transition temperature (Tg), a moisture content after moisture conditioning at 25° C. and 80% RH and a moisture permeability under conditions of 60° C., 95% RH and 24 hours were made on each of the films formed, and the measured values obtained are also shown in Table 2. All these films had their haze values in the range of 0.1 to 0.9, the average diameter of secondary particles of the matting agent used was 1.0 μm, the tensile elasticity modulus was 4 Gpa or above, and the change in mass by 48-hour standing under conditions of 80° C. and 90% RH was from 0% to 3%. In addition, the dimensional change by 24-hour standing under conditions of 60° C. and 95% RH and that by 24-hour standing under 90° C. and 5% RH were in the range of 0% to 4.5%. Further, every sample film had a photoelasticity coefficient of 50×10⁻¹³ cm²/dyne or below.

Other films were formed in the same manner as the optical film F13 presented in Table 2, except that their dry thicknesses were changed to 143 μm and 176 μm, respectively, which were 1.3 times and 1.6 times the dry thickness of F13. From these films, it was confirmed that the Re and Rth values increased in rough proportion to the thickness and the moisture permeability was almost inversely proportional to the thickness. The humidity dependences of Re and Rth, namely ΔRe and ΔRth, the glass transition temperature Tg and the moisture content were each irrelevant to the thickness, and the films had the same value with respect to each of those factors.

Each of the cellulose acylate films (F1 to F17) was coated with 10 cc/m² of a 1.0 N potassium hydroxide solution (solvent: water/isopropyl alcohol/propylene glycol=69.2 parts by mass/15 parts by mass/15.8 parts by mass) on the band-contact side, and the alkali solution was kept on each film for 30 seconds under a temperature of about 40° C. Then, the solution was scraped off, the film surface was washed with pure water, and further water drops were eliminated with an air knife. Thereafter, drying at 100° C. was carried out for 15 seconds. The contact angle of pure water with respect to the alkali-treated surface was found to be 42 degrees.

### (Formation of Alignment Film)

To each of the alkali-processed surfaces of cellulose acylate films (F1 to F17), a coating solution for forming an alignment film, which had the composition described below, was applied in an amount of 2.8 ml/m² by use of a #16 wire-bar coater. Then, the solution applied was dried for 60 seconds with 60° C. hot air, and further dried for 150 seconds with 90° C. hot air, thereby forming an alignment film.

### Composition of Coating Solution for Alignment Film:

| | | |
|---|---|---|
| Modified polyvinyl alcohol below | 10 | parts by mass |
| Water | 371 | parts by mass |
| Methanol | 119 | parts by mass |
| Glutaraldehyde (cross-linking agent) | 0.5 | parts by mass |
| Citric acid ester (AS3, produced by | 0.35 | parts by mass |
| Sankyo Chemical Co., Ltd.) | | |
| Modified polyvinyl alcohol | | |
| 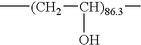 | | |
| 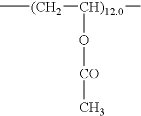 | | |
| 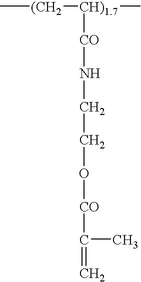 | | |

### (Rubbing Treatment)

While each transparent support having thereon the alignment film formed in the foregoing manner was conveyed at a speed of 20 nm/min, the surface of the alignment film formed on the transparent support underwent rubbing treatment with a rubbing roll (measuring 300 mm in diameter) that was disposed so that the rubbing treatment was performed at a 45° angle with respect to the length direction and rotated at 650 rpm. Herein, the length of contact between the rubbing roll and the transparent support was set at 18 mm.

### (Formation of Optically Anisotropic Layer)

In 102 Kg of methyl ethyl ketone were dissolved 41.01 Kg of a discotic liquid crystalline compound illustrated below, 4.06 Kg of ethylene oxide-modified trimethylolpropane triacrylate (V#360, made by Osaka Organic Chemical Industry Ltd.), 0.35 Kg of cellulose acetate butyrate (CAB 531-1, produced by Eastman Chemical Company), 1.35 Kg of a photopolymerization initiator (Irgacure 907, produced by Ciba Geigy AG) and 0.45 Kg of a photosensitizer (KAYACURE DETX, produced by Nippon Kayaku Co., Ltd.). To the solution obtained was added 0.1 Kg of a copolymer containing fluorinated aliphatic groups (Megafac F780, made by Dainippon Ink and Chemicals, Incorporated), thereby preparing a coating solution. The coating solution thus prepared was continuously applied to the surface of the alignment film on each transparent support conveyed at a speed of 20 m/min by means of a #3.2 wire bar rotating at 391 revs in the same direction as the film-feeding direction.

Discotic Liquid Crystalline Compound:

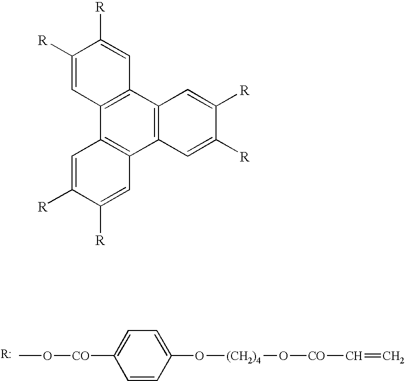

The solvent was removed by drying under continuous heating from room temperature to 100° C., and then each film was fed into a 130° C. drying zone. In the drying zone, each film was heated for about 90 seconds in a condition that the film-surface velocity of a wind blowing in its optically anisotropic discotic layer surface was adjusted to 2.5 m/sec, thereby aligning molecules of the discotic liquid crystalline compound. In the next place, the resulting film was fed into a 80° C. drying zone and, in a state that the surface temperature thereof was about 100° C., underwent 4 seconds' ultraviolet irradiation in illumination of 600 mW by means of a ultraviolet irradiation apparatus (ultraviolet lamp with 160 W/cm of output and 1.6 m of emission length), thereby pursuing cross-linking reaction to result in fixation of aligned state of the discotic liquid crystalline compound molecules. Thereafter, each film was cooled to room temperature, and formed into a roll by winding it around a cylinder. Thus, role-form optical compensation films (KH-01 to 17) were formed.

The viscosity of the optically anisotropic films each was 695 cp, measured at a film-surface temperature of 127° C. This viscosity value was a result of measuring the liquid crystal layer (from which the solvent was removed) having the same composition as the optically anisotropic layer by means of a rotational viscometer of heating type.

Samples were prepared by cutting away portions of the thus formed roll-form optical compensation films, and optical characteristics were measured on these samples. The Re retardation value of the optically anisotropic layer was 380 nm when measured at a wavelength of 546 nm. The angle (tilt angle) that the disc plane of the discotic liquid crystalline compound in the optically anisotropic layer formed with the support surface varied continuously in the depth direction of the layer, and the average tilt angle was found to be 28°. Further, the optically anisotropic layer alone was peeled away from each sample. When an average direction of molecular symmetry axes in the optically anisotropic layer was determined, it was found that the average direction formed an angle of 45° with respect to the length direction of the optical compensation film.

### (Making of Polarizer)

Each of the optical compensation films (KH-06, KH-08 and KH-17) was stacked on a polarizing film with the aid of an adhesive of polyvinyl alcohol type in a state that it adjoined the polarizing film on the side of its transparent support. Further, a commercially available 80 μm-thick triacetyl cellulose film (TD-80U, made by Fuji Photo Film Co., Ltd.) was subjected to saponification treatment, and then stacked on the other side of the polarizing film with the aid of an adhesive of polyvinyl alcohol type.

The polarizing film, the transparent support and the commercially available triacetyl cellulose film were arranged so that their length directions became parallel to one another. In this way, polarizers respectively having different optical compensation films were made.

Further, each of the optical compensation films was stacked on one side of a polarizing film with the aid of an adhesive of polyvinyl alcohol type in a state that it adjoined the polarizing film on the side of its transparent support. In addition, an antireflective film (Fiji Film CV Clear View UA, made by Fuji Photo Film Co., Ltd.) was subjected to saponification treatment, and then stacked on the other side of the polarizing film with the aid of an adhesive of polyvinyl alcohol type.

The polarizing film, the transparent support and the commercially available antireflective film were arranged so that their length directions became parallel to one another. In this way, polarizers having the antireflective film in addition to optical compensation films were made.

On polarizing plates prepared by combining each polarizer with cellulose acylate films formed in Example so that the films were situated inside the polarizer, singl plate transmittance TT, parallel transmittance PT and cross transmittance CT in the wavelength region of 380 nm to 780 nm under a 25° C.-60% RH condition were measured with a spectrophotometer (UV3100PC). From these measurements, the average values thereof in the 400-700 nm wavelength region and the polarization degree P were determined. As a result, TT was found to be from 40.8 to 44.7, PT from 34 to 38.8, CT 1.0 or below, and P from 99.98 to 99.99. In addition, the cross transmittances at the wavelengths 380 nm, 410 nm and 700 nm, CT(380), CT(410) and CT(800), were 1.0 or below, 0.5 or below and 0.3 or below, respectively. Further, in the durability test by 500-hour standing under the 60° C.-95% RH condition, all the polarizing plates fell within the ranges −0.1≦ΔCT≦0.2 and −2.0≦ΔP≦0, while in the durability test at 60° C. and 90% RH, they fell within the ranges −0.05≦ΔCT≦0.15 and −1.5≦ΔP≦0.

One part of each of the polarizing plates A1 to A17 was stored in a moisture-proof bag as it was, and the other part underwent 2-hour moisture control at 25° C. and 60% RH and then stored in a moisture-proof bag. The moisture-proof bag was a package made of a lamination of polyethylene terephthalate, aluminum and polyethylene, and the moisture permeability thereof was found to be 0.01 mg/m² (24 hours).

### (Making of Bend Alignment Liquid Crystal Cell)

On a glass substrate with an ITO electrode, a polyimide film was placed and subjected to rubbing treatment to prepare an alignment film. The two sheets of glass substrate thus made were stacked so that the alignment films were made to face each other, their rubbing directions became parallel, and the cell gap (d) was set at 4.5 μm. And into the cell gap was injected a liquid crystal compound having Δn of 0.1396 (ZLI1132, produced by Merck Ltd., Japan), thereby making a bend alignment liquid crystal cell. The liquid crystal cell measured 20 inches diagonally.

On the bend alignment cell made, a polarizer having one of the optical compensation films (alone) and a polarizer having both one of the optical compensation films and the antireflective film were stacked so that the cell was sandwiched in between the polarizers. Herein, the polarizer having both the optical compensation film and the antireflective film was placed on the viewing side. The optically anisotropic layer of the polarizer faced the cell substrate, and the liquid crystal cell and the optically anisotropic layer facing the liquid crystal cell were disposed so that their rubbing directions were antiparallel to each other.

### (Evaluation of Liquid Crystal Display)

A 55 Hz rectangular-wave voltage was applied to the liquid cell. The white-state display was set at 2V and the black-state display at 5V. The transmittance ratio (white-state display/black-state display) was taken as contrast ratio, and viewing angles were measured at 8 stages from the black-state display (L1) to the white-state display (L8). In addition, the frontal contrast (CR: brightness of white-state display/brightness of black-state display) was also determined.

Further, after 1-week storage under the 25° C.-80% RH condition and the 25° C.-10% RH condition, respectively, the liquid crystal displays were examined for viewing angle characteristics.

Results obtained are shown in Table 2-3.

TABLE 2-3

| | | Viewing Angle | | | |
|---|---|---|---|---|---|
| Optical | | (Contrast > 10) | | | |
| compensation | Frontal | top/ | left/ | | |
| Film | Contrast | bottom | right | 25° C. 80% | 25° C. 10% |
| KH-06 | 480 | 80°/80° | 80°/80° | nothing | nothing |
| | | | | wrong | wrong |
| KH-08 | 530 | 80°/80° | 80°/80° | nothing | nothing |
| | | | | wrong | wrong |
| KH-17 | 460 | 80°/80° | 80°/80° | lateral tone | vertical tone |
| | | | | reversal | reversal |

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application Nos. JP2005-81401 and JP2005-82211, both filed Mar. 22 of 2005, the contents of which are incorporated herein by reference.

1. An optical compensation film comprising:
a cellulose acylate film:
an optically anisotropic layer comprising a liquid crystalline compound,
wherein the cellulose acylate film comprises a cellulose having a glucose unit, a hydroxyl group of the glucose unit being substituted with an acyl group having at least two carbon atoms, and the cellulose acylate film satisfies relationships (I) and (II):
2.0≦DS2+DS3+DS6≦3.0 (I)
DS6(DS2+DS3+DS6)≦0.315 (II)
wherein DS2 stands for a substitution degree of the hydroxyl group at 2-position of the glucose unit with the acyl group, DS3 stands for a substitution degree of the hydroxyl group at 3-position of the glucose unit with the acyl group, and DS6 stands for a substitution degree of the hydroxyl group at 6-position of the glucose unit with the acyl group.

2. The optical compensation film according to claim 1, wherein the cellulose acylate film contains a retardation developer comprising one of a rod-shaped compound and a discotic compound.

3. The optical compensation film according to claim 1, which has a difference between retardation values Re(550) under 25° C.-10% RH and 25°-80% RH conditions, ΔRe (Re10% RH-Re80% RH), of 12 nm or below and has a difference between retardation values Rth(550) under 25° C.-10% RH and 25°-80% RH conditions, ΔRth (Rth10% RH-Rth80% RH), of 32 nm or below, wherein Re(λ) is an in-plane retardation expressed in the units nm at a wavelength of λ nm and Rth(λ) is a thickness-direction retardation expressed in the units nm at a wavelength of λ nm.

4. The optical compensation film according to claim 1, wherein the liquid crystalline compound is a discotic liquid crystalline compound.

5. The optical compensation film according to claim 1, wherein the liquid crystalline compound is a rod-shaped liquid crystalline compound.

6. The optical compensation film according to claim 5, wherein the cellulose acylate film has an Re(550) value of 20 nm to 150 nm and an Rth(550)/Re(550) ratio of 1.5 to 7, and the optically anisotropic layer has an Re(550) value of 0 nm to 10 nm and an Rth(550) value of −80 nm to −400 nm, wherein Re(λ) is an in-plane retardation expressed in the units nm at a wavelength of λ nm and Rth(λ) is a thickness-direction retardation expressed in the units nm at a wavelength of λ nm.

7. An optical compensation film comprising:
a cellulose acylate film:
an optically anisotropic layer comprising a rod-shaped liquid crystalline compound,
wherein the cellulose acylate film comprises a cellulose having a glucose unit, a hydroxyl group of the glucose unit being substituted with an acyl group having at least two carbon atoms, and the cellulose acylate film satisfies relationships (I) and (II):
2.0≦DS2+DS3+DS6≦3.0 (I)
DS6(DS2+DS3+DS6)≦0.315 (II)
wherein DS2 stands for a substitution degree of the hydroxyl group at 2-position of the glucose unit with the acyl group, DS3 stands for a substitution degree of the hydroxyl group at 3-position of the glucose unit with the acyl group, and DS6 stands for a substitution degree of the hydroxyl group at 6-position of the glucose unit with the acyl group.

8. A polarizing plate comprising: a polarizer; and an optical compensation film according to claim 1.

9. A liquid crystal display comprising: a liquid crystal cell; and an optical compensation film according to claim 1.

10. The liquid crystal display according to claim 9, wherein the liquid crystal cell is of an IPS mode.

11. The liquid crystal display according to claim 9, wherein the liquid crystal cell is of an OCB mode.
